(19) United States
(12) Patent Application Publication
(10) Pub. No.: US 2017/0193412 A1
(43) Pub. Date: Jul. 6, 2017

(54) SYSTEM AND METHOD FOR PROJECT CONTRACT MANAGEMENT

(71) Applicant: Progressclaim.com Pty Ltd, Melbourne (AU)

(72) Inventors: Lincoln Keith Easton, Melbourne (AU); Mark William Ballinger, Melbourne (AU); Vito Benito Bruscella, Melbourne (AU)

(73) Assignee: Progressclaim.com Pty Ltd, Melbourne (AU)

(21) Appl. No.: 14/983,748

(22) Filed: Dec. 30, 2015

(51) Int. Cl. G06Q 10/06; G06Q 10/10

(52) U.S. Cl. CPC G06Q 10/06313; G06Q 10/103

(57) ABSTRACT

A system for managing contract payments between a first agent and at least one second agent for a project, via a communications network(s), including: a network server connected to the network(s) which act as central repository for storing and sharing contract information; and, at least one user terminal associated with each of the first and second agents, the terminals being configured to connect to the network(s) for creating, editing, viewing and/or approving the contract information stored on the network server(s). The contract information including: at least one contract which includes at least one contract item entity associated with the project and the second agent, the contract item entity representing a contract item being for a good and/or service provided by the second agent to the first agent in accordance with the contract.

### BACKGROUND

Technical Field

The present invention relates generally to the management of contracts associated with projects, and relates particularly, though not exclusively, to systems and/or methods for managing contracts associated with construction, building or development projects. More particularly, the present invention relates to a system and/or method for managing contract payments between a first agent and at least one second agent involved in a construction project.

It will be convenient to hereinafter describe the invention in relation to a system and/or method for managing contract payments associated with construction projects, however, it should be appreciated that the present invention is not limited to that use only. For example, the system and/or method of the present invention could also be used to manage contract payments associated with projects for other industries, such as, for example, the education, entertainment, event management, catering, transport, mining, legal, advertising, marketing, sales, government, defence, and/or information technology industries, and/or any other industry wherein goods and/or services are supplied as per contractual arrangements. A skilled person will appreciate many possible uses and modifications of the system and/or method of the present invention. Accordingly, the present invention as hereinafter described should not be construed as limited to any one or more of the specific examples provided herein, but instead should be construed broadly within the spirt and scope of the invention as defined in the description and claims that now follows.

Description of Related Art

Any discussion of documents, devices, acts or knowledge in this specification is included to explain the context of the invention. It should not be taken as an admission that any of the material forms a part of the prior art base or the common general knowledge in the relevant art in Australia, the United States, or elsewhere, on or before the priority date of the disclosure herein.

Unless stated otherwise, throughout the ensuing description, the expression “first agent” is intended to refer to any suitable ‘respondent’ (i.e. an individual or organisation responsible for approving contract payments) party to, or otherwise appointed responsible for, one or more contract(s) associated with a construction project managed in accordance with the system and/or method of the present invention. For example, a first agent may include, but is not limited to, a: contract administrator; head or general contractor; developer; owner builder; owner agent; or, architect. Similarly, the expression “second agent” is intended to refer to any suitable ‘claimant’ (i.e. an individual or organisation that provides goods and/or services, and then makes a claim(s) or payment application(s) for contract payment(s)) party to one or more contract(s) associated with a construction project managed in accordance with the system and/or method of the present invention. For example, a second agent may include, but is not limited to, a: subcontractor; head or general contractor (if, for example, carrying out some work on a construction project themselves, or if working for a developer, etc.); or, consultant (such as, for example, an architect, engineer, project manager, etc.). Finally, the expression “third agent” is intended to refer to any suitable individual or organisation with an interest or authority over a particular construction project managed in accordance with the system and/or method of the present invention. For example, a third agent may include, but is not limited to, a: project manager; architect; owner; owner agent; quality surveyor; assessor; superintendent; or, stakeholder (such as, for example, a financier, lawyer, government agency, insurer, etc.). A skilled person will appreciate many such first, second and third agents, along with combinations, substitutions, variations or alternatives thereof, applicable for use with the system and/or method of the present invention. Accordingly, the present invention should not be construed as limited to any one or more of the specific examples provided herein. Finally, the definitions of the expressions hereinbefore described are only provided for assistance in understanding the nature of the invention, and more particularly, the preferred embodiments of the invention as hereinafter described. Such definitions, where provided, are merely examples of what the expressions refer to, and hence, are not intended to limit the scope of the invention in any way.

The construction industry and other industries, are highly competitive and often involve contracts for the provision of goods and/or services between a first agent and at least one second agent. For example, in the construction industry, for any given project, a first agent may be a general contractor and a second agent may be a subcontractor. The goods may be, for example, building materials, such as bricks, concrete, steel and tiles. Whereas, the services may, for example, include erecting walls, laying tiles and pouring concrete. There are, of course, many other types of goods and/or services applicable to the construction industry.

Typically, a contract for a construction project is negotiated and agreed, then executed or otherwise formalised (e.g. verbally, electronically, etc.). The contract governs the types of goods and/or services which are to be supplied, when such goods and/or services are to be supplied, the amount of goods and/or services which are to be supplied and the cost of those goods and/or services.

When, for example, a subcontractor supplies a good and/or service, the subcontractor will seek payment for the good and/or service supplied, or part payment for the good and/or service partially supplied (i.e. a progress claim, or payment application, etc.), from, for example, a general contractor. Typically, after having supplied a specified good and/or service, the subcontractor would notify the general contractor about the supplied good and/or service. The terms of a construction contract will normally prescribe the process for making claims/applications for payment, including the rights and obligations of both parties (e.g. the general contractor and subcontractor, etc.), the information to be included and the expected timing for the submittal, assessment, approval and payment of a claim/application. After being notified of the supply of a good and/or service by the subcontractor (i.e. after having received a progress claim, payment application, etc.), the general contractor would then typically determine (sometimes using a third agent, such as a quantity surveyor or other kind of assessor, etc.) whether the good and/or service has been supplied, and whether the good and/or service has been supplied in the amount, condition or state, claimed by the subcontractor. If the general contractor is satisfied that the good and/or service has been supplied in the amount (state, condition, etc.) claimed by the subcontractor, payment in full would typically be authorised and made in accordance with any contractual conditions which may pertain to the payment (e.g. less retention or retainage funds, etc.—i.e. a portion of the agreed upon contract price deliberately withheld until the work is substantially complete to assure that general contractor or subcontractor will satisfy its obligations and complete a construction project). On the other hand, if the general contractor is not satisfied that the good and/or service has been supplied in the amount (state, condition, etc.) claimed by the subcontractor, the general contractor may only approve and authorise payment for a portion of the amount claimed by the subcontractor (less any retention/retainage funds, etc.), or may not approve any payment at all.

A claim for payment (e.g. a progress claim, payment application, etc.) in accordance with a construction contract is essentially a pre-cursor to the second agent (e.g. a subcontractor, etc.) submitting a tax invoice to the first agent (e.g. a general contractor, etc.). However, it is common for less sophisticated industry participants, quite often subcontractors, to submit an invoice as a de-facto claim/application. This leads to complexity when claims are not approved in full, as the invoice needs to be amended, replaced or supported by a credit note to bring the net amount back to the approved amount.

Typically, a general contractor, etc., will keep a spreadsheet, or other such accounting instrument, which records contractual items of goods and/or services to be supplied by, for example, one or more subcontractors. In such a spreadsheet, the description of the item, the cost of the item, the amount of the item supplied and the amount of payments authorised to the subcontractor(s) would typically be recorded. The subcontractor(s), etc., may also keep a similar, but not linked spreadsheet which records details of the goods and/or services supplied to the general contractor to date, and the associated payment amounts received in connection therewith. Such spreadsheets are typically used in the construction industry because: horizontal business accounting systems do not have the construction contract administration functionality needed to be able to provide a sufficient level of detail of the scope of work contracted to facilitate a reasonable level of assessment to be able to verify the claim/application for works actually completed; and, even where sophisticated vertical enterprise resource planning (ERP) systems are used by one or both contract parties that have the contract administration function necessary, the systems of each party are disconnected and therefore require manual spreadsheet reconciliation.

Due to the records of contract items being kept separately by, for example, a general contractor and a subcontractor, there is typically a requirement for the general contractor and the subcontractor to communicate with each other to discuss the items supplied and the amounts to be paid. Such communications can be time consuming, inaccurate and the communications may be delayed or missed. Such communications may include e-mails, regular mail and telephone calls. Missed or delayed communications can cause problems with the timeliness of payments, which can lead to misunderstandings and further communication problems between the general contractor and the subcontractor. Moreover, missed and/or delayed communications can lead to problems with contract payments or contract items not being delivered, or not being delivered in a timely fashion. These problems are compounded by the fact that subcontractors, etc., are generally required to submit claims/applications for contract payments once per month by a specified day of the month.

Aside from the delays and problems associated with current record keeping practices, in Australia, as well as in several other countries, there is Security of Payments or similar statutory adjudication legislation that governs the requirements of construction payment claims/applications. In Australia, these Acts specify many basic provisions, including: key data to be included in a claim/application in order for it to be considered a “conforming payment claim” or “conforming payment application”, etc., that can be enforced under the Act(s); a defined time limit by which the respondent (i.e. the first agent, such as, for example, a general contractor) must respond to the payment claim/application, after which failure to respond makes the claim/application subject to adjudication; and, a set of criteria with which the respondent must comply in order to have been considered to have adequately met its obligations—this generally constitutes full payment or detailed rationale as to why a claim/application should not be paid in full. The Australian Security of Payments legislation is essentially an extension of the common law contracts between the contractual participants. There are several common requirements typically imposed under these common law contracts in accordance with Australian Standards, such as AS4000-1997, AS4902-2000 and AS4903-2000. Examples include: the party performing the works to be paid for (i.e. the claimant or second agent, such as, for example, a subcontractor) is usually required to provide the party paying for the works (i.e. the respondent or first agent, such as, for example, a general contractor) with insurance certificates of currency (e.g. public liability, workers compensation, etc.) to indemnify the respondent from responsibility for the claimant's negligent actions and employees; and, the claimant usually has to provide a statutory declaration covering the claim period stating that they have paid their workers and subcontractors (if any).

Given that current practices for managing contracts associated with construction projects are largely paper based, manual and inefficient, it can be extremely difficult for contracted parties to comply with such Security of Payments or similar statutory adjudication legislation. In addition, calculations often differ from party to party, and one party will not readily be able to determine how another party either calculated or assessed the other's claim/application. This problem is exacerbated when claims/applications for variations or change orders (i.e. work that is added to, or deleted from, the original scope of work of a contract, which alters the original contract amount and/or completion date, etc.) are submitted for approval and payment by second agents, e.g. subcontractors. Another common problem with current practices is that retention/retainage calculations are generally wrong and often neglected. Overall, current practices are slow and disjointed, resulting in countless hours wasted by all parties on needless spreadsheet reconciliations, time-consuming disputes (e.g. arbitration) and loss of productivity, both on site and in the office, generating ongoing and unnecessary suspicion and ill will between contracted parties.

There exists some automated, or at least partially automated, systems for managing contracts in accordance with construction projects, however none of these known systems adequately address the problems outlined above. For example, some contract payment systems enable a second agent, e.g. a subcontractor, to submit a payment claim/application to a first agent, e.g. a general contractor, using an automated or partially automated process. However, these contract payment systems are not truly collaborative and do not allow for the first agent to assess the amount of a good and/or service which has been supplied by the second agent, so as to alter the amount paid to the second agent for the amount of the good and/or service actually supplied, or assessed as having been supplied. Further, such contract payment systems do not allow for a second agent to make progressive claims/applications for payment of a good and/or service which is supplied in instalments over a period of time. Other systems, such as document management systems, allow for some collaboration between first and second agents, however such systems only include records of project documentation, such as plans, contracts and other such documents. These known contract payment systems do not include any sort of truly collaborative payment systems or methods.

Other problems associated with known contract management systems for construction projects include, but are not limited to: they are typically non-compliant with relevant Security of Payments or similar statutory adjudication legislation; they cannot be run as a stand-alone system should only one of a first or second agent wish to use the system; they offer no integration with external software systems, such as, for example, budgeting or accounting software; they do not automatically or adequately calculate retention/retainage amounts for each contract payment claim/application; they do not typically allow first, second and/or third agents to use a single account to manage or view multiple construction projects and contracts; they do not provide adequate notifications or reminders for the various phases of a contract, such as, for example, reminders for second agents to claim for final completion and associated retention/retainage release, etc.; they do not adequately enable supporting documentation to be submitted and distributed between contracted parties, such as, for example, at each of the contract, claim, contract line item and claim line item level; and/or, they do not adequately display project-to-date reconciliations for any given project, or for all claims/applications made under a contract for a specific project to any point in time, i.e. they do not show or display amounts approved prior to a new claim/application being made, the cumulative value claimed up to the date of the new claim/application being made, and once approved, the assessed/certified cumulative value approved.

A need therefore exists for an improved system and/or method for managing contracts associated with construction projects, one which overcomes or alleviates one or more of the aforesaid problems associated with known systems, methods or processes for managing contracts associated with construction projects, or one which at least provides a useful alternative. More particularly, a need exists for an improved system and/or method for managing contract payments between a first agent and at least one second agent involved in a construction project, one which simplifies the claims or payment application process and complies with relevant Security or Payments or similar statutory adjudication legislation.

### SUMMARY

According to one aspect, the present invention provides a system for managing contract payments between a first agent and at least one second agent for a project, said system being operable over a communications network, said system including: at least one network server connected to said communications network, said at least one network server acting as a central repository for storing and sharing contract information associated with said project; and, at least one user operable terminal associated with each of said first and second agents, said user operable terminals being configured to be selectively connected to said communications network for creating, editing, viewing and/or approving said contract information associated with said project stored at said at least one network server; wherein said contract information includes: at least one contract which includes at least one contract item entity associated with said project and said second agent, said contract item entity representing a contract item being for a good and/or service provided by said second agent to said first agent in accordance with said contract, each contract item entity including: at least one item identifier for identifying said contract item; an item value representing a first monetary value of said contract item as agreed between said first agent and said second agent; a completion amount for said contract item which said second agent claims to have completed; a claim amount representing a second monetary value which said second agent claims for payment, said claim amount depending on said item value and said completion amount; and, an approval amount representing a third monetary value which is a portion between 0% and 100% of said claim amount approved by said first agent for payment to said second agent; and, wherein said at least one network server generates and provides at least one visual indicator for display on said user operable terminals, said at least one visual indicator being configured to graphically represent consolidated project-to-date contract information and/or contract item entity information.

In one practical preferred embodiment, said second agent populates said completion amount, and said first agent populates said approval amount based on assessment and/or agreement of said completion amount. In an alternative practical preferred embodiment, one of said first or second agents populates said completion amount, and also populates said approval amount based on self-assessment and/or agreement of said completion amount.

Preferably, said at least one visual indicator is/are a progress wheel and/or a progress bar. It is also preferred that said progress wheel and/or said progress bar utilise multiple colours or varying shades of a single colour to graphically represent consolidated project-to-date or current claim/approval contract information and/or contract item entity information.

Preferably, said system further includes at least one external software provider or server connected to said communications network, said at least one external software provider or server being selectively integrable with said at least one network server so as to enable data sharing between said at least one network server and said at least one external software provider or server, and/or to enable various external software functions to be automated and/or controlled by way of said at least one network server. It is also preferred that said at least one external software provider or server is selected from the group consisting of: an ERP software provider; a project collaboration software provider; a procurement software provider; a cost planning or budgeting software provider; an accounting software provider; and/or, any other suitable software or data provider that may provide associated or desired software or data that may be accessed or otherwise used by said at least one network server.

Preferably, at least one of said at least one user operable terminals is associated with at least one third agent who may also selectively connect to said communications network to at least edit and/or view said contract information associated with said project stored at said at least one network server.

Preferably, said at least one network server or at least third party notification service provider sends multiple notifications to first, second and/or third agents during the various phases or said project, these notifications may be selected from the following group: invitations to first, second and/or third agents to collaborate on said project; reminders to populate said completion amount so as to submit a claim for payment; notifications of submittal of said claims for payment; reminders to populate said approval amount based on assessment and/or agreement of said completion amount so as to approve a claim; reminders of approval deadlines in accordance with legislation governing said contract; notifications of approval of claims; and/or, reminders to claim for final completion and associated retention/retainage release.

Preferably said contract information further includes at least one variation/change order item entity associated with said project and said second agent, said variation/change order item entity representing a variation/change order item being for a good and/or service associated with said contract, each variation/change order item entity including: at least one item identifier for identifying said variation/change order item; an item value representing a first monetary value of said variation/change order item; a completion amount for said variation/change order item nominated by said first or second agent; and, an approval amount representing a third monetary value approved by said first agent for payment to or by said second agent, wherein said at least one network server generates and provides at least one visual indicator for display on said user operable terminals, said at least one visual indicator being configured to graphically represent consolidated project-to-date variation/change order item entity information.

In one practical preferred embodiment, said first or second agent populates said completion amount of said at least one variation/change order item entity, and said first agent populates said approval amount of said at least one variation/change order item entity based on assessment and/or agreement of said completion amount. In an alternative practical preferred embodiment, one of said first or second agents populates said completion amount of said at least one variation/change order item entity, and also populates said approval amount, of said at least one variation/change order item entity, based on self-assessment and/or agreement of said completion amount.

Preferably, any required supporting compliance documents must be submitted and/or verified before a claim for payment or approval of a claim can be made or processed.

Preferably, said at least one network server generates claim and payment schedule documents as part of the process of submitting a claim for payment or for approving a claim, the claim and payment schedule documents complying with relevant statutory adjudication legislation.

According to a further aspect, the present invention provides a method for managing contract payments, via a communications network, between a first agent and at least one second agent for a project, said method including the steps of: providing a central repository for storing and sharing contract information associated with said project; providing said first and said at least one second agents with controlled access to said central repository and said contract information stored therein so that they may selectively create, edit, view and/or approve said contract information associated with said project; wherein said contract information includes: at least one contract which includes at least one contract item entity associated with said project and said second agent, said contract item entity representing a contract item being for a good and/or service provided by said second agent to said first agent in accordance with said contract, each contract item entity including: at least one item identifier for identifying said contract item; an item value representing a first monetary value of said contract item as agreed between said first agent and said second agent; a completion amount for said contract item which said second agent claims to have completed; a claim amount representing a second monetary value which said second agent claims for payment, said claim amount depending on said item value and said completion amount; and, an approval amount representing a third monetary value which is a portion between 0% and 100% of said claim amount approved by said first agent for payment to said second agent; and wherein said method further includes the step of: generating and providing at least one visual indicator for display to said first and second agents, said at least one visual indicator being configured to graphically represent consolidated project-to-date contract information and/or contract item entity information.

In one practical preferred embodiment, said second agent populates said completion amount, and said first agent populates said approval amount based on assessment and/or agreement of said completion amount. In an alternative practical preferred embodiment, one of said first or second agents populates said completion amount, and also populates said approval amount based on self-assessment and/or agreement of said completion amount.

Preferably, said at least one visual indicator is/are a progress wheel and/or a progress bar. It is also preferred that said progress wheel and/or said progress bar utilise multiple colours or varying shades of a single colour to graphically represent consolidated project-to-date or current claim/approval contract information and/or contract item entity information.

Preferably, said central repository is at least one network server and said method further includes the step of: enabling at least one external software provider or server to be selectively integrated with said at least one network server so as to enable data sharing between said at least one network server and said at least one external software provider or server, and/or to enable various external software functions to be automated and/or controlled by way of said at least one network server. It is also preferred that said at least one external software provider or server is selected from the group consisting of: an ERP software provider; a project collaboration software provider; a procurement software provider; a cost planning or budgeting software provider; an accounting software provider; and/or, any other suitable software or data provider that may provide associated or desired software or data that may be accessed or otherwise used by said at least one network server.

Preferably, said method further includes the step of: providing at least one third agent with controlled access to said central repository and said contract information stored therein, so that said at least one third agent may at least selectively edit and/or view said contract information associated with said project.

Preferably, said method further includes the step of: generating and sending multiple notifications to first, second and/or third agents during the various phases of said project; these notifications may be selected from the following group: invitations to first, second and/or third agents to collaborate on said project; reminders to populate said completion amount so as to submit a claim for payment; notifications of submittal of said claims for payment; reminders to populate said approval amount based on assessment and/or agreement of said completion amount so as to approve a claim; reminders of approval deadlines in accordance with legislation governing said contract; notifications of approval of claims; and/or, reminders to claim for final completion and associated retention/retainage release.

Preferably, said contract information further includes at least one variation/change order item entity associated with said project and said second agent, said variation/change order item entity representing a variation/change order item being for a good and/or service associated with said contract, each variation/change order item entity including: at least one item identifier for identifying said variation/change order item; an item value representing a first monetary value of said variation/change order item; a completion amount for said variation/change order item nominated by said first or second agent; and, an approval amount representing a third monetary value approved by said first agent for payment to or by said second agent, wherein said at least one network server generates and provides at least one visual indicator for display on said user operable terminals, said at least one visual indicator being configured to graphically represent consolidated project-to-date variation/change order item entity information.

In one practical preferred embodiment, said first or second agent populates said completion amount of said at least one variation/change order item entity, and said first agent populates said approval amount of said at least one variation/change order item entity, based on assessment and/or agreement of said completion amount. In an alternative practical preferred embodiment, one of said first or second agents populates said completion amount of said at least one variation/change order item entity, and also populates said approval amount, of said at least one variation/change order item entity, based on self-assessment and/or agreement of said completion amount.

Preferably, any required supporting compliance documents must be submitted and/or verified before a claim for payment or approval of a claim can be made or processed.

Preferably, said method further includes the step of: generating claim and payment schedule documents as part of the process of submitting a claim for payment or for approving a claim, the claim and payment schedule documents complying with relevant statutory adjudication legislation

According to yet a further aspect, the present invention provides a non-transitory computer readable medium storing a set of instructions that, when executed by a machine, cause the machine to execute a method for managing contract payments, via a communications network, between a first agent and at least one second agent for a project, said method including the steps of: providing a central repository for storing and sharing contract information associated with said project; proving said first and said at least one second agents with controlled access to said central repository and said contract information stored therein so that they may selectively create, edit, view and/or approve said contract information associated with said project; wherein said contract information includes: at least one contract which includes at least one contract item entity associated with said project and said second agent, said contract item entity representing a contract item being for a good and/or service provided by said second agent to said first agent in accordance with said contract, each contract item entity including: at least one item identifier for identifying said contract item; an item value representing a first monetary value of said contract item as agreed between said first agent and said second agent; a completion amount for said contract item which said second agent claims to have completed; a claim amount representing a second monetary value which said second agent claims for payment, said claim amount depending on said item value and said completion amount; and, an approval amount representing a third monetary value which is a portion between 0% and 100% of said claim amount approved by said first agent for payment to said second agent; and wherein said method further includes the step of: generating and providing at least one visual indicator for display to said first and second agents, said at least one visual indicator being configured to graphically represent consolidated project-to-date contract information and/or contract item entity information.

These and other essential or preferred features of the present invention will be apparent from the description that now follows.

### BRIEF DESCRIPTION OF THE DRAWINGS

In order that the invention may be more clearly understood and put into practical effect there shall now be described in detail preferred constructions of a system and/or method for managing contracts associated with projects, preferably construction projects, in accordance with the invention. The ensuing description is given by way of non-limitative examples only and is with reference to the accompanying drawings, wherein:

FIG. 1 is a block diagram of a system for managing contracts associated with construction projects made in accordance with a preferred embodiment of the present invention;

FIG. 2 is a flow diagram illustrating a preferred embodiment of a method for managing contracts associated with construction projects, the preferred method being suitable for use with the preferred system shown in FIG. 1;

FIG. 3 is an exemplary graphical user interface (GUI) screen-shot illustrating a preferred project dashboard or home page screen that may be presented to a user in accordance with the preferred method of FIG. 2, and preferred system of FIG. 1;

FIG. 4 is an exemplary GUI screen-shot illustrating a preferred detailed project page or screen that may be presented to a user upon the user selecting to view details of a specific project displayed within the preferred project dashboard or home page screen of FIG. 3;

FIG. 5 is an exemplary GUI screen-shot illustrating a preferred new contract creation page(s) or screen(s) that may be presented to a user upon the user selecting to add a new contract for a specific project displayed within the preferred detailed project page or screen of FIG. 4;

FIG. 6 is an exemplary GUI screen-shot illustrating a preferred detailed contract page or screen that may be presented to a user upon the user selecting to view details of a specific contract displayed within the preferred detailed project page or screen of FIG. 4;

FIG. 7 is a flow diagram illustrating, in detail, how claims or payment applications may preferably be made in accordance with the preferred method for managing contracts associated with construction projects shown in FIG. 2;

FIG. 8 is an exemplary GUI screen-shot illustrating a preferred page or screen that may be presented to a user upon the user selecting to make a new claim or payment application in accordance with a selected contract displayed within the preferred detailed contract page or screen of FIG. 6;

FIG. 9 is a flow diagram illustrating, in detail, how claims or payment applications may preferably be assessed and/or approved in accordance with the preferred method for managing contracts associated with construction projects shown in FIG. 2; and,

FIG. 10 is an exemplary GUI screen-shot illustrating a preferred page or screen that may be presented to a user upon the user selecting to assess and/or approve a claim or payment application in accordance with the preferred method for assessing and/or approving claims shown in FIG. 9.

### DETAILED DESCRIPTION OF PREFERRED EMBODIMENTS

In the following detailed description of the invention, reference is made to the drawings in which like reference numerals refer to like elements throughout, and which are intended to show by way of illustration specific embodiments in which the invention may be practiced. It is to be understood that other embodiments may be utilised and that procedural and/or structural changes may be made without departing from the spirit and scope of the invention.

Unless specifically stated otherwise as apparent from the following discussion, it is to be appreciated that throughout the description, discussions utilising terms such as “processing”, “computing”, “calculating”, “acquiring”, “transmitting”, “receiving”, “determining”, and/or “displaying”, or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Discussions regarding apparatus for performing the operations of the invention are provided herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), erasable programmable read-only memory (EPROMs), electrically erasable programmable read-only memory (EEPROMs), magnetic or optical cards, or any type of media suitable for storing electronic instructions, and each coupled to a computer system bus.

The software modules, engines or applications, and displays presented herein are not inherently related to any particular computer or other apparatus. Various general purpose systems may be used with programs in accordance with the teachings herein, or it may prove convenient to construct more specialised apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

A machine-readable medium includes any mechanism for storing or transmitting information in a form readable by a machine (e.g., a computer). For example, a machine-readable medium includes read only memory (“ROM”); random access memory (“RAM”); magnetic disk storage media; optical storage media; flash memory devices; electrical, optical, acoustical or other form of propagated signals (e.g., carrier waves, infrared signals, digital signals, etc.); etc.

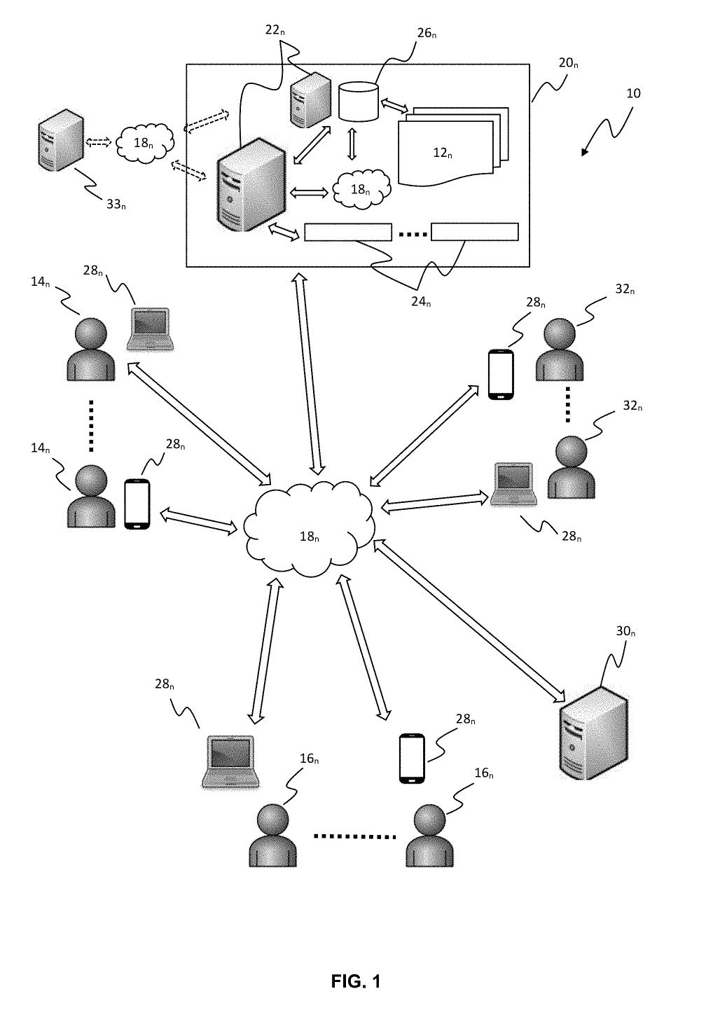

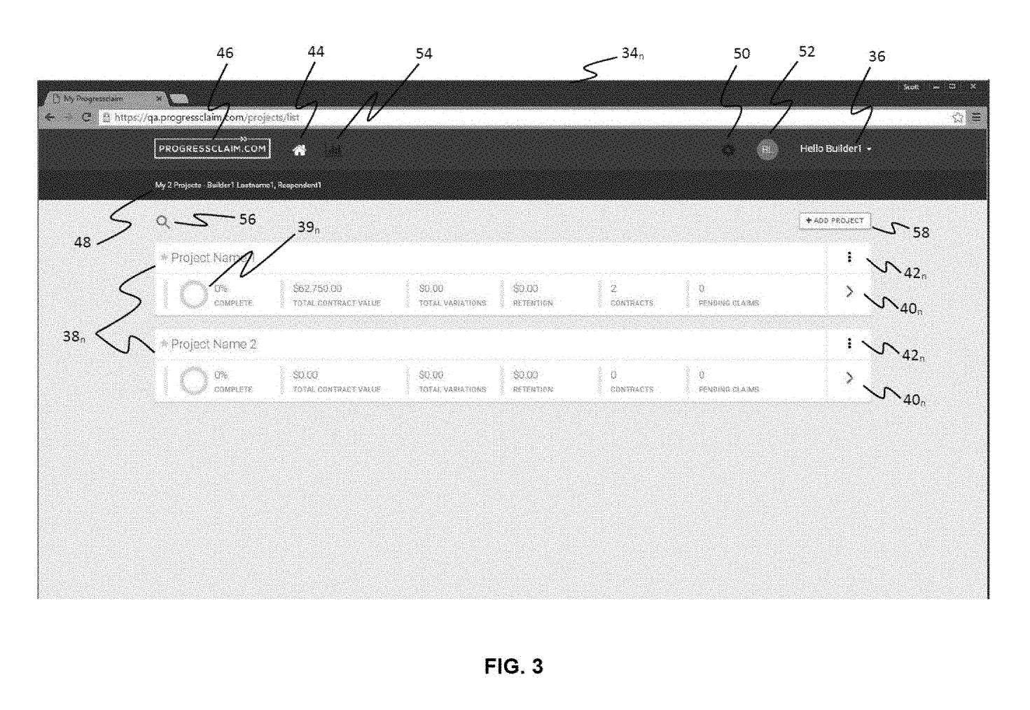

In FIG. 1 there is shown a preferred system 10 for managing contracts 12 associated with one or more projects 38ₙ (see, for example, FIGS. 3 & 4), such as, for example, construction projects 38ₙ as hereinbefore described. System 10 is configured for managing contract payments between a first agent 14ₙ (e.g. a general contractor, etc.) and at least one second agent 16ₙ (e.g. a subcontractor, etc.) involved in a construction project 38 (hereinafter simply referred to as “project(s) 38ₙ”). One or more first agent(s) 14ₙ and their appointed second agent(s) 16ₙ may use system 10 to (preferably) collaboratively manage contract payments for any number of projects 38ₙ. Alternatively, system 10 may be used as a “stand-alone” system should only one of first agent 14ₙ or second agent 16ₙ wish to use system 10 so as to “self-assess” one or more contracts 12ₙ for any given project 38ₙ-as will be described in further detail below. System 10 is suitable for use over a communications network(s) 18ₙ, as shown. It should be understood however, that system 10 is not limited to that use only. For example, although not shown in FIG. 1, it will be appreciated that system 10 could be provided to first and/or second agents 14ₙ, 16ₙ, by way of software and/or hardware installed locally on a single user terminal 28ₙ (i.e. enabling both a first and second agent(s) 14ₙ, 16ₙ, to collaborate using the same user terminal 28ₙ, or enabling one of a first or second agent 14ₙ, 16ₙ, to use system 10 in a stand-alone mode, without the need of communications network(s) 18ₙ).

System 10 includes at least one network server 20ₙ, which includes at least one computing device 22ₙ, which may host and/or maintain a plurality of tools or applications 24ₙ (e.g. software and/or hardware applications, etc.) and databases/storage devices 26ₙ, that provide a means of managing contract payments between a first agent 14ₙ and second agent(s) 16ₙ involved in a project 38ₙ.

Network server 20ₙ is designed to receive/transmit data from/to at least one user terminal 28ₙ, via communications network 18ₙ. The term “user terminal(s) 28ₙ” refers to any suitable type of computing device or software application, etc., capable of transmitting, receiving and/or displaying data as described herein, including, but not limited to, a mobile or cellular phone, a smart phone, an App (e.g. iOS or Android) for a smart phone, a connected Internet of Things (“IoT”) device; a Personal Digital Assistant (PDA), and/or any other suitable computing device, as for example a server, personal, desktop, tablet, or notebook computer.

Network server 20ₙ is also designed to receive/transmit data from/to at least one external software provider or server 30ₙ (hereinafter simply referred to as “external software provider(s) 30ₙ”), via communications network 18ₙ. The term “external software provider 30ₙ” refers to any suitable external service/software provider that hosts and/or maintains software or data (such as, for example, in a cloud environment) for first or second agents 14ₙ, 16ₙ, etc., and which software or data may be accessed or otherwise used by system 10 for the purpose of integration with system 10. External software providers 30ₙ may include, but are not limited to: ERP software providers, such as, for example, Viewpoint™, Jonpac™, Sage 300 Construction and Real Estate™ (formerly, Sage Timberline Office™), and, Construction Industry Solutions (COINS™); project collaboration software providers (e.g. document management providers, etc.), such as, for example, Aconex™; procurement software providers; cost planning or budgeting software providers; and/or, accounting software providers, such as, for example, Xero™, MYOB™, Quickbooks™, and, Sage One™; and/or, any other suitable software or data providers (whether cloud based, or otherwise) that may provide associated or desired software or data that may be accessed or otherwise used by system 10 for the purpose of integration with system 10.

User terminals 28ₙ are each configured to be operated by at least one user of system 10. The term “user” refers generally to first and second agents 14ₙ, 16ₙ, as hereinbefore described. The term “user” may also refer to one or more third agent(s) 32ₙ which may also use or interact with system 10 as will be described in further detail below. First, second 14ₙ, 16ₙ, and possibly third agents 32ₙ, are able to interact with system 10 by being in possession of, or stationed at, a user terminal(s) 28ₙ. In accordance with system 10, first, second 14ₙ, 16ₙ, and possibly third agents 32ₙ, may utilise a user terminal(s) 28ₙ in order to, for example: transmit, receive and/or display data associated with projects 38ₙ and one or more contracts 12ₙ associated therewith; submit or exchange information (e.g. project 38ₙ, contract 12ₙ or user information, supporting documentation, etc.) associated with projects 38ₙ and/or one or more contracts 12ₙ associated therewith; maintain permissions or access to projects 38ₙ or contracts 12ₙ in accordance with system 10; submit claims/applications for contract payments (for example, by a second agent 16ₙ); approve (in part or full) or decline claims/applications for contract payments (for example, by a first agent 14ₙ); transmit, receive and/or display data associated with external software provider(s) 30ₙ, and/or to allow system 10 to interact with external software provider(s) 30ₙ to, for example, exchange data, generate invoices, and/or to perform reconciliations or the like, etc.; and, receive notifications (e.g. reminders, etc.) from network server 20ₙ concerning projects 38ₙ or contracts 12ₙ, and the various phases associated therewith, in accordance with the invention.

User terminals 28ₙ may include various types of software and/or hardware (not shown) required for transmitting, receiving and/or displaying data to/from network server 20ₙ and external software provider(s) 30ₙ, via communications network 18ₙ, in accordance with system 10 including, but not limited to: web-browser or other GUI 34ₙ application(s) or App(s) (not shown), which could simply be an operating system installed on user terminal 28ₙ that is capable of actively transmitting, receiving and/or displaying data on a screen without the need of a web-browser GUI, etc.; monitor(s); GUI pointing devices; and/or, any other suitable data acquisition, transmission and/or display device(s) (not shown).

External software provider(s) 30ₙ is/are configured to be accessed by first, second and/or third agents 14ₙ, 16ₙ, 32ₙ, by way of their user terminal(s) 28ₙ, for the purpose of them viewing or using the software or data hosted and/or maintained thereat. External software provider(s) 30ₙ is/are also configured to be accessed by network server 20ₙ, preferably after having been authorised to do so by a first, second and/or third agent 14ₙ, 16ₙ, 32ₙ, so that the software and/or data hosted and/or maintained by external software provider(s) 30ₙ can be integrated with system 10. For example, should external software provider(s) 30ₙ be a cloud based accounting software provider (such as, for example, Xero™, MYOB ™, Quickbooks™, and, Sage One™, etc.), then system 10 may be configured to selectively and/or automatically import and/or exchange data between network server 20ₙ and external software provider 30ₙ so as to, for example, allow invoices to be generated automatically, or to allow accounts to be reconciled, etc. Similarly, should external software provider(s) 30ₙ be an ERP software provider (such as, for example, Viewpoint™, Jobpac™, Sage 300 Construction and Real Estate™, and, COINS™), then system 10 may be configured to selectively and/or automatically import/export and/or exchange data between network server 20ₙ and external software provider 30ₙ so as to, for example, allow ERP project or contract information, reference numbers, etc., to be imported into system 10, or to allow system 10 records to be reconciled with ERP records, etc.

Network server 20ₙ is configured to communicate with user terminals 28ₙ and external software provider(s) 30ₙ via any suitable communications connection or network 18ₙ (hereinafter referred to simply as a “network(s) 18ₙ”). External software provider(s) 30ₙ is/are configured to transmit and receive data to/from network server 20ₙ and user terminals 28ₙ, via network(s) 18ₙ. User terminals 28ₙ are configured to transmit, receive and/or display data from/to network server 20ₙ and external software provider(s) 30ₙ, via network(s) 18ₙ.

Each user terminal 28ₙand external software provider 30ₙ may communicate with network server 20ₙ (and each other, where applicable) via the same or a different network 18ₙ. Suitable networks 18ₙ include, but are not limited to: a Local Area Network (LAN); a Personal Area Network (PAN), as for example an Intranet; a Wide Area Network (WAN), as for example the Internet; a Virtual Private Network (VPN); a Wireless Application Protocol (WAP) network, or any other suitable telecommunication network, such as, for example, a GSM, 3G or 4G network; Bluetooth network; and/or any suitable WiFi network (wireless network). Network server 20ₙ, external software provider(s) 30ₙ, and/or user terminal 28ₙ, may include various types of hardware and/or software necessary for communicating with one another via network(s) 18ₙ, and/or additional computers, hardware, software, such as, for example, routers, switches, access points and/or cellular towers, etc. (not shown), each of which would be deemed appropriate by persons skilled in the relevant art.

For security purposes, various levels or security, including hardware and/or software, such as, for example, firewalls, tokens, two-step authentication (not shown), etc., may be used to prevent the unauthorized access to, for example, network server 20ₙ and/or external software provider(s) 30ₙ. Similarly, network server 20ₙ and/or external software provider(s) 30ₙ may utilise security (e.g. hardware and/or software—not shown) to validate access by user terminals 28ₙ, or when exchanging information between respective servers 20ₙ, 30ₙ. It is also preferred that network server 20ₙ performs validation functions to ensure the integrity of data transmitted between external software provider(s) 30ₙ and/or user terminals 28ₙ. A person skilled in the relevant art will appreciate such technologies and the many options available to achieve a desired level of security and/or data validation, and as such a detailed discussion of same will not be provided. Accordingly, the present invention should be construed as including within its scope any suitable security and/or data validation technologies as would be deemed appropriate by a person skilled in the relevant art.

Communication and/or data transfer between network server 20ₙ, external software provider(s) 30ₙ and/or user terminals 28ₙ, may be achieved utilising any suitable communication, software architectural style, and/or data transfer protocol, such as, for example, FTP, Hypertext Transfer Protocol (HTTP), Representational State Transfer (REST); Simple Object Access Protocol (SOAP); Electronic Mail (hereinafter simply referred to as “e-mail”), postal or regular mail, Unstructured Supplementary Service Data (USSD), voice, Voice over IP (VoIP), Transfer Control Protocol/Internet Protocol (hereinafter simply referred to as “TCP/IP”), Short Message Service (hereinafter simply referred to as “SMS”), Multimedia Message Service (hereinafter simply referred to as “MMS”), any suitable Internet based message service, any combination of the preceding protocols and/or technologies, and/or any other suitable protocol or communication technology that allows delivery of data and/or communication/data transfer between network server 20ₙ, external software provider(s) 30ₙ and/or user terminals 28ₙ, in accordance with system 10. Similarly, any suitable data transfer or file format may be used in accordance with system 10, including (but not limited to): text; a delimited file format, such as, for example, a CSV (Comma-Separated Values) file format; a RESTful web services format; a JavaScript Object Notation (JSON) data transfer format; a PDF (Portable Document Format) format; and/or, an XML (Extensible Mark-Up Language) file format.

Access to network server 20ₙ and the transfer of information between network server 20ₙ, external software provider(s) 30ₙ and/or user terminals 28ₙ, may be intermittently provided (for example, upon request), but is preferably provided “live”, i.e. in real-time. Similarly, system 10 may enable users, e.g. first, second or third agents 14ₙ, 16ₙ, 32ₙ, to, for example, prepare or approval claims or payment applications, etc., in an offline manner, such that when their user terminal(s) 28ₙ is/are again selectively connected to network(s) 18ₙ, those claims, payment applications, or approvals related thereto, may be received by network server 20ₙ, of system 10, and processed thereafter according to the invention as herein described.

As already outlined above, system 10 is designed to provide an improved process for managing contract payments between a first agent 14ₙ (e.g. a general contractor, etc.) and at least one second agent 16ₙ (e.g. a subcontractor, etc.) involved in a project 38ₙ. System 10 is designed and configured to simplify and automate the submission and approval of contract payment claims (e.g. progress claims, payment applications, etc.) between contractual parties (e.g. first and second agents 14ₙ, 16ₙ). System 10 facilitates the agreement between the parties 14ₙ, 16ₙ, as to the amount payable for any particular claim/application in accordance with a contract 12ₙ, but preferably does not control the transmittal of any actual funds.

System 10 does not make assumptions about the business/service type of any first or second agent 14ₙ, 16ₙ (e.g. financier, head contractor, consultant, subcontractor, etc.). Only their capacity to a specific contract 12ₙ (e.g. whether they are a first or second agent 14ₙ, 16ₙ) is considered. Contracts 12ₙ may be managed collaboratively (i.e. where both first and second agents 14ₙ, 16ₙ, are system 10 users), or in a stand-alone manner (i.e. where only one contractual party, e.g. first or second agent 14ₙ, 16ₙ, need be a system 10 user). System 10 preferably provides a single central repository for all users 14ₙ, 16ₙ and 32ₙ. A single account may preferably be used per first or second agent 14ₙ, 16ₙ, regardless of how many other second or first agents 16ₙ, 14ₙ, that user is managing contracts 12ₙ with. Each first, second or third agent 14ₙ, 16ₙ, 32ₙ, that uses system 10 has the capacity to maintain its own information. Where a first or second agent 14ₙ, 16ₙ has created a contract(s) 12ₙ in a stand-alone configuration then that first or second agent 14ₙ, 16ₙ, will also have the ability to maintain its own copy of its counterparty's (e.g. second or first agent 16ₙ, 14ₙ) details/information.

System 10 preferably supports first and/or second agents 14ₙ, 16ₙ, having multiple legal entities, so that a parent organisation operating multiple businesses or legal structures can have contracts 12ₙ related to each legal structure within the one system 10 account subscription. For example, where a first agent 14ₙ operates under different legal entities in various States of Australia, that first agent 14ₙ can use one system 10 account subscription to manage projects 38ₙ and contracts 12ₙ for all related legal entities.

Account subscriptions for use with system 10 are preferably managed at an organisation level, wherein one or multiple users may be associated with each account. Similarly, user permissions and notification options for each account subscription (and each user appointed to an account) are preferably configured at an organisation level, and may also be configured at a project 38ₙ level.

In accordance with system 10, one or more contracts 12ₙ exist within the context of a project 38ₙ. Each first, second and/or third agent 14ₙ, 16ₙ, 32ₙ, that is a party to one or more contracts 12ₙ for a project 38ₙ can see an aggregated set of values for its contracts 12ₙ on a per project 38ₙ basis. First and second agents 14ₙ, 16ₙ, preferably only ever see contracts 12ₙ to which they are a party thereto. Third agents 32ₙ, are preferably only ever able to see contracts 12ₙ, and associated project 38ₙ information, for projects 38ₙ to which they have been appointed as an authorised third-party agent by at least one of a first and/or second agent 14ₙ, 16ₙ. In accordance with system 10, access to contracts 12ₙ, may also be preferably further restricted based on user permissions at individual/organisation and/or project 38ₙ level. For example, access to contract payment claim/application information regarding a specific contract 12ₙ may be restricted based upon the status of a claim/application and/or the first or second agents 14ₙ, 16ₙ, capacity under the contract 12ₙ. As such, and by way of an example only, a first agent 14ₙ preferably cannot see a contract payment claim/application until it is submitted by a second agent 16ₙ, and likewise, the second agent 16ₙ preferably cannot see approval values applied to a contract payment claim/application until the approval process is finalised by the first agent 14ₙ. Contract payment claims/applications for any given contract 12ₙ may be made at the absolute discretion of second agent 16ₙ, subject to (preferably) having only one pending claim/application per contract 12ₙ at any time.

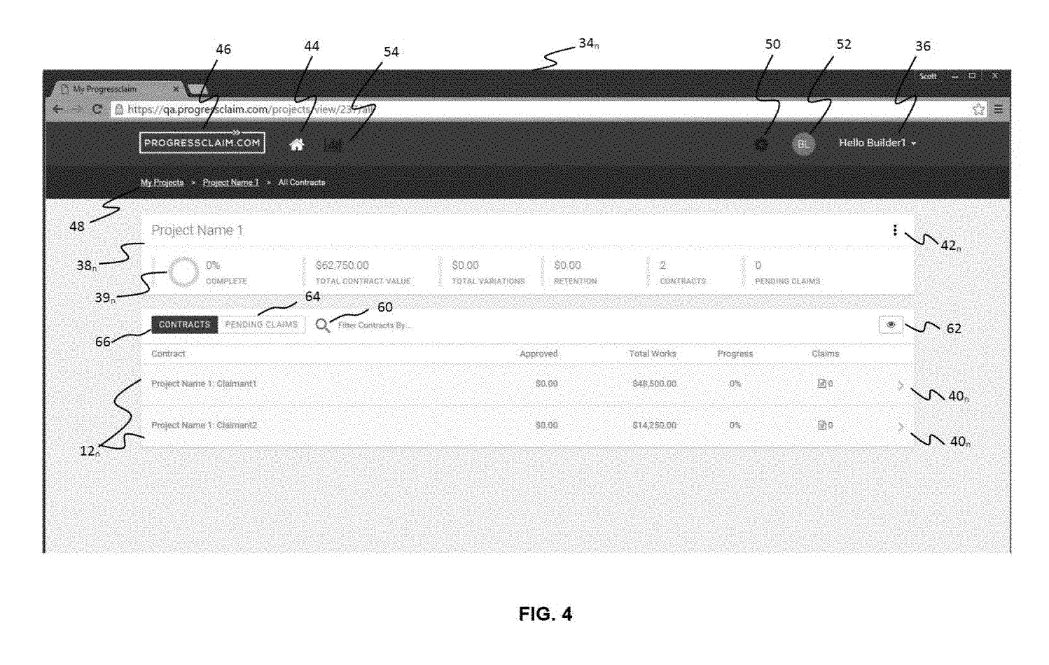

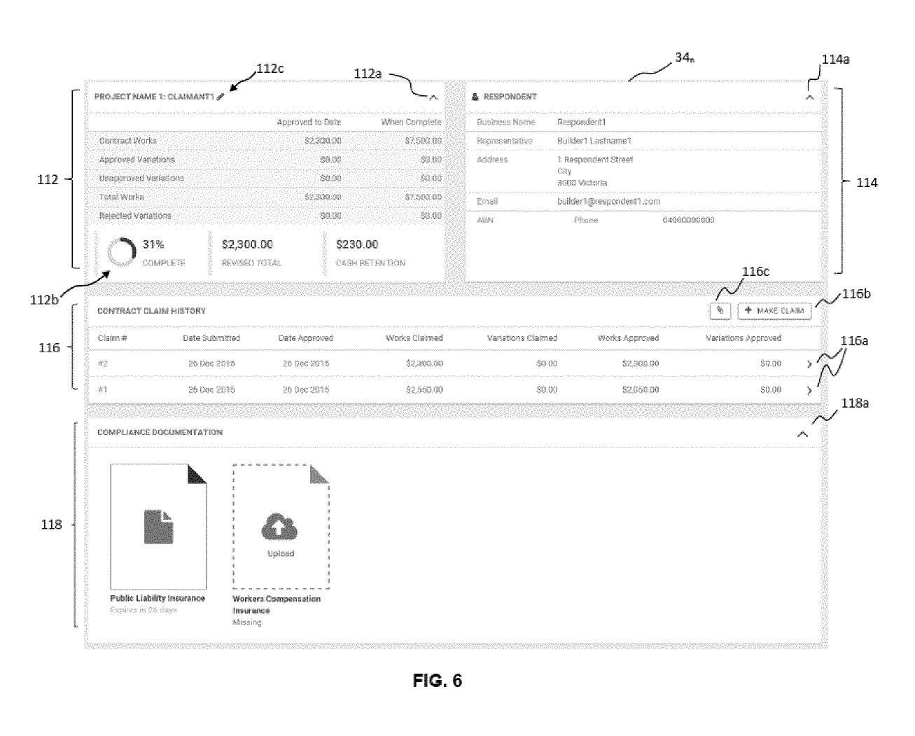

Each contract payment claim or payment application made in accordance with system 10 constitutes a project-to-date reconciliation of all claims or payment applications made under a specific contract 12ₙ to that point in time (i.e. the date and time upon which the claim/application is made/approved, or any given date in between claims/applications or approvals). As will be described in further detail below (with reference to, for example, FIGS. 6 & 8), each contract, contract payment claim or payment application clearly and cleverly shows or displays, using progress bars 120b, 122e, progress wheels 112b or the likes (e.g. other forms of colour coded visual indicators, etc.), amounts approved prior to a new claim/application being made, the cumulative value claimed up to the date of the new claim/application being made, and once approved, the assessed/certified cumulative value approved in accordance with the applicable contract 12ₙ. Further, for any given project 38ₙ, the completion status of all consolidated contracts 12ₙ associated with the project 38ₙ may be clearly and cleverly displayed by way of, for example, a number representing a completion percentage amount and/or a progress wheel 39ₙ (see, FIG. 4), progress bar, or the like (e.g. other form of colour coded visual indicator, etc.).

In accordance with system 10, required retention/retainage parameters for any given project 38ₙ can be set at a contract 12ₙ level. By setting or fixing retention/retainage amounts at a contract 12ₙ level, system 10 is able to automatically calculate retention/retainage amounts for each payment claim/application made against a specific contract 12ₙ. Hence, any retention/retainage amounts are always captured and automatically applied to contracts 12ₙ, and hence, contract payment claims/applications and approvals.

System 10 preferably stores (for example, in databases/storage devices 26ₙ, etc., of network server 20ₙ) a full history of all payment claims/applications relevant to each contract 12ₙ. A full audit trail of claimed versus approved values for contract payment claims/applications as at a point in time, along with all necessary supporting information/documentation is also preferably captured (i.e. attached to, or associated with, contracts 12ₙ, payment claims/applications, approved claims/applications, etc.) and stored (for example, in databases/storage devices 26ₙ, etc., of network server 20ₙ) by system 10. Supporting information/documentation can preferably be attached to a first or second agent's 14ₙ, 16ₙ, core system data at the following levels: contract 12ₙ; contract payment claim (e.g. progress claim or payment application, etc.); contract 12ₙ line item; and/or, claim line item. By keeping a full history or audit trail, along with capturing all necessary information/documentation associated with first and/or second agents 14ₙ, 16ₙ, etc., projects 38ₙ and contracts 12ₙ associated therewith, system 10 is also able to assist all contractual parties (e.g. first and second agent(s) 14ₙ, 16ₙ) to comply with the relevant statutory adjudication legislation or rules governing a contract 12ₙ, such as, for example the Australian Security of Payments legislation, etc.

Given that both network server 20ₙ and user terminals 28ₙ, of system 10, are configured to interact with external software provider(s) 30ₙ, system 10 also streamlines and improves other processes associated with the management of projects 38ₙ and contracts 12ₙ associated therewith. By being able to integrate system 10 with, for example, an ERP software provider (such as, for example, Viewpoint™, Jobpac™, Sage 300 Construction and Real Estate™, and, COINS™), compliance with, for example, a first agent's 14ₙ ERP software is very simply and effectively achieved. Likewise, integration with, for example, cloud based accounting software providers (such as, for example, Xero™, MYOB™, Quickbooks™, and, Sage One™), enables system 10 to streamline and simplify accounting processes, such as, for example, invoicing and account reconciliations, for first and/or second agents 14ₙ, 16ₙ, etc. Of course there could be many other forms of software and/or data hosted and/or maintained by external software provider(s) 30ₙ which could be accessed and integrated with system 10 in accordance with the invention. Accordingly, the present invention should not be constructed as limited to any one or more of the integration examples provided herein, but instead should be construed broadly so as to include within its scope any form of integration with external software and/or data that would be deemed appropriate and/or applicable by a skilled person.

System 10 preferably also generates and sends multiple notifications during the various phases of a project 38ₙ. Such notifications may be generated and sent by network server 20ₙ of system 10, or may be generated and sent by an external or third party server or provider 33ₙ, such as, for example, Mandrill™, or any other suitable third party notification server/provider 33ₙ. It is preferred that one or more of the following notifications are generated and sent in accordance with system 10: invitations (to first, second and/or third agents 14ₙ, 16ₙ, 32ₙ) to collaborate using system 10; reminders (to second agents 16ₙ) to submit contract payment claims/applications on a given day of the month (on a per project 38ₙ basis); notifications (to first agents 14ₙ) of contract payment claim/application submissions, with system-generated documents (and any documents supplied by second agents 16ₙ) attached thereto; reminders (to first agents 14ₙ) that a contract payment claim/application is close to the approval deadline under the relevant legislation, if any, governing the contract; reminders (to approvers, e.g. third agents 32ₙ, in a multi-stage approval project 38ₙ) that one or more contract payment claims/applications are up to their approval stage; notifications (to second agents 16ₙ, etc.) of contract payment claim/application approvals with system-generated documents (and any documents supplied by first agents 14ₙ, etc.) attached thereto; and/or, reminders (to second agents 16ₙ) to claim for final completion and associated retention/retainage release. Of course there could be many other forms of notifications generated and sent in accordance with system 10 of the present invention. Accordingly, the present invention should not be constructed as limited to any one or more of the notification examples provided herein, but instead should be construed broadly so as to include within its scope any form of notification that would be deemed appropriate and/or applicable by a skilled person.

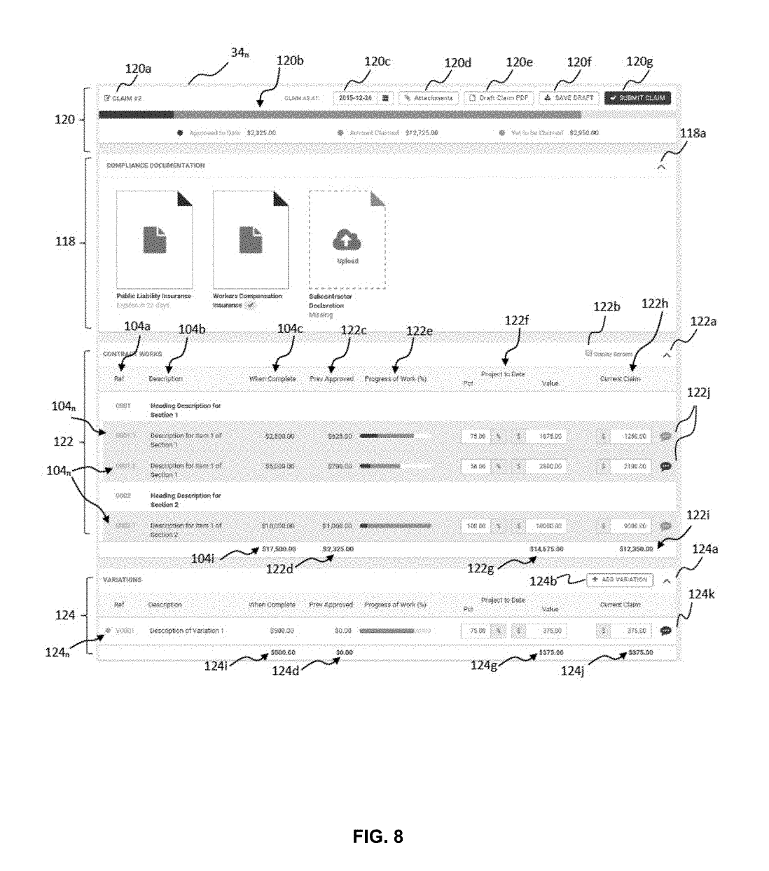

As already briefly outlined above, the one or more computing device(s) 22ₙ of network server 20ₙ, of system 10, may host and/or maintain a plurality of applications 24ₙ (such as software and/or hardware modules or engines) and databases/storage devices 26ₙ that enable multiple aspects of system 10 to be provided over network(s) 18ₙ. These applications 24ₙ and databases/storage devices 26ₙ may include, but are not limited to: one or more databases/storage devices 26ₙ for storing: user (e.g. first, second and third agent 14ₙ, 16ₙ, 32ₙ) information; project 38ₙ information; and/or, contract 12ₙ information (such as, for example, full history or audit trail of payment claims/approvals made in accordance with a contract 12ₙ, along with any/all supporting information/documentation applicable to each contract 12ₙ and/or claim/approval); one or more module(s) or application(s) 24ₙ for communicating with user terminals 28ₙ for the purpose of receiving, processing and/or capturing: user (e.g. first, second and third agent 14ₙ, 16ₙ, 32ₙ) information (including user permissions and/or access information, multiple entity information, etc.); project 38ₙ information; and/or, contract 12ₙ information/documentation (including any supporting information/documentation, retention/retainage information, etc.); one or more module(s) or application(s) 24ₙ for communicating with user terminals 28ₙ for the purpose of receiving, processing and/or capturing contract payment claim/application information (including any variation/change order information, and any supporting information/documentation applicable to each claim/application); one or more module(s) or application(s) 24ₙ for communicating with user terminals 28ₙ for the purpose of receiving, processing and/or capturing contract payment claim/application approval or disapproval information (including any supporting information/documentation applicable to the approval or otherwise of each claim/application); one or more module(s) or application(s) 24ₙ for calculating and determining retention/retainage amounts applicable to each contract 12ₙ and payment claim/application and approval made against each contract 12ₙ; one or more module(s) or application(s) 24ₙ for generating and displaying project-to-date financial data reconciliation or consolidation information (hereinafter simply referred to as “financial data display engine 24ₙ”), such as, for example, in the form of progress wheels 39ₙ, 112b (see, for example, FIGS. 3 & 4, or FIG. 6) and/or progress bars 120b, 122eₙ (see, for example, FIGS. 8 & 10), or some other form of (preferably) colour coded visual indicator, etc. (not shown), applicable to each project 38ₙ (e.g. using progress wheels 39ₙ, etc.), contract 12ₙ (e.g. using progress wheels 112b, or progress bars 120b, etc.) and contract item(s) 104ₙ or variation/change order item(s) 124ₙ (e.g. using progress bars 122e, etc.), etc.; one or more module(s) or application(s) 24ₙ for communicating with user terminals 28ₙ and external software provider(s) 30ₙ for the purpose of integrating system 10 with the external software and/or data hosted and/or maintained by external software provider(s) 30ₙ; one or more module(s) or application(s) 24ₙ (which could, for example, be provided by a third party notification server or provider 33ₙ, e.g. Mandrill™, etc.) for generating and sending notifications to users (e.g. first, second and/or third agent 14ₙ, 16ₙ, 32ₙ) via their user terminals 28ₙ; and/or, one or module(s) or application(s) 24ₙ (which could, for example, be provided by a third party payment gateway server or provider 33ₙ, such as, for example, Stripe™, PayPal™, etc.) for processing user (e.g. first, second and/or third agent 14ₙ, 16ₙ, 32ₙ) account subscription payments for system 10.

Although separate modules, applications or engines 24ₙ have been outlined, each for effecting specific preferred aspects (or combinations thereof) of system 10, it should be appreciated that any number of modules/applications/engines 24ₙ for performing any one, or any suitable combination of, aspects of system 10, could be provided in accordance with the present invention. Similarly, it should be appreciated that not all of databases/storage devices 26ₙ and/or modules/applications/engines 24ₙ as described herein need be hosted and/or maintained by network server 20ₙ of system 10 in order to perform the invention. That is, any one or more of database(s)/storage device(s) 26ₙ and/or modules/applications/engines 24ₙ could be hosted or provided by a third party server or provider 33ₙ (such as, for example: Mandrill™, or other notification service provider 33ₙ, etc., in the case of the one or more module(s) or application(s) 24ₙ for generating and sending notifications to users 14ₙ, 16ₙ, 32ₙ; and/or, Stripe™, or other payment gateway provider 33ₙ, etc., in the case of the one or more modules(s) or application(s) 24ₙ for processing user, 14ₙ, 16ₙ, 32ₙ, account subscription payments on behalf of system 10). A skilled person will appreciate that many such, or alternative, third party server(s) or provider(s) 33ₙ could be used to provide any number of the preferred aspects or features of the present invention as herein described. Accordingly, network server 20ₙ, of system 10, of the present invention should not be construed as having to provide all of database(s)/storage device(s)/application(s)/module(s) 26ₙ/24ₙ in order to perform the teachings of the invention.

In order to clearly demonstrate that network server 20ₙ need not provide all of application(s)/engine(s)/module(s) 24ₙ, or database(s)/storage device(s) 26ₙ, of system 10, in order to perform the teachings of the invention, and hence, that any one or more of the database(s)/storage device(s)/application(s)/module(s) 26ₙ/24ₙ, may be provided by an external third party server(s) or provider(s) 33ₙ, in FIG. 1, network server 20ₙ is depicted as being connected to, or in communication with, third party server(s)/provider(s) 33ₙ by way arrows illustrated in dashed-lines and network(s) 18ₙ (which of course may be the same or a different network(s) 18ₙ (e.g. a secure network(s) 18ₙ) to that of all other network(s) 18ₙ depicted in FIG. 1). The arrows representing the connection or communication between network server 20ₙ and third party server(s)/provider(s) 33ₙ, via network(s) 18ₙ, are illustrated in dashed-lines so as to demonstrate that the use of one or more third party server(s)/provider(s) 33ₙ in accordance with system 10 is optional, i.e. if desired, network server 20ₙ could readily provide all aspects of system 10.

In order to provide a more detailed understanding of the operation of preferred system 10 of the present invention, reference will now be made to the exemplary GUI screen-shots 34ₙ (e.g. web-browser GUI screen-shots, or other similar GUI screen-shots, as shown) shown in FIGS. 3, 4, 5, 6, 8 & 10, which illustrate preferred constructions of various screens or pages 34ₙ that may be presented to first, second and/or third agents 14ₙ, 16ₙ, 32ₙ, in accordance with system 10 as herein described. Although exemplary web-browser GUI screen-shots 34ₙ are shown and described with reference to FIGS. 3, 4, 5, 6, 8 & 10, it will be appreciated that any suitable GUI 34ₙ may be used depending on the application of system 10 (e.g. collaborative versus stand-alone, etc.), and the way in which GUI(s) 34ₙ of system 10 are accessible via, for example, network(s) 18ₙ, to first, second and/or third agents 14ₙ, 16ₙ, 32ₙ, via user terminals 28ₙ. Similarly, the content of GUI screen-shots 34ₙ shown in FIGS. 3, 4, 5, 6, 8 & 10 only represents an example of the type of information that may be displayed to users (e.g. first, second and/or third agents 14ₙ, 16ₙ, 32ₙ) of system 10. Accordingly, the present invention should not be construed as being limited to any or more of the specific GUI screen-shot 34ₙ examples provided.

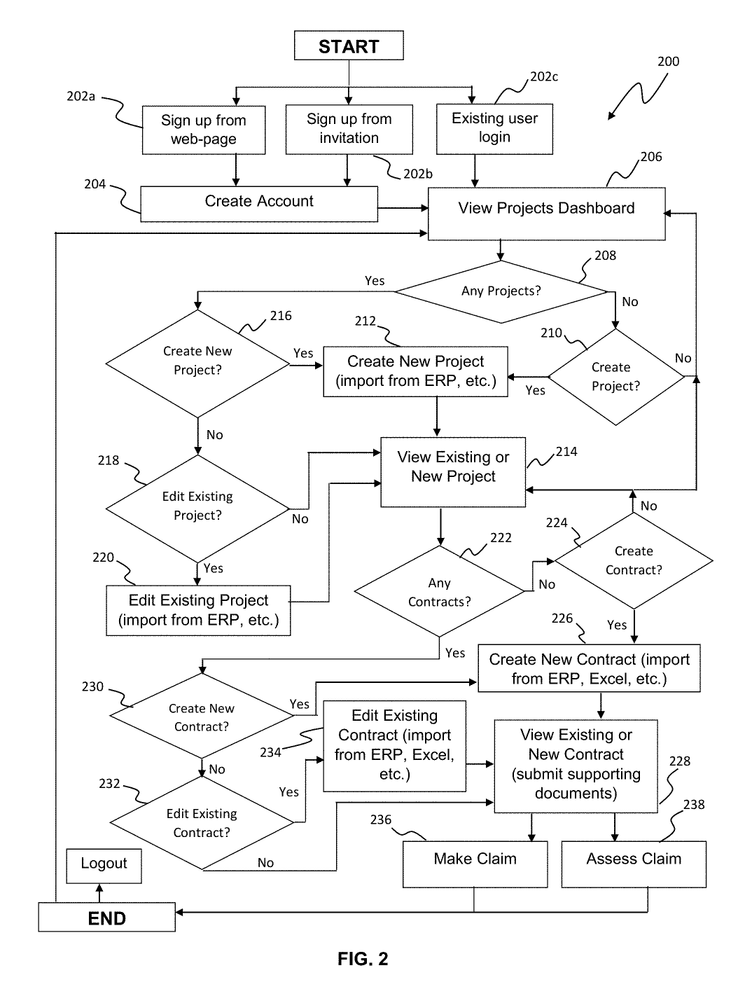

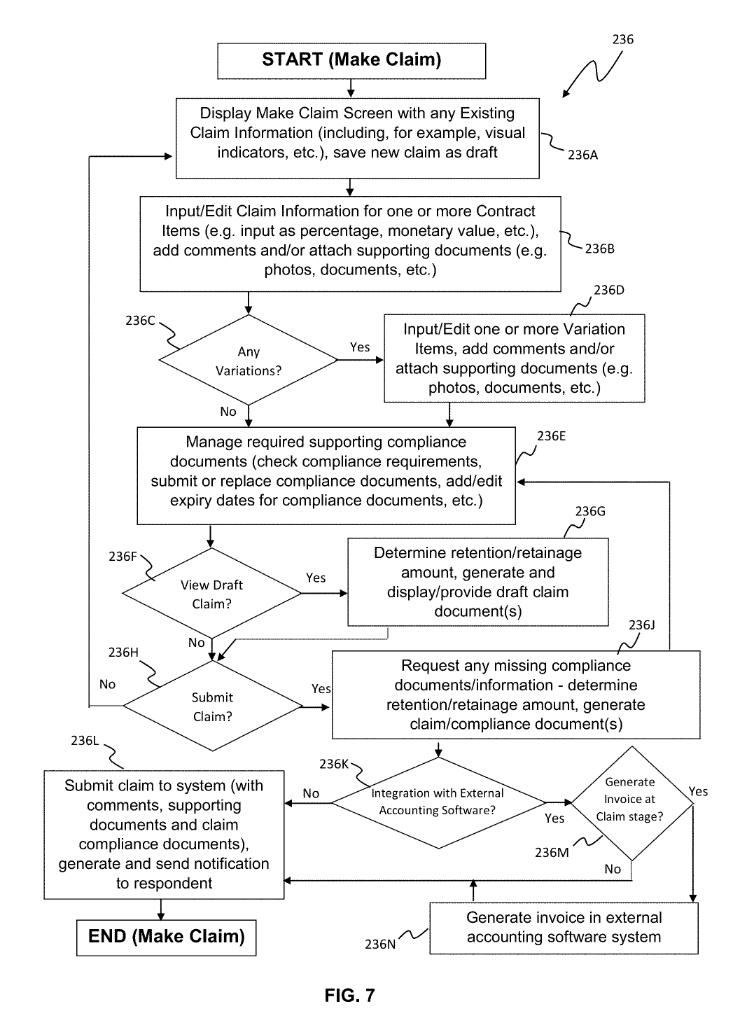

Preferred GUI screen-shots 34ₙ of FIGS. 3, 4, 5, 6, 8 & 10 will be described in conjunction with the flow diagrams of FIGS. 2, 7 & 9, which illustrate preferred methods 200, 236, 238, for managing contract payments between a first agent 14ₙ (e.g. a general contractor, etc.) and at least one second agent 16ₙ (e.g. a subcontractor, etc.) involved in a project 38ₙ. Preferred methods 200, 236, 238, are suitable for use with system 10 (shown in FIG. 1) of the present invention. It should be understood, however, that preferred methods 200, 236, 238, described with reference to the flow diagrams of FIGS. 2, 7 & 9, only illustrate examples of the way in which project contract payments may be managed in accordance with system 10. Many other methods (not shown) may be utilised to achieve the same or similar result and as such the present invention should not be construed as limited to the specific examples provided. Further, it will be appreciated by a skilled person that not all method steps are recited herein, and/or that some method steps that are recited herein are not essential to the operation of methods 200, 236, 238. Various steps that are not recited, or which may be readily omitted, will be readily apparent to a skilled person and thus need not be described in detail herein.

A flow diagram illustrating a preferred method 200 for managing contract payments associated with projects 38ₙ is shown in FIG. 2. As can be seen in FIG. 2, the preferred process of managing contract payments associated with projects 38ₙ in accordance with method 200 commences at one of steps 202a, 202b, or 202c, depending on whether or not a user, e.g. a first, second or third agent 14ₙ, 16ₙ, 32ₙ, already has an existing user account and login details for accessing system 10 (as represented by step 202c), or whether or not the user 14ₙ, 16ₙ, 32ₙ, elects to sign up and create their own account without being prompted (as represented by step 202a), or is invited or otherwise prompted to sign up and create an account by another user 14ₙ, 16ₙ, 32ₙ, so as to be able to collaborate on a project 38ₙ with that other user(s), 14ₙ, 16ₙ, 32ₙ (as represented by step 202b).

When a user 14ₙ, 16ₙ, 32ₙ, wishes, or is prompted, to sign up to create an account by way of either steps 202a or 202b, method 200 continues at step 204, whereat the user 14ₙ, 16ₙ, 32ₙ, is provided with a GUI screen(s) (not shown), accessible via their user terminal(s) 28ₙ, for inputting the required information necessary to create a new account. Should the user (e.g. a first or second agent 14ₙ, 16ₙ) have been invited to sign up and create an account (as represented by step 202b) by another (existing) user (e.g. a second or first agent 16ₙ, 14ₙ) of system 10, then some of the required information (such as, for example, the individual/entity name, address, e-mail address, and/or telephone number, etc.) necessary to create a new account may have been already pre-populated for that user 14ₙ, 16ₙ, by system 10 (e.g. by way of having been previously inputted by the inviting party, e.g. second or first agent 16ₙ, 14ₙ).

Information required for creating a new account may include, but is not limited to: one or more valid e-mail address(es); individual/organisation details (which could include multiple individuals/entities) including name(s), address(es), company registration details, telephone number(s), etc.; logos (e.g. company logos, etc.) or profile pictures;

permissions for each individual/entity, if applicable; and/or, payment details (e.g. credit card, direct debit, etc.) necessary for charges associated with the user 14ₙ, 16ₙ, 32ₙ, account, if applicable. To assist a user 14ₙ, 16ₙ, 32ₙ, with inputting the required information for creating a new account, system 10 may provide automated tools (not shown) for capturing certain user 14ₙ, 16ₙ, 32ₙ, information, such as, for example, an automated tool for looking up and capturing an address(es) in the correct format required for a certain jurisdiction, or an automated tool for looking up and capturing company registration details (e.g. an ABN (Australian Business Number) or ACN (Australian Company Number) look up facility for Australian company registration details). A skilled person will appreciate these and other such automated tools or facilities (not shown) which could be used for automating the capture of user 14ₙ, 16ₙ, 32ₙ information in accordance with system 10 of the present invention. Accordingly, a detailed discussion of how such tools or facilities operate need not be provided herein. Regardless of how the required user 14ₙ, 16ₙ, 32ₙ information is inputted by way of GUI screen(s) (not shown), such information is captured (by way of, e.g. one or more module(s) or application(s) 24ₙ of network server 20ₙ) and stored (in, for example, one or more databases/storage devices 26ₙ associated with network server 20ₙ) by system 10. A skilled person will appreciate many ways in which an account for use with system 10 may be created in accordance with the present invention, and as such, a detailed discussion of how an account may be created need not be provided herein. Similarly, processes and varying levels of authentication, etc., for logging into and out of system 10 will be readily understood by a skilled person, and as such, those processes, authentication requirements, etc., need not be described herein in detail. Accordingly, any suitable account creation, sign-in/sign-out processes, and/or authentication techniques are to be understood as being included within the spirit and scope of the invention as herein described.

After having signed up and created a new account at step 204, or after having logged into system 10 by way of an existing user 14ₙ, 16ₙ, 32ₙ, account (as represented by step 202c), method 200 continues at step 206, whereat the user 14ₙ, 16ₙ, 32ₙ, is presented with, or arrives at, their GUI “project dashboard” screen 34ₙ (hereinafter simply referred to as “dashboard screen 34ₙ”), by way of their user terminal(s) 28ₙ. The dashboard screen 34ₙ is also preferably the “home page” of the preferred GUI 34ₙ interface(s)/screen(s)/page(s) provided by system 10. An exemplary GUI screen-shot 34ₙof a preferred dashboard screen 34ₙ is shown in FIG. 3.

Referring to FIG. 3, it can be seen that preferred dashboard screen 34ₙ, which in this example is that of a first agent 14ₙ or “builder” (as is indicated by the exemplary generic name (which would normally simply be the user's 14ₙ name, initials, alias, etc., and not a reference to the user's 14ₙ, etc., role as part of a project 38ₙ) applied to the button or region 36 toward the top right hand corner of screen 34ₙ—the button/region 36 revealing a drop-down menu or the like (not shown) when selected or hovered over using a GUI pointing device, pen, finger, etc.—as will be described in further detail below) preferably displays one or more projects 38ₙ with which first agent 14ₙ is involved. If first agent 14ₙ has yet to create any projects 38ₙ for use with system 10, dashboard screen 34ₙ may simply be presented to first user 14ₙ as a blank screen (not shown) until such time that one or more new project(s) 38ₙ are created (preferred processes for creating new projects 38ₙ will be described in detail below). Likewise, if first agent 14ₙ (or any other agent 16ₙ, 32ₙ, for that matter) is only involved in a single project 38ₙ, then dashboard screen 34ₙ may be configured to display that single project 38ₙ in a more detailed, or expanded manner/view, such that, for example, brief details of any/all contracts 12ₙ associated with that project 38ₙ, and any other desired project 38ₙ related information, is/are visible by default upon logging into system 10 and arriving at dashboard screen 34ₙ (see, for example, the exemplary single project 38ₙ expanded GUI screen-shot 34ₙ shown in FIG. 4—which will be described in further detail below).

Each project 38ₙ displayed on dashboard screen 34ₙ, in its concise or collapsed format as shown in FIG. 3, preferably provides summary information concerning the status of all contracts 12ₙ associated with that particular project 38ₙ. This summary information may include, but is not limited to: consolidated contract 12ₙ completion percentage information, which is preferably presented as both a number and by way of a progress wheel 39ₙ or the like (e.g. other form of visual indicator, etc.), which may preferably, and cleverly, visually display the completion status of all consolidated contracts 12ₙ for a project 38ₙ, using, for example, multiple colours, e.g. one colour for approved contract 12ₙ status information, another colour for pending contract 12ₙ claim/application status information, and yet another colour for disapproved or variations/change order contract 12ₙ claim/application status information; consolidated total contract 12ₙ value information; consolidated total contract 12ₙ variation/change order information; consolidated contract 12ₙ retention/retainage information; the number of contracts 12ₙ associated with the specific project 38ₙ; and/or, the number of pending payment claims/applications made in accordance with contracts 12ₙ associated with the specific project 38ₙ. Although examples of the type of summary information that may be displayed with respect to each concise view of a project 38ₙ, shown on dashboard screen 34ₙ, is provided, it will be appreciated that many variations or modifications of such summary information that may be displayed could be made without departing from the spirit and scope of the invention. Accordingly, the present invention should not be construed as limited to the specific examples provided.

As already outlined above, it is preferred that the consolidated financial information and/or progress wheels 39ₙ or the like (e.g. other form of visual indicator, etc.) that are displayed within dashboard screen 34ₙ, of FIG. 3, are generated by financial data display engine 24ₙ of network server 20ₙ (or a third party service provider 33ₙ, if desired) of system 10. Upon a user 14ₙ, 16ₙ, 32ₙ, requesting or otherwise being provided with dashboard screen 34ₙ of FIG. 3, financial data display engine 24ₙ preferably retrieves, calculates, analyses and/or manipulates all necessary financial data, and then populates the relevant fields or regions for each project 38ₙ (displayed in its concise or collapsed form) provided within dashboard screen 34ₙ. The consolidated financial data for display within dashboard screen 34ₙ, may have been prepared in advance by financial data display engine 24ₙ, i.e. upon a last transaction (e.g. a project 38ₙ or contract 12ₙ being created, a claim/payment application being made or approved, etc.) being completed, or may be prepared in (substantially) real-time upon, for example, a request being received by system 10 to display a dashboard screen 34ₙ.

Although not shown in the drawings, it will be appreciated that dashboard screen 34ₙ of FIG. 3, and/or any of the other preferred GUI screens 34ₙ shown in FIGS. 4, 5, 6, 8 & 10, may be displayed in a condensed format suitable for display within/on small GUI facilities 34ₙ, such as, for example, for display on mobile devices or the like (i.e. user terminals 28ₙ, such as, for example, smart phones or tablets). Even in instances when not displayed on a mobile device 28ₙ, it is preferred that system 10 uses a responsive web design (RWD) programming approach such that any content displayed on any of GUI screens 34ₙ of system 10 of the present invention, is automatically condensed when, for example, the GUI screen 34ₙ is minimised length wise, or otherwise resized, so as to avoid project 38ₙ, contract 12, etc., information being chopped off, or otherwise not viewable, when GUI screen 34ₙ is minimised length wise, resized, etc. A person skilled in the relevant art will appreciate suitable RWD web programming approaches, and hence, how content displayed within a GUI screen 34ₙ may be readily condensed for display on, for example, a mobile device 28ₙ, or may be condensed upon a GUI screen 34ₙ being reduced in size, etc. Accordingly, a detailed discussion of how content displayed within GUI screens 34ₙ may be condensed in accordance with system 10 of the present invention need not be provided herein.

If dashboard screen 34ₙ includes more than one project 38ₙ, then each project 38ₙ displayed on dashboard screen 34ₙ (in the concise or collapsed format shown in FIG. 3) may preferably be expanded (to, for example, the exemplary single project 38 expanded GUI screen-shot 34ₙ shown in FIG. 4) by simply selecting or hovering over (e.g. using a GUI pointing device, pen, finger, etc.) any region of the selected project 38ₙ shown on dashboard screen 34ₙ. Alternatively, first user 14ₙ, etc., may select or hover over (e.g. using a GUI pointing device, pen, finger, etc.) the button or region 40ₙ marked with an “>”, toward the right hand side of each project 38ₙ shown on dashboard screen 34ₙ. Yet a further preferred option for expanding the concise or collapsed view of a particular project 38ₙ shown on dashboard screen 34ₙ, may be to select or hover over (e.g. using a GUI pointing device, pen, finger, etc.) the button or region 42ₙ marked with the three vertically aligned dots, toward the right hand side of each project 38ₙ shown on dashboard screen 34ₙ, which may then reveal (by way of, for example, a drop-down menu, pop-up screen or the like—not shown) one or more further buttons or regions (not shown), including a button or region, e.g. a “show project” or “view project” button or region, that may then be selected or hovered over (e.g. using a GUI pointing device, pen, finger, etc.) so as to expand the view of a particular project 38ₙ. Although not shown, selecting or hovering over the button or region 42ₙ, may also reveal a button or region, e.g. an “Edit Project” button or region, which may be selected or hovered over so as to enable a first agent 14ₙ, etc., to edit the particular project 38ₙ if or as desired (examples of how a project 38ₙ may be edited in accordance with system 10 will be provided below). Of course, there may be many other ways in which the concise or collapsed view of a particular project 38ₙ (FIG. 3) may be changed to an expanded view (to, such as, the expanded view shown in FIG. 4) in accordance with system 10 of the present invention. Accordingly, the present invention should not be construed as limited to the specific examples provided.

Regardless of the way in which a particular project 38ₙ may be displayed in an expanded or more detailed view (see, for example, FIG. 4) in accordance with system 10, first user 14ₙ, etc., may return to their dashboard screen 34ₙ (FIG. 3) at any time by (preferably) either selecting or hovering over (e.g. using a GUI pointing device, pen, finger, etc.) the home button or region 44, or the system 10 branded button or region 46, or by using an inbuilt GUI “back” button should one be available. Yet a further preferred option for returning to one's dashboard screen 34ₙ could be to select or hover over (e.g. using a GUI pointing device, pen, finger, etc.) the root or first directory (e.g. “My 2 Projects”, as shown) of the navigation element 48 shown, in FIG. 3, toward the top left hand side of dashboard screen 34ₙ. Of course, there may be many other ways in which a user 14ₙ, 16ₙ, 32ₙ, may return to their dashboard screen 34ₙ in accordance with system 10 of the present invention. Accordingly, the present invention should not be construed as limited to the specific examples provided.

As already briefly discussed above, by selecting of hovering over (using a GUI pointing device, pen, finger, etc.) button or region 36, of dashboard screen 34ₙ, a drop-down menu or the like (not shown), may be revealed which may provide a number or buttons or regions (not shown) which may be selected or hovered over, etc., so as to perform other functions of system 10. These buttons or regions (not shown) may include, but are not limited to: a button/region for accessing one's account settings, e.g. a “My Account” button or region; a button/region for accessing details about client (e.g. developer, owner, etc.) and/or supplier (e.g. subcontractor, engineer, etc.) counterparty details, e.g. a “Counterparties” button or region (which may, for example, enable a user 14ₙ, 16ₙ, to quickly and conveniently check and/or view details concerning how many clients (i.e. respondents) and/or suppliers (e.g. claimants) they are associated with, etc.); a button/region for accessing demonstrational videos, FAQs and/or help or online chat/forum facilities, e.g. a “Getting Started” or “Help”, etc., button or region; and/or, a button/region for logging out of system 10, e.g. a “Logout” button or region.

Instead of using the preferred “My Account” button or region (not shown) that may be included within the preferred drop-down menu (not shown) that may be revealed after selecting or hovering over (using a GUI pointing device, pen, finger, etc.) button or region 36, of for example, dashboard screen 34ₙ, in order to access one's 14ₙ, 16ₙ, 32ₙ, account details, dashboard screen 34ₙ may also preferably include an additional “My Account” button or region 50, that may be selected or hovered over (using a GUI pointing device, pen, finger, etc.) so as to access one or more screen(s) (not shown) that list the user's 14ₙ, 16ₙ, 32ₙ, account details. Within this/these screen(s), a user 14ₙ, 16ₙ, 32ₙ, may add, edit or update information or settings related to their account (which may vary depending on the user's 14ₙ, 16ₙ, 32ₙ, role within system 10, e.g. a first agent 14ₙ, such as a general contractor 14ₙ, may be presented with more account related settings (e.g. compliance related settings, etc.—discussed below) than that of say a second agent 16ₙ, such as a subcontractor 16ₙ, who may have a reduced set of settings if, for example, he/she/they only ever acts as a second agent 16ₙ) if and when required or desired in accordance with system 10. Information or settings that a user, e.g. 14ₙ, 16ₙ, may enter, edit and/or update, may include, but is not limited to: their profile details; organisation details (which may include preferences for system 10 generated forms and/or invoices—discussed in further detail below); user details (e.g. authorised user settings or information, preferably including means to alter access permissions for each user, if desired); their system 10 subscription plan and/or usage details (e.g. type of subscription, expiry dates, etc.); their payment details (e.g. credit card, direct debit details, payment history, etc.); their legal entity details (including a facility and settings for adding and editing legal entity details, etc.); compliance details and settings (e.g. for enabling, adding or removing default settings associated with required supporting compliance documents, etc., that must be submitted in connection with contracts 12ₙ and claims—as will be discussed in further detail below); and/or, their preferred “Add-On” details, if any; etc. The “add-on” details or page(s) may preferably provide user 14ₙ, 16ₙ, 32ₙ, with a means for integrating their system 10 subscription/account with, for example, external software provider(s) 30ₙ, such as, for example, cloud based accounting service provider(s) 30ₙ (e.g. Xero™, MYOB™, Quickbooks™, and, Sage One™, etc.), or ERP software provider(s) 30ₙ (e.g. Viewpoint™, Jobpac™, Sage 300 Construction and Real Estate™, and, COINS™, etc.), as will be described in further detail below.

Dashboard screen 34ₙ may also preferably include a button or region 52 (which may be, or include, a logo or profile picture of a user 14ₙ, 16ₙ, 32ₙ, uploaded as part of the process of signing up for a new account as was described earlier with reference to step 204, of preferred method 200, shown in FIG. 2), which, when selected or hovered over (using a GUI pointing device, pen, finger, etc.) may reveal brief details of the user's 14ₙ, 16ₙ, 32ₙ, system 10 subscription account details.

Other dashboard screen 34ₙ buttons or regions may include, but are not limited to: a button or region 54 that may be selected or hovered over (using a GUI pointing device, pen, finger, etc.) so as to access one or more screen(s) (not shown) for generating reports related to project 38ₙ; a button or region 56 that may be selected or hovered over (using a GUI pointing device, pen, finger, etc.) so as to access a facility for searching for project 38ₙ and contracts 12ₙ should a particular user 14ₙ, 16ₙ, 32ₙ, have quite a number of active projects 38ₙ and/or contracts 12ₙ and wish to quickly find one of those projects 38ₙ and/or contracts 12ₙ without having to click though all of their projects 38ₙ, etc.; and/or, a button or region 58 that may be selected or hovered over (using a GUI pointing device, pen, finger, etc.) so as to add a new project 38ₙ, e.g. a “Add Project” button or region 58, in accordance with system 10 of the present invention. An example of preferred processes for adding a new project 38ₙ, and later editing same if desired, will be described in further detail below with reference to preferred method 200 of FIG. 2.

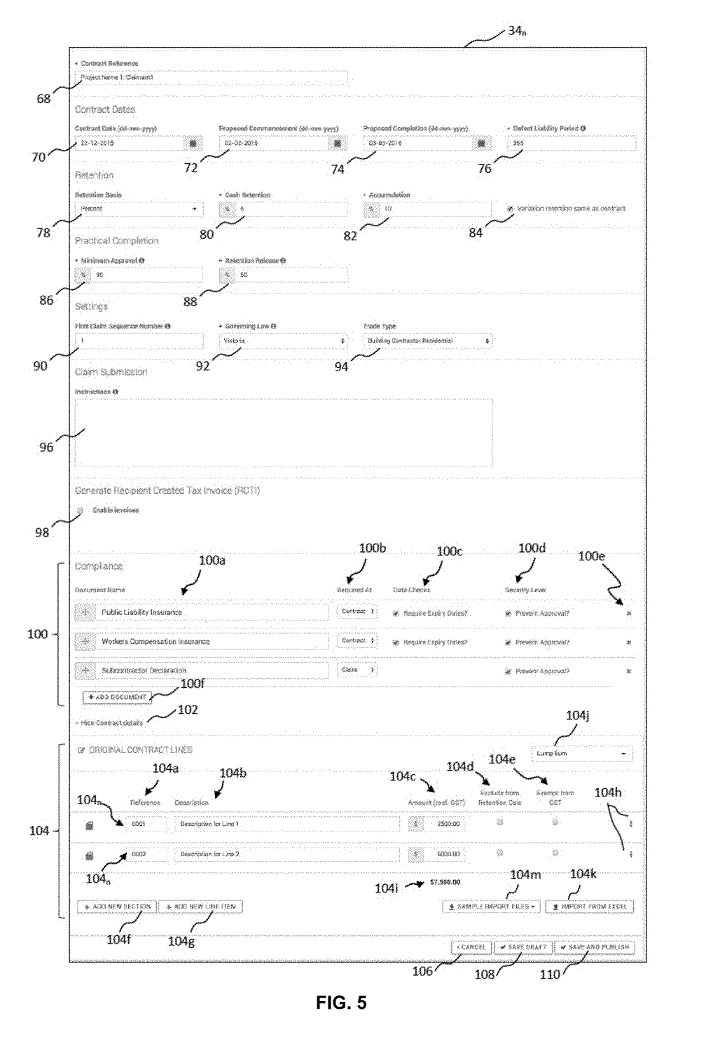

In FIG. 4 there is shown an exemplary GUI screen 34ₙ which illustrates a preferred detailed (single expanded) project 38ₙ page (hereinafter simply referred to as “project screen 34”) that may be presented to a user, e.g. first agent 14ₙ, etc., upon that user 14ₙ, etc., selecting to view details of a specific project 38ₙ displayed within dashboard screen 34ₙ of FIG. 3. In this figure is can be seen that preferred project screen 34ₙ preferably displays the same project 38ₙ summary information (as that described with reference to FIG. 3) concerning the consolidated status of all contracts 12ₙ associated with the particular project 38ₙ being viewed. In addition, and when one or more contracts 12ₙ already exist in connection with the particular project 38ₙ, as is shown in FIG. 4, project screen 34ₙ preferably also displays a concise view of all contracts 12ₙ associated with the particular project 38ₙ being viewed. On the other hand, although not shown in the drawings, if no contracts 12ₙ already exist in connection with the particular project 38ₙ being viewed, an “Add Contract” or “New Contract” button or region (not shown) is preferably presented to first user 14ₙ, etc., in a predetermined convenient location on project screen 34ₙ (such as, for example, centred on screen 34ₙ in or around the region where a first contract 12ₙ may otherwise be displayed, should one or more contracts 12ₙ already exist for that project 38ₙ) so that the user, e.g. first agent 14ₙ, may add one or more contracts 12ₙ for that project 38ₙ as desired. Although not specifically shown in FIG. 4, another way to add one or more new contract(s) 12ₙ for the project 38ₙ may include selecting or hovering over the button or region 42ₙ, which may then reveal a button or region, e.g. an “New Contract” button or region, which may then be selected or hovered over so as to enable the user, e.g. first agent 14ₙ, etc., to add one or more new contracts 12ₙ for that project 38ₙ as desired. An example of a preferred process for adding a new contract 12ₙ, and later editing same if desired, will be described in further detail below with reference to preferred method 200 of FIG. 2, and the exemplary create new contract GUI screen-shot 34ₙ of FIG. 5.

When one or more contracts 12ₙ exist in connection with the particular project 38ₙ being viewed, each contract 12ₙ displayed on project screen 34ₙ, preferably provides summary information concerning the status of that particular contract 12ₙ. This summary information may include, but is not limited to: the project 38ₙ or contract 12ₙ name, reference, or similar identifying information; the counterparty name (e.g. claimant name or second agent 16ₙ, or one of its legal entities, etc.); an indication (not shown—but which may be presented as, e.g. colour coded text, a colour coded box including text, or a colour coded icon, etc.) as to whether or not: a contract 12ₙ, is in draft form (e.g. is a “Draft Contract”); a claim or payment application is in draft form (e.g. is a “Draft Claim”); and/or, there are any pending claims awaiting approval or to assess/approve for that contract (e.g. “Pending Claim(s)”, etc.); the consolidated amount approved for the contract 12ₙ to date; the total amount of works approved or to be supplied in accordance with the contract 12ₙ; consolidated contract 12ₙ completion percentage information, which may be presented as a number, as shown, but which could also, or additionally, be presented by way of a progress wheel 39ₙ (not shown) or the like (e.g. other form of visual indicator, etc.), so as to visually display the completion status of each contract 12ₙ; and/or, the number of claims or payment applications that have been made in accordance with each contracts 12ₙ. Although examples of the type of summary information that may be displayed with respect to each concise view of a contract 12ₙ, shown on project screen 34ₙ, is provided, it will be appreciated that many variations or modifications of such summary information that may be displayed could be made without departing from the spirit and scope of the invention. Accordingly, the present invention should not be construed as limited to the specific examples provided.

As already outlined above, it is preferred that the consolidated financial information that is displayed within project screen 34ₙ, of FIG. 4, is generated by financial data display engine 24ₙ of network server 20ₙₙ(or a third party service provider 33ₙ, if desired) of system 10. Upon a user 14ₙ, 16ₙ, 32ₙ, requesting or otherwise being provided with project screen 34ₙ of FIG. 4, financial data display engine 24ₙ preferably retrieves, calculates, analyses and/or manipulates all necessary financial data, and then populates the relevant fields or regions for the selected project 38ₙ and each contract 12ₙ (displayed in its concise or collapsed form) provided within project screen 34ₙ. The consolidated financial data for display within project screen 34ₙ, may have been prepared in advance by financial data display engine 24ₙ, i.e. upon a last transaction (e.g. a project 38ₙ or contract 12ₙ being created, a claim/payment application being made or approved, etc.) being completed, or may be prepared in (substantially) real-time upon, for example, a request being received by system 10 to display a project screen 34ₙ.

Each contract 12ₙ displayed on project screen 34ₙ (in the concise or collapsed format shown in FIG. 4) may preferably be expanded (to, for example, the exemplary single contract 12ₙ (expanded) GUI screen-shot 34ₙ shown in FIG. 6) by simply selecting or hovering over (e.g. using a GUI pointing device, pen, finger, etc.) any region of the selected contract 12ₙ shown on project screen 34ₙ. Alternatively, the user 14ₙ, e.g. first agent 14ₙ, may select or hover over (e.g. using a GUI pointing device, pen, finger, etc.) the button or region 40ₙmarked with an “>”, toward the right hand side of each contract 12ₙ shown on project screen 34ₙ. Of course, there may be many other ways in which the concise or collapsed view of a particular contract 12ₙ (FIG. 4) may be changed to an expanded view (to, such as, the expanded view shown in FIG. 6) in accordance with system 10 of the present invention. Accordingly, the present invention should not be construed as limited to the specific examples provided.

Regardless of the way in which a particular contract 12ₙ may be displayed in an expanded or more detailed view (see, for example, FIG. 6) in accordance with system 10, a user 14ₙ, 16ₙ, 32ₙ, may return to the project screen 34ₙ (of FIG. 4), showing the concise or collapsed view of each contract 12ₙ, at any time by (preferably) either using an inbuilt GUI “back” button should one be available, or selecting or hovering over (e.g. using a GUI pointing device, pen, finger, etc.) the project directory (e.g. “Project Name 1”, as shown) of the navigation element 48 shown, in FIG. 4, toward the top left hand side of project screen 34ₙ. Of course, there may be many other ways in which a user 14ₙ, 16ₙ, 32ₙ, may return to the project screen 34ₙ in accordance with system 10 of the present invention. Accordingly, the present invention should not be construed as limited to the specific examples provided.

Other project screen 34ₙ buttons or regions may include, but are not limited to: a button or region 60 that may be selected or hovered over (using a GUI pointing device, pen, finger, etc.) so as to access a facility for searching for specific contracts 12ₙ that exist for the particular project 38ₙ being viewed; a button or region 62 that may be selected or hovered over (using a GUI pointing device, pen, finger, etc.) so as to access a pop-up screen or the like (not shown), that a user, e.g. first agent 14ₙ, may use to selectively show or hide certain (by way of, for example, check boxes or the like) summary information (e.g. contract name, counterparty name, etc.) for each contract 12ₙ shown in their concise or collapsed state on project screen 34ₙ; a button or region 64, e.g. a “Pending Claims” button or region, that may be selected or hovered over (using a GUI pointing device, pen, finger, etc.) so as to selectively only display contracts 12ₙ having pending claims; and/or; a button or region 66, e.g. a “Contracts” button or region, that may be selected or hovered over (using a GUI pointing device, pen, finger, etc.) so as to selectively display all contracts 12ₙ associated with the particular project 38ₙ.

Referring back to the flow diagram of FIG. 2, which illustrates preferred method 200 for managing contract payments associated with projects 38ₙ, it can be seen that after having arrived at step 206, and hence, after having presented dashboard screen 34ₙ (FIG. 3) to user, e.g. a first or second agent 14ₙ, 16ₙ, method 200 may continue at step 208, whereat it is determined whether the user 14ₙ, 16ₙ, is already associated with one or more projects 38ₙ. If user 14ₙ, 16ₙ, is not associated with any projects 38ₙ (and, for example, is presented with a blank dashboard screen 34ₙ (not shown), as previously discussed with reference to FIG. 3), then method 200 continues at step 210, whereat the user 14ₙ, 16ₙ, may selectively choose to add one or more new projects 38ₙ, by way of, for example, “Add Project” button or region 58 (see, FIG. 3). Should user 14ₙ, 16ₙ, choose not to add a new project 38ₙ at step 210, then method 200 may return to step 206, and then loop between steps 206, 208 & 210, until such time that user 14ₙ, 16ₙ, elects to add a new project 38ₙ (at step 210), signs out or logs out of system 10 (not represented in the flow diagram of FIG. 2), or is associated with one or more projects 38ₙ (and contract(s) 12ₙ) by another user 14ₙ, 16ₙ, of system 10. Should user 14ₙ, 16ₙ, choose to add a new project 38ₙ, at step 210 (using, for example, “Add Project” button or region 58, of dashboard screen 34ₙ of FIG. 3), then method 200 may continue at step 212, whereat user 14ₙ, 16ₙ, is provided with a create new project GUI screen(s) (not shown), accessible via their user terminal(s) 28ₙ, for inputting, and possibly importing (discussed below), the required information necessary to create a new project.

Information required for creating a new project 38ₙ for use with system 10 may include, but is not limited to: a project name; the proposed commencement date for the project (which may be selected using a pop-up calendar, etc.); the proposed completion date for the project (again, which may be selected using a pop-up calendar, etc.); the monthly claim submission reminder day (i.e. the specific day of each month that notifications will be sent (e.g. by third party notification service provider 33ₙ, e.g. Mandrill™) to all contracted claimants, e.g. second agents 16ₙ, reminding them to submit any claims or payment applications; the project site address (including the street, city, postal or zip code, state and country); and/or, access permissions applicable to the new project 38ₙ. The access permissions for new project 38ₙ may preferably and readily be selectable by way of a series of check-boxes that are all preferably ticked or populated by default (i.e. granting all available access permissions by default). In this way, a user, e.g. first agent 14ₙ, may either simply accept the default setting of granting full access to all users 14ₙ, within their organisation, or their appointed third party agent(s) 32ₙ, that will be collaborating on new project 38ₙ, or may un-tick any check-boxes associated with access permissions that they do not wish to grant to users 14ₙ, 32ₙ, that will be collaborating on new project 38ₙ. Preferred access permissions that may be set by way of the preferred check-boxes (not shown) presented to user 14ₙ, etc., in accordance with system 10, may include, but are not limited to: view rights; rights to change primary contact information (which is used for system 10 generated correspondence); rights to create contracts; rights to change claim or payment application submission reminder information or settings (i.e. to select which users 14ₙ, or third party agents 32ₙ, receive what notifications, etc.); rights to submit claims or payment applications; rights to change claim or payment application submission notification information or settings (i.e. to select whether or not a user 14ₙ, or third party agent 32ₙ, receives such notifications, etc.); rights to change claim or payment application approval reminders information or settings (i.e. to select whether or not a user 14ₙ, or third party agent 32ₙ, receives such notifications, etc.); rights to approve claims; and/or, rights to change claim or payment application approval notification information or settings; etc. The preferred access permissions may readily be used to, for example, provide view only (and/or other limited) project 38ₙ access to certain users, such as, for example, third party agents 32ₙ, etc. Although examples of the type of information and settings that may be required in order to create a new project 38ₙ in accordance with step 212, of method 200, are provided, it will be appreciated that only some of that information, or those settings, or alternative information/settings, could be used to create a new projects 38ₙ in accordance with the present invention. The present invention should therefore not be construed as limited to the specific examples provided.

As is illustrated by way of the flow diagram of FIG. 2, as part of step 212 of creating a new project 38 in accordance with method 200 of the present invention, at least some of the necessary new project 38 information/settings may be imported into system 10 from, for example, an external ERP software provider 30ₙ (such as, for example, Viewpoint™, Jonpac™, Sage 300 Construction and Real Estate™, and, COINS ™, etc.). That is, the create new project GUI screen(s) (not shown) presented to user, e.g. 14ₙ, for inputting the required information necessary to create a new project 38ₙ may include a facility for integrating system 10 with an ERP software provider 30ₙ, etc., so as to enable user 14ₙ to readily retrieve existing ERP project information for automatically populating the necessary information/setting fields as part of step 212, of method 200. Access to, or integration with, the ERP software provider 30ₙ, etc., may be enabled, facilitated and/or granted, by way of, e.g. the “Add-On” facility or page(s) (not shown) previously described with reference to dashboard screen 34ₙ, of FIG. 3. Although not shown in the drawings, it will be appreciated that the process of integrating system 10 with an ERP or other software provider 30ₙ, would include a user, e.g. 14ₙ, granting access rights to system 10 (and/or, external software provider(s) 30ₙ) so as to enable data to be shared between system 10 and external software provider(s) 30ₙ. By enabling a user, e.g. first agent 14ₙ, to import existing ERP, etc., project data into system 10, as part of step 212, of method 200, consistency with existing ERP project information is likely to be assured.

After having entered (and/or imported from, e.g. external ERP software provider 30ₙ, etc.) all necessary information/settings required to create a new project 38ₙ, at step 212, the user, e.g. first agent 14ₙ, may then save or submit (using, e.g. an “Update” or “Submit” button or region (not shown) provided within the create new project GUI screen(s) (not shown) presented to user, e.g. 14ₙ, for inputting the required information necessary to create a new project) the new project 38ₙ for use with system 10. At this stage, a notification(s) may be sent (by, e.g. a third party notification service provider 33ₙ, e.g. Mandrill™, etc.) to all parties associated with the new project 38ₙ, informing them of the creation of the new project 38ₙ. Thereafter, method 200 may continue at step 214, whereat the user, 14ₙ, 16ₙ, is presented with either their dashboard screen 34ₙ (e.g. FIG. 3, showing the concise or collapsed view of the new project 38ₙ, and any other projects 38ₙ), or the project screen 34ₙ (e.g. FIG. 4, the expanded view of new project 38ₙ) applicable to the new project 38ₙ just created.

Referring back to step 208, of method 200, of FIG. 2, if it is determined that user, e.g. 14ₙ, 16ₙ, is already associated with one or more projects 38ₙ (and, for example, is presented with a dashboard screen 34ₙ populated with existing project(s) 38ₙ, as previously discussed with refer to FIG. 3), then method 200 may continue at step 216, whereat user 14ₙ, 16ₙ, may selectively choose to add one or more new projects 38ₙ, by way of, for example, “Add Project” button or region 58 (see, FIG. 3). Should user 14ₙ, 16ₙ, choose to create a new project 38ₙ, at step 216, then method 200 may continue at step 212 (i.e. user 14ₙ, 16ₙ, creates a new project 38ₙ), and then step 214 (i.e. user 14ₙ, 16ₙ, is presented with either dashboard or project screen 34ₙ, see, for example, FIGS. 3 & 4), as hereinbefore described. Alternatively, should user 14ₙ, 16ₙ, choose not to create a new project 38ₙ, at step 216, then method 200 continues at step 218, whereat user 14ₙ, 16ₙ, may selectively choose to edit an existing project 38ₙ, by way of, for example, the “Edit Project” button or region (not shown) that may be revealed (and then selected or hovered over, using, e.g. a GUI pointing device, pen, finger, etc.) by way of selecting or hovering over (e.g. using a GUI pointing device, pen, finger, etc.) button or region 42ₙ shown in, for example, FIGS. 3 & 4. Should user 14ₙ, 16ₙ, choose not to edit an existing project 38ₙ, at step 218, then method 200 may continue at step 214 (i.e. user 14ₙ, 16ₙ, is presented with either dashboard or project screen 34ₙ), as hereinbefore described. Alternatively, should user 14ₙ, 16ₙ, choose to edit an existing project 38ₙ, at step 218, then method 200 may continue at step 220, whereat user 14ₙ, 16ₙ, is provided with an edit project GUI screen(s) (not shown), accessible via their user terminal(s) 28ₙ, for editing the selected existing project 38ₙ. Here, user, e.g. 14ₙ, 16ₙ, may then edit information/settings for the existing project 38ₙ, as desired (including importing in any missing or new/updated ERP or other software provider(s) 30ₙ information, if desired), so long as they have been granted the necessary access permissions (as hereinbefore described with reference to step 212 for creating a new project 38 in accordance with method 200 of FIG. 2) required to do so. After having made any desired/allowed changes to existing project 38ₙ, at step 220, user 14ₙ, 16ₙ, etc., may then save or submit those changes (using, e.g. an “Update” or “Submit” button or region, etc.—not shown) as previously described. Thereafter, method 200 continues at step 214, whereat the user, 14ₙ, 16ₙ, is presented with either their dashboard screen 34ₙ (e.g. FIG. 3) or the project screen 34ₙ (e.g. FIG. 4) applicable to the project 38ₙ just edited.

After having been presented with either dashboard or project screen 34ₙ (see, FIGS. 3 & 4), at step 214, method 200, of FIG. 2, may continue at step 222, whereat it is determined whether a selected project 38ₙ already has one or more contracts 12ₙ associated therewith. If it is determined that no contracts 12ₙ are associated with the selected project 38ₙ, then method 200 may continue at step 224, whereat the user, e.g. first or second agent 14ₙ, 16ₙ, may selectively choose to add one or more new contracts 12ₙ, by way of, for example, any of the “Add Contract” or “New Contract” button(s) or regions(s), etc. (not shown), that may be accessible to user 14ₙ, 16ₙ, by way of project screen 34ₙ (as was described previously with reference to FIG. 4). Should user 14ₙ, 16ₙ, choose not to add a new contract 12ₙ at step 224, then method 200 may return to step 214 or step 206 (i.e. back to dashboard screen 34ₙ or project screen 34ₙ), as hereinbefore described. Alternatively, should user 14ₙ, 16ₙ, choose to add a new contract 12ₙ to the selected project 38ₙ, at step 224, then method 200 may continue at step 226, whereat user 14ₙ, 16ₙ, is provided with a create new contract GUI screen(s) 34ₙ accessible via their user terminal(s) 28ₙ, for inputting the required information necessary to create a new contract 12ₙ. A preferred process for adding a new contract 12ₙ in accordance with step 226, of method 200, will now be described with reference to exemplary create new contract GUI screen-shot 34ₙ of FIG. 5.

In FIG. 5, the preferred GUI screen 34ₙ (which in this instance only shows the preferred screen content so as to simplify the drawing) for creating a new contract 12ₙ (hereinafter simply referred to as “create contract screen(s) 34ₙ”) in accordance with step 226, is shown in a state part way through the preferred process of creating a new contract 12ₙ in accordance with method 200, of FIG. 2. That is, although not shown, before arriving at the create contract screen 34ₙ at the stage shown in FIG. 5, an initial screen (or a portion of screen 34ₙ that has since been collapsed, etc.) was preferably presented to user 14ₙ, 16ₙ, etc., by way of their user terminal 28ₙ, requiring them to input or select their role applicable to the new contract 12ₙ, that is, whether or not they will be: a respondent 16ₙ (i.e. will be approving claims or payment applications for the new contract 12ₙ) or a claimant 14ₙ (i.e. will be making claims or submitting payment applications in connection with the new contract 12ₙ). If the user, e.g. a first agent 14ₙ, inputted or selected “respondent” as their role applicable to the new contract 12ₙ, then within the initial create contract screen (not shown) they were then preferably only required to input or select details of the counterparty, e.g. a second agent 16ₙ, etc., applicable to the new contract 12ₙ, and a contract name or reference for the new contract 12ₙ. Existing counterparty details may preferably have been selected from a drop down menu presented to user 14ₙ, etc., whilst new counterparty details may preferably have been input by either initially entering the counterparty 16ₙ, etc., name, which may then have preferably presented a pop-up menu, or the like (not shown), to user 14ₙ, that they were then able to use to input the required remaining counterparty 16ₙ, etc., details, or by selecting, etc., a button or region, e.g. a “New Counterparty” button or region (not shown), which may then have presented user 14ₙ, etc., with a pop-up menu, or the like (not shown), to user 14ₙ, that they were able to use to input the required remaining counterparty 16ₙ, etc., details.

Thereafter, the user 14ₙ, was preferably presented with (at least) a “Continue” button or region (not shown), which when selected, etc., took the user 14ₙ to the stage of the preferred new contract 12ₙ creation process shown and represented in/by FIG. 5. Alternatively, if the user, e.g. a second agent 16ₙ, inputted or selected “claimant” as their role applicable to the new contract 12ₙ, within the initial create contract screen (not shown), they were then preferably required to select, or otherwise, whether or not they will be self-assessing claims made against the new contract 12ₙ on behalf of the counterparty (in this example, first agent 14ₙ). If user 16ₙ, etc., selected the self-assess option, then system 10 will run in its preferred stand-alone mode for the new contract 12ₙ (i.e. the user 16ₙ, etc., will have the ability to enter both respondent 14ₙ and claimant 16ₙ details themselves for the new contract 12ₙ) as hereinbefore described. If user 16ₙ, etc., did not select the self-assess option, then system 10 will run in its preferred collaborative mode as hereinbefore described (i.e. with the counterparty, e.g. first agent 14ₙ, later being invited by system 10 to collaborate in connection with the new contract 12ₙ). After selecting to use system 10 in either it's preferred collaborative or stand-alone modes, user 16ₙ, etc., was then required to enter the counterparty 14ₙ, etc., and contract name/reference details (as described previously), before selecting, etc., e.g. a “Continue” button or region, which then took the user 16ₙ to the stage of the preferred new contract 12ₙ creation process shown and represented in/by FIG. 5.

Referring now to FIG. 5, and hence the state part way through the preferred process of creating a new contract 12ₙ in accordance with step 226, method 200, it can be seen that preferred create contract screen 34ₙ, preferably includes various facilities, i.e. panels, text boxes (which may incorporate, for example, drop-down menus with selectable text/data, or automated data retrieval or search facilities, etc., for assisting a user, e.g. a first agent 14ₙ, which inputting the information necessary for creating a new contract 12ₙ), check-boxes, buttons or regions, etc., so as to enable a user, e.g. a first or second agent 14ₙ, 16ₙ, to create a new contract 12ₙ for the selected project 38ₙ. These facilities may include, but are not limited to: a text box 68 for entering/editing the contract name or reference; a text box 70 for entering the contract date (which may, for example, provide a facility for selecting the date from a pop-up calendar, or the like); a text box 72 for entering the proposed commencement date for the contract 12ₙ (which may, for example, provide a facility for selecting the date from a pop-up calendar, or the like); a text box 74 for entering the proposed completion date for the contract 12ₙ (which may, for example, provide a facility for selecting the date from a pop-up calendar, or the like); a text box 76 for entering the defect liability period applicable to the contract 12ₙ; a text box 78 which may include a selectable drop-down menu (not shown) for nominating the retention/retainage basis (e.g. percent, max dollar or bank guarantee) applicable to the contract 12ₙ; a text box 80 for entering the cash retention/retainage percentage or dollar limit (depending on the basis selected nominated by user, e.g. first agent 14ₙ, by way of text box 78) applicable to the contract 12ₙ; a text box 82 for entering the retention/retainage accumulation percentage amount applicable to the contract 12ₙ (although not shown, should user 14ₙ, etc., nominate “bank guarantee” as the retention/retainage basis by way of text box 78, then text box 82 will disappear or be greyed out, etc.); a check-box 84 for nominating whether or not the variation retention/retainage is to be the same as the contract 12ₙ (if check-box 84 is not checked, then new variation/change order text boxes appear that are the same as that of text boxes 78, 80 & 82, only this time for variation/change order retention/retainage parameters); a text box 86 for nominating a minimum approval percentage amount applicable to when practical completion may be enabled in accordance with the contract 12ₙ; a text box 88 for nominating a retention/retainage release percentage amount applicable to the portion of retention/retainage funds that may be released upon practical completion in accordance with the contract 12ₙ; a text box 90 for entering a sequence number that is to be used as the first claim sequence number in accordance with the contract 12ₙ; a text box 92 for nominating the governing law jurisdiction applicable to the contract 12ₙ (which may include a drop-down menu, or the like (not shown) for selecting the applicable jurisdiction); a text box 94 for entering or nominating that trade type (e.g. building contractor, engineering contractor, installation services provider, etc.) to be provided by the claimant, e.g. second agent 16ₙ, etc. (which may include a drop-down menu, or the like (not shown) for selecting the applicable trade type); a text box 96 for entering any special instructions (comments, or the like) applicable to the contract 12ₙ; a check-box 98 for nominating whether or not Recipient Created Tax Invoices (RCTI) are to be enabled and generated by system 10, in accordance with the contract 12ₙ; a panel 100 including multiple text boxes, drop-down menus, check-boxes and buttons or regions for entering/setting compliance (e.g. required supporting documents, etc.) information applicable to the contract 12ₙ; a button or region 102 that may be selected or hovered over (e.g. using a GUI pointing device, pen, finger, etc.) so as to hide all of text boxes/check-boxes 68 to 100, after having entered or selected the necessary contract 12ₙ information using those boxes 68 to 100 (e.g. so as to then focus on the final panel 104 that must be completed in order to create the new contract 12ₙ); a panel 104 including multiple text boxes, drop-down menus, check-boxes and buttons or regions for entering contract items 104ₙ applicable to the contract 12ₙ; and/or, buttons or regions 106, 108, 110, for cancelling (106), saving as a draft (108), or saving and publishing (110) the new contract 12ₙ, as desired, by user 14ₙ, 16ₙ, etc.

In FIG. 5 it can be seen that preferred panel 100 for entering compliance (e.g. required supporting documents, etc.) information/settings applicable to the new contract 12ₙ, may include multiple line items each relating to a specific compliance document type 100a that must be submitted in accordance with the new contract 12ₙ . In the example shown in FIG. 5, it can be seen that three different document types 100a have been selected, e.g. public liability insurance, workers compensation insurance and subcontractor declaration. These (three) example compliance line items, and their associated settings 100b, 100c, 100d, may be provided by default, or may be added one at a time, as desired, by way of the “Add Document” button or region 100f, or some other similar button or region (not shown). If one or more compliance line items are provided by default within create contract screen 34ₙ, or if a user, e.g. a first agent 14ₙ, adds a new required compliance document (using, e.g. “Add Document” button or region 100f), then the user 14ₙ, etc., may choose to selectively remove one or more of the compliance document line items by way of simply clicking on, etc., delete line item buttons or regions 100e. As can be seen in FIG. 5, the settings 100b, 100c, 100d, associated with each compliance document type preferably include: a text box 100b, which may include a drop-down menu, or the like (not shown), for selecting a stage, e.g. contract stage or claim stage, upon which the particular required supporting document must be submitted by a user, e.g. a second agent 16ₙ; a check-box 100c for selecting whether or not the expiry date applicable to the particular required supporting document (e.g. the expiry date of an insurance policy, etc.) must also be provided by user 16ₙ, etc.; and, a check-box 100d for selecting whether or not a user 14ₙ, 16ₙ, etc., can make or approve a claim or payment application without submitting/verifying the required supporting document. It is preferred that panel 100 for entering compliance (e.g. required supporting documents, etc.) information applicable to the new contract 12ₙ, is only provided within create contract screen 34ₙ, and hence is only part of the process of creating a new contract 12ₙ, at step 226, of method 200, in instances where the user, e.g. a first agent 14ₙ, has enabled required supporting documents/information as being essential items as a default setting for all contracts 12ₙ, using, for example, their compliance settings (not shown) accessible via, e.g. “My Account” button or region 50 (see, for example, FIGS. 3 & 4), of any of their GUI screens 34ₙ, as hereinbefore described. Of course, it will be appreciated, that panel 100 may be provided within create contract screen 34ₙ regardless of what compliance settings have been set as default by user 14ₙ, etc.

In FIG. 5 it can also be seen that preferred panel 104 for entering contract items 104ₙ applicable to the new contract 12ₙ, is configured to enable a user, e.g. a first or second agent 14ₙ, 16ₙ, to add one or more contract items 104ₙ as required in accordance with the new contract 12ₙ being created. In the preferred create contract screen 34ₙ shown in FIG. 5, it can be seen that each contract item 104ₙ is in the form of a line or row, and each contract item 104ₙ preferably includes: a text box 104a for entering an item reference (e.g. a unique item reference); a text box 104b for entering an item description (e.g. a description of the good or service to be supplied in accordance with the new contract 12ₙ); a text box 104c for entering the items value when completed (excluding Goods and Services Tax (GST) in this example); a check-box 104d for selecting whether or not the contract item 104ₙ is to be included or excluded from retention/retainage calculations; and, a check-box 104e for selecting whether or not the contract item 104ₙ is exempt from tax (e.g. Goods and Services Tax, or GST as it is known in Australia). Although not shown in FIG. 5 (but see, for example, FIGS. 8 & 10), in accordance with preferred create contract screen 34ₙ, contract items 104ₙ can be created and grouped in sections such that a section header (not shown) may be provided with one or more sub contract items 104ₙ disposed thereunder. The section header may include a section title or description 104b (e.g. construction of new dwelling, etc.), with each sub (section) contract item 104ₙ thereunder having a sub section description 104b (e.g. erecting brick walls, erecting roof, plumbing, etc.). If contract items 104ₙ are created and grouped in sections, then the text box 104c for each section header may be replaced with an automatically calculated completion amount total for all sub contract items 104ₙ associated with that section header. Alternatively, the text box 104c may be omitted altogether for section headings (not shown). Hence, the section header may simply provide a consolidated summary and completion amount total of the goods or services to be supplied by way of the sub contract items 104ₙ for that section, or may simply only provide a description for the contract items 104ₙ for that section. For this reason, the check-boxes 104d and 104e, need not apply to the section header line or row of preferred panel 104. New sections and contract items 104ₙ, may be added to the new contract 12ₙ by way of, for example, buttons or regions, e.g. an “Add New Section” button or region 104f, and an “Add New Line” button or region 104g. Once some contract items 104ₙ and associated sections (not shown) have been created, it is preferred that a button or region 104h associated with each section header (not shown) or contract item 104n, may be accessed (e.g. using a GUI pointing device, pen, finger, etc.) so as to reveal a drop-down menu of the like (not shown) for accessing buttons or regions (not shown) for converting a contract item 104ₙ into a section header and vice versa, or for deleting unwanted sections or contract items 104ₙ. Provided under the completion item value text boxes 104c, there is automatically calculated total 104i, which represents the total amount of all contract items 104ₙ at completion.

Although not shown in the exemplary create contract screen 34ₙ, of FIG. 5, instead of creating contract items 104ₙ in lump sum format, contract items 104ₙ may be created as a schedule of rates by way of selecting or hovering over (e.g. using a GUI pointing device, pen, finger, etc.) a button or region 104j, and then accessing and selecting, etc., the option of using a “Schedule of Rates” by way of, for example, a drop-down box or the like (not shown). When the option of creating contract items 104ₙ as a “Schedule or Rates” is selected (not shown), create contract screen 34ₙ of FIG. 5, preferably includes additional text boxes (not shown), etc., for entering the unit of measure (e.g. hours, feet, etc.) applicable to the contract item 104ₙ, the quantity (e.g. 1 hour, 1 foot, etc.) of the item 104ₙ to be supplied, and the rate per unit of measure (e.g. $60 per hour, $40 per foot, etc.). In this case, the text boxes for entering the total amount of the contract item 104ₙ at completion may be replaced with boxes showing an automatically calculated total for the contract item 104ₙ. Further, an additional text box (not shown) for each contract item 104ₙ, may be provided so as to select whether or not a user, e.g. 16ₙ, can enter any desired quantity amount (e.g. a portion of a unit of measure, or a full unit of measure etc.) when making a claim or payment application.

As is illustrated by way of the buttons or regions 104k (e.g. the “Import from Excel”, etc., button or region) and 104m (e.g. the “Sample Import Files”, etc., button or region), shown in the exemplary create contract screen 34ₙ, of FIG. 5, and by way of the flow diagram of FIG. 2, as part of step 226 of creating a new contract 12ₙ in accordance with method 200 of the present invention, at least some of the necessary new contract 12ₙ information/settings may be imported into system 10 from, for example: an external ERP software provider 30ₙ (such as, for example, Viewpoint™, Jobpac™, Sage 300 Construction and Real Estate™, and, COINS ™, etc.); an Excel or similar spreadsheet; and/or, from a sample file (in any suitable format) that may be downloaded from, for example, network server 20ₙ of system 10. That is, create contract screen 34ₙ of FIG. 5, presented to user, e.g. a first agent 14ₙ, for inputting the required information necessary to create a new contract 12ₙ may include a facility (such as, for example, “Import from Excel” button or region 104k, which may of course be replaced with simply an “Import” button or region, or to an “Import from ERP” button or region, etc.) for integrating system 10 with an ERP software provider 30ₙ, etc.; or for enabling a user to import Excel or similar spreadsheet data, or any other suitable data (whether the user's 14ₙ own data, or sample data downloaded from, e.g. network server 20ₙ, using, e.g. the “Sample Import Files” button or region 104m of create contract screen 34ₙ) into system 10, so as to enable user 14ₙ to readily retrieve existing ERP contract information and/or (user 14ₙ or sample) Excel or other spreadsheet or similar contract data, for automatically populating the necessary information/setting fields as part of step 226, of method 200. For example, in the case of importing new contract 12ₙ data into system 10 from an external ERP software provider 30ₙ, text boxes 68 through to 92, along with some (generally consolidated) contract items 104ₙ of create contract screen 34ₙ, of FIG. 5, and the counterparty details, may be pre-populated by way of the import process. Thereafter, in the case of imported consolidated contract items 104ₙ, a user 14ₙ, etc., may, if necessary, convert one or more of the imported contract items 104ₙ into a section heading (using, e.g. button(s) or region(s) 104h), and then create a breakdown of the works by way of adding sub-contract items 104ₙ (the sub-contract item 104ₙ information possibly being imported into system 10 from an Excel spreadsheet, or the like). As already described above, access to, or integration with, an ERP software provider 30ₙ, etc., may be enabled, facilitated and/or granted, by way of, e.g. the “Add-On” facility or page(s) (not shown) previously described with reference to dashboard screen 34ₙ, of FIG. 3. By enabling a user, e.g. first agent 14ₙ, to import existing ERP, Excel, etc., contract data into system 10, as part of step 226, of method 200, consistency with existing ERP, Excel, etc., contract information is likely to assured.

Although examples of the type of information and settings that may be required in order to create a new contract 12ₙ in accordance with step 226, of method 200, are provided, it will be appreciated that only some of that information, or those settings, or alternative information/settings, could be used to create a new contracts 12ₙ in accordance with the present invention Likewise, it will also be appreciated that some of the text-boxes and check-boxes 68 to 104, etc., provided within preferred create contract screen 34ₙ, may be pre-populated with existing, typical or recommend settings or information by system 10, such that a user, e.g. a first agent 14ₙ, need only alter the pre-populated information in those boxes 68 to 104 that he/she wishes to change for the new contract 12ₙ being created. The present invention should therefore not be construed as limited to the specific examples provided.

After having entered (and/or imported from, e.g. external ERP software provider 30ₙ, and/or an Excel or other spreadsheet, data file, etc.) all necessary information/settings required to create a new contract 12ₙ (at step 226) the user, e.g. first agent 14ₙ, may then save or submit (using, e.g. the “Save and Publish” button or region 110 provided within create contract screen 34ₙ) the new contract 12ₙ for use with system 10. Once the new contract 12ₙ has been created at step 226, assuming that the contract 12ₙ is not being self-assessed (i.e. system 10 is not being used in stand-alone mode), a notification (not shown) may then be sent (by, e.g. a third party notification service provider 33ₙ, e.g. Mandrill™, etc.) to the counterparty, e.g. first, second or third agent 14ₙ, 16ₙ, 32ₙ, applicable to the new contract 12ₙ, inviting them to collaborate on the associated project 38ₙ. If the counterparty 14ₙ, 16ₙ, 32ₙ, is a not an existing user 14ₙ, 16ₙ, 32ₙ, of system 10, then that notification may also include an invitation, link(s), instructions, etc., for informing/inviting the counterparty 14ₙ, 16ₙ, 32ₙ, to create a new account for use with system 10 (e.g. by way of, for example, steps 202a or 202b, and then 204, of preferred method 200, of FIG. 2).

After creating a new contract 12ₙ for a selected project 38ₙ, at step 226, method 200 (of FIG. 2) may continue at step 228, whereat the user, 14ₙ, 16ₙ, etc., is preferably presented with the project screen 34ₙ (see, FIG. 4), for the selected project 38ₙ, which includes a concise or collapsed view of the new contract 12ₙ just created. User, 14ₙ, 16ₙ, etc., may then select or hover over (e.g. using a GUI pointing device, pen, finger, etc.) the new contract 12ₙ (or an existing contract 12ₙ, should contracts 12ₙ have already existed before the new contract 12ₙ was created—as will be described below with reference to steps 230, 226 & 228 of method 200, of FIG. 2) displayed within project screen 34ₙ (FIG. 4), so as to be presented with an expanded view of the selected contract 12ₙ. An exemplary single contract 12ₙ (expanded) GUI screen-shot 34ₙ (hereinafter simply referred to as “contract screen 34ₙ,”) is shown in FIG. 6.

Referring to FIG. 6 (which again only shows the preferred screen content so as to simplify the drawing), it can be seen that preferred contract screen 34ₙ, which in this example is that of a second agent 16ₙ, e.g. a subcontractor or some other “claimant”, preferably includes a number of panels, buttons or regions, for displaying information/documents associated with the selected contract 12ₙ and/or for performing various actions in connection with that contract 12ₙ. For example, and as shown in FIG. 6, contract screen 34ₙ preferably includes, but it not limited to: a panel or region 112 for displaying consolidated project-to-date summary information; a panel of region 114 for displaying counterparty (e.g. claimant information should the user be a first agent 14ₙ, or respondent information should the user be a second agent 16ₙ, etc.) information; a panel or region 116 for displaying project-to-date claim or payment application summary information and/or for making/approving claims/payment applications; and/or, a panel or region 118 for displaying required supporting documentation (i.e. compliance documents/information) that must be (e.g. as was defined in panel 100, of create contract screen 34ₙ, of FIG. 5), or has been, submitted or otherwise provided in accordance with contract 12ₙ.

Although not shown in FIG. 6, should user 16ₙ, etc., have created one or more draft claims or payment applications, but not yet finalised and/or submitted same in accordance with system 10, and/or should user 14ₙ, 16ₙ, etc., have a pending claim/payment application awaiting approval (e.g. in the case of a user 16ₙ) or to assess/approve (e.g. in the case of a user 14ₙ), preferred contract screen 34ₙ may also include an additional (temporary) panel or region (not shown) for displaying summary information (and buttons or regions for performing any desired or necessary tasks) related to that/those draft/pending claim(s)/payment application(s) and/or for viewing, editing, finalising, submitting, assessing, approving, etc., that/those draft/pending claim(s)/payment application(s) in accordance with system 10. Alternatively, and again although not shown, such draft/pending claim/payment application summary information may instead be included within preferred panel or region 116. Of course, other panels or regions (not shown), or alternatives or variations of the preferred ones described herein, may be provided in accordance with the present invention. The present invention should therefore not be construed as limited to the specific examples provided.

Although not shown in FIG. 6, one or more of preferred panels or regions 112, 114, 116 and/or 118, may be selectively collapsed or expanded by system 10, or selectively by a user, e.g. second agent 16ₙ, as desired, as part of the process of viewing/using preferred contract screen 34ₙ. For example, each of panels/regions 112, 114 and 118 may preferably be collapsed/expanded by way of the “̂” buttons or regions 112a, 114a, and 118a. Again, although not shown, in their collapsed form, each of regions 112, 114, 118 (and possibly 116) may display a brief description of the respective panel/region, e.g. the project/contract name or reference, etc., for panel/region 112, the “Respondent”/“Claimant” or the actual respondent/claimant name, etc., for panel/region 114, and “Compliance Documentation”, etc., for panel/region 118. The compliance documentation panel or region 118 (in its concise or collapsed form—not shown) preferably also includes clever, preferably colour coded, visual indicators (e.g. colour coded icons, regions, etc., not shown) so that a user 14ₙ, 16ₙ, may readily determine (e.g. by way of, for example, selecting or hovering over, using, e.g. a GUI pointing device, pen, finger, etc., one or more of the colour coded icons, etc.) the status (e.g. submitting, missing, expiring soon, not verified, etc.) of the supporting documents to be submitted/verified or otherwise provided in accordance with contract 12ₙ.

In FIG. 6, it can be seen that preferred panel or region 112 preferably displays consolidated project-to-date summary information for the selected contract 12ₙ. The summary information preferably includes, but is not limited to: the project/contract name or reference; ‘approved to date’ and ‘when complete’ claim/payment application and contract 12ₙ project-to-date consolidated totals for each of the contract works, approved variations, unapproved variations, total works and rejected variations; the project-to-date revised total amount of the contract 12ₙ; the project-to-date total retention/retainage amounts withheld in accordance with the contract 12ₙ; and/or, the completion status of the contract 12ₙ which may clearly and cleverly be displayed by way of, for example, a number representing a completion percentage amount and/or a progress wheel 112b or the like (e.g. a progress bar (not shown), or some other form of, preferably colour coded, visual indicator, etc.). Preferred panel or region 112 may also include a button or region 112c, e.g. an “Edit Contract” button or region 112c, which, when selected or hovered over (e.g. using a GUI pointing device, pen, finger, etc.), may provide the user, e.g. a first or second agent 14ₙ, 16ₙ, with an edit contract GUI screen(s) (not shown—but which may simply be the same as, or similar to, preferred create contract screen 34ₙ, shown in FIG. 5) that they may use to edit the selected contract 12ₙ if or as desired using (such as, for example, in accordance with step 234, of method 200, of FIG. 2, as will be described below).

The preferred panel or region 114 for displaying the counterparty information, shown in FIG. 6 as a “Respondent”, may simply list or otherwise display important particulars or details concerning the counterparty. Such particulars may include, but are not limited to: the counterparty name (e.g. the individual, business or company name); the counterparty representative (which may not be provided or may be blank should the counterparty be an individual, etc.); the counterparty address; the counterparty e-mail address(es); the counterparty company registration number (e.g. an ABN or ACN number in the case of an Australian business or company, etc.), if applicable; and/or, the counterparty phone number(s).

In FIG. 6, it can be seen that should one or more claims or payment application have already been made and assessed/approved in accordance with the selected contract 12ₙ, then preferred panel or region 116 preferably displays a concise view of all claims/payment applications made and approved in connection with that contract 12ₙ. On the other hand, although not shown in the drawings, if no claims/payment applications have been made/approved to date in connection with the contract 12ₙ, then panel 116 will not be populated with any claim/payment application history. When one or more claims/payment applications have been made/approved in connection with the contract 12ₙ, each claim/payment application displayed within panel 116 of contract screen 34ₙ, preferably provides summary information concerning the claim/payment application. This summary information may include, but is not limited to: the claim/application number or other reference; the date of submittal of the claim/application; the approval date of the claim/application; the total amount of works claimed; the total amount of variations claimed; the total amount of works approved; and/or, the total amount of variations approved in connection with the claim/application. Should a user, e.g. first, second or third agent 14ₙ, 16ₙ, 32ₙ, wish to inspect or view one of the previously approved claims/applications displayed within panel 116n, they may do so by way of, e.g. clicking, selecting, etc., anywhere within the desired claim/application, or by clicking, selecting, etc., button or region “>” 116a, either of which will present user 14ₙ, 16ₙ, 32ₙ, with an expanded view of the selected previously approved claim/application. Should the user 14ₙ, 16ₙ, wish to make a new claim (e.g. in the case of a user 16ₙ) in accordance with step 236 of method 200, or to assess/approve a pending claim (e.g. in the case of a user 14ₙ) in accordance with step 238 of method 200, then they may do so by selecting or hovering over (e.g. using a GUI pointing device, pen, finger, etc.), a button or region 116b, such as, for example, a “Make Claim” or “Assess Claim” (not shown) button or region. Preferred processes for making and submitting claims or payment applications (at step 236) and assessing/approving claims or payment applications (at step 238), in accordance with method 200, will be described in detail below.

As already outlined above, it is preferred that the consolidated financial information that is displayed within contract screen 34ₙ, of FIG. 6, is generated by financial data display engine 24ₙ of network server 20ₙ (or a third party service provider 33ₙ, if desired) of system 10. Upon a user 14ₙ, 16ₙ, 32ₙ, requesting or otherwise being provided with contract screen 34ₙ of FIG. 4, financial data display engine 24ₙ preferably retrieves, calculates, analyses and/or manipulates all necessary financial data, and then populates the relevant fields or regions (e.g. panel or region 112 and 116, etc.) for the contract 12ₙ (displayed in its concise or collapsed form) provided within contract screen 34ₙ. The consolidated financial data for display within contract screen 34ₙ, may have been prepared in advance by financial data display engine 24ₙ, i.e. upon a last transaction (e.g. a project 38ₙ or contract 12ₙ being created, a claim/payment application being made or approved, etc.) being completed, or may be prepared in (substantially) real-time upon, for example, a request being received by system 10 to display a contract screen 34ₙ.

The preferred panel or region 118 for displaying required supporting documentation (i.e. compliance documents/information) that must be, or has been, submitted or otherwise provided (or must be verified, or has been verified—as will be described below with reference to the process of assessing/approving a claim in accordance with step 238, of preferred method 200) in accordance with contract 12ₙ is preferably presented to (at least) claimant's 16ₙ, e.g. second agent's 16ₙ, in its expanded form as shown in FIG. 6. Hence, when a second agent 16ₙ, etc., chooses to view a selected contract 12ₙ, for any given project 38ₙ, in accordance with step 228 of method 200 (FIG. 2), the second agent 16ₙ is automatically, and conveniently, presented with a list of the required supporting documents, if any, that they must submit in accordance with the selected contract 12ₙ (i.e. the supporting compliance documents selected, e.g. by way of preferred panel 100 of create contract screen 34ₙ of FIG. 5, by the user, e.g. the first agent 14ₙ, that created the selected contract 12ₙ in accordance with the invention). Panel 118 may then be readily and selectively collapsed, as desired, by way of, for example, the “̂” button or region 118a. Another way of accessing a list of the supporting compliance documents required to be submitted or otherwise provided in accordance with the selected contract 12ₙ, and/or selectively submitting/providing any required compliance documents/information, may include selecting or hovering over (e.g. using a GUI pointing device, pen, finger, etc.) a button or region, e.g. a “Manage Contract Attachments” button or region 116c, accessible via, for example, preferred panel or region 116, of contract screen 34ₙ, which may then bring up a pop-up screen, or the like (not shown), which includes the list of required supporting documents and/or a facility for submitting/uploading those documents, etc.. As discussed previously, the required supporting compliance documentation may include, but is not limited to: insurance certificates of currency (for, e.g. public liability, professional indemnity, etc.), work cover information/documentation and/or, statutory declaration(s) confirming that all workers, subcontractors, etc., have been paid. After, for example, having reviewed the list of required supporting compliance documents (by way of either panel 118 or “Manage Contract Attachments” button or region 116c), if any, second agent 16ₙ, etc., may then view or attach/upload/otherwise submit (e.g. using drag and drop, etc.) one or more of the required supporting documents by way of contract page 34ₙ (e.g. by way of a view or upload facility that may be presented to the user 16ₙ, etc., upon selecting or hovering over (e.g. using a GUI pointing device, pen, finger, etc.): a previously submitted document (e.g. the Public Liability Insurance document shown in FIG. 6) or the outline of a “Missing” document (e.g. the “Missing” Workers Compensation Insurance document shown in FIG. 6; and/or, the “Manage Contract Attachments” button or region 116c of panel 116) of FIG. 6. Although not shown in the drawings, preferred panel/region 118 may also include at least one button or region (not shown), e.g. “Download Compliance Document Template”, “Download Statutory Declaration Template” (e.g. a pre-prepared region-specific template, possibly configured for the user's 14ₙ, etc., requirements), “Download Sample Compliance Document”, etc., so as to readily enable a user 16ₙ, etc., to download (or otherwise obtain) and use compliance document templates (e.g. for preparing a required statutory declaration, etc.), or sample compliance documents, to assist them with preparing and submitting various required supporting compliance documents, etc.

Referring back to step 222, of method 200, of FIG. 2, if it is determined that existing contracts 12ₙ are associated with the selected project 38ₙ, then method 200 may continue at step 230, whereat user 14ₙ, 16ₙ, may selectively choose to add one or more new contracts 12ₙ, by way of, for example, any of the “Add Contract” or “New Contract” button(s) or regions(s), etc. (not shown), that may be accessible to user 14ₙ, 16ₙ, by way of project screen 34ₙ (as was described previously with reference to FIG. 4). Should user 14ₙ, 16ₙ, choose to create a new contract 12ₙ, at step 230, then method 200 may continue at step 226 (i.e. user 14ₙ, 16ₙ, creates a new contract 12ₙ), and then step 228 (i.e. user 14ₙ, 16ₙ, is presented with the contract screen 34ₙ for the new contract 12ₙ, see for example, FIG. 6, and may then submit any required supporting compliance documents, etc., if needed, or if required to do so, etc.), as hereinbefore described. Alternatively, should user 14ₙ, 16ₙ, choose not to create a new contract 12ₙ, at step 230, then method 200 may continue at step 232, whereat user 14ₙ, 16ₙ, may selectively choose to edit an existing contract 12ₙ, by way of, for example, selecting or hovering over (e.g. using a GUI pointing device, pen, finger, etc.) an “Edit Contract” button or region 112c, provided within contract screen 34ₙ (see, for example, FIG. 6). Should user 14ₙ, 16ₙ, choose not to edit an existing contract 12ₙ, at step 232, then method 200 may continue at step 228 (i.e. user 14ₙ, 16ₙ, may be presented with a contract screen 34ₙ for a selected contract 12ₙ, see for example, FIG. 6, and may then submit any required supporting compliance documents, etc., if needed, or if required to do so, etc.), as hereinbefore described. Alternatively, should user 14ₙ, 16ₙ, choose to edit an existing contract 12ₙ, at step 232, then method 200 may continue at step 234, whereat user 14ₙ, 16ₙ, is provided with an edit contract GUI screen(s) (not shown—but which may simply be the same as, or similar to, the create contract screen 34ₙ, shown in FIG. 5), accessible via their user terminal(s) 28ₙ, for editing the selected existing contract 12ₙ. Here, user, e.g. 14ₙ, 16ₙ, may then edit information/settings for the existing contract 12ₙ (including importing in any missing or new/updated ERP or other software provider(s) 30ₙ contract information, reference numbers, etc., or importing in any contract related information from a spreadsheet, e.g. an Excel spreadsheet, if desired), so long as they have been granted the necessary access permissions (as hereinbefore described with reference to step 212 for creating a new project 38, or step 226 for creating a new contract 12ₙ, in accordance with method 200 of FIG. 2), as desired or required to do so. After having made any desired/allowed changes to existing contract 12ₙ, at step 234, user 14ₙ, 16ₙ, etc., may then save or submit those changes (using, e.g. an “Update”, “Submit”, “Save or “Save and Publish” button or region 110, etc.—see, for example, FIG. 5) as previously described. Thereafter, method 200 may continue at step 228 (i.e. user 14ₙ, 16ₙ, may be presented with the contract screen 34ₙ for the existing contract 12ₙ, see for example, FIG. 6, just edited, and may then submit any required supporting compliance documents, etc., if needed, or if required to do so, etc.), as hereinbefore described.

After having been presented with, and reviewing, the contract screen 34ₙ (FIG. 6), for a selected contract 12ₙ, at step 228, and after having attached or otherwise submitted the required supporting compliance documents, if any, or if required or desired to do so (e.g. should the user be, for example, a second agent 16ₙ), method 200 may continue at either: step 236, whereat, the user, e.g. a second agent 16ₙ, may make a claim or payment application in accordance with the selected contract 12ₙ; or, step 238, whereat, the user, e.g. a first agent 14ₙ, or a third agent 32ₙ, may assess and approve (or otherwise) a claim or payment application in accordance with the selected contract 12ₙ. Preferred processes for making and submitting claims or payment applications (at step 236) and assessing/approving claims or payment applications (at step 238), in accordance with method 200, will be described in detail below with reference to the flow diagrams of FIGS. 7 & 9, which will be described in conjunction with the exemplary GUI screen-shots 34ₙ of FIGS. 8 & 10.

After choosing to either make a claim (step 236) or to assess/approve a claim (step 238), or possibly not electing to do either of those tasks (not shown), method 200 may simply end, e.g. by way of the user 14ₙ, 16ₙ, 32ₙ, logging out of system 10ₙ, or by returning user 14ₙ, 16ₙ, 32ₙ, to, for example, dashboard screen 34ₙ (see, FIG. 3).

In FIG. 7, there is shown a flow diagram which illustrates a preferred method 236 for making claims or payment applications in accordance with step 236, of method 200, of FIG. 2. As can be seen in FIG. 7, the preferred process of making a claim or payment application in accordance with method 236 preferably commences at step 236A, whereat the user, e.g. a first or second agent 14ₙ, 16ₙ, is presented with, or arrives at, a GUI “make claim or payment application” page(s) or screen(s) 34ₙ (hereinafter simply referred to as “make claim screen 34ₙ”), by way of their user terminal(s) 28ₙ. An exemplary GUI screen-shot 34ₙ of a preferred make claim screen 34ₙ is shown in FIG. 8 (which may display a new claim/payment application being created from scratch, or may show a previously saved draft claim/payment application—which will be described in detail below). As is indicated by step 236A, shown in FIG. 7, if any existing claim(s)/application(s) have been made against the selected contract 12ₙ, then details pertaining to the existing claim(s)/application(s) are retrieved by system 10, and used to generate the display of information shown within make claim screen 34ₙ. The existing claim(s)/application(s) details preferably include, but are not limited to: the last claim/application number made against the contract 12ₙ; previously approved claim amounts (which preferably includes the monetary and percentage, etc., amounts); previously added variation items and amounts; any comments or supporting documents (e.g. photos, documents, etc.) that may have been associated with one or more contract items 104ₙ and/or variation/change order items 124ₙ (see, FIG. 8); and/or, any supporting compliance documents that may have already been submitted by a user, 14ₙ, 16ₙ, etc., in connection with the specific contract 12ₙ. This existing claim(s)/application(s) data, if any, is preferably retrieved and/or used by financial data display engine 24ₙ (and/or any other associated modules or engines 24ₙ, not shown) of network server 20ₙ (or a third party service provider 33ₙ, if desired), of system 10, to calculate, analyse and/or manipulate any necessary data (e.g. financial data) so as to then populate the relevant fields or regions (including the various progress bars 120b, 122e, or other similar visual indicators not shown) of make claim screen 34ₙ shown in FIG. 8. The data necessary for display within make claim screen 34ₙ, may have been prepared in advance by financial data display engine 24ₙ, i.e. upon a last transaction (e.g. a project 38ₙ or contract 12ₙ being created, a claim/payment application being made or approved, etc.) being completed, or may be prepared in (substantially) real-time upon, for example, a request being received by system 10 to make a claim (at step 236), and to display make claim screen 34ₙ. Once make claim screen 34ₙ, of FIG. 8, has been generated and displayed or otherwise provided to user 16ₙ, etc., in accordance with step 236A, it is preferred that the new claim/application being made is automatically saved as a draft.

Referring to FIG. 8 (which again only shows the preferred screen content so as to simplify the drawing), it can be seen that if an existing claim or payment application has been made against the selected contract 12ₙ, then a number of the preferred fields or features presented within the various preferred panels or regions 120, 118, 122, 124, of make claim screen 34ₙ may have been pre-populated by system 10 (as will be described below). Preferred make claim screen 34ₙ, of FIG. 8, which in this example is that of a second agent 16ₙ, is shown in a state part through the preferred process of making a claim or payment application in accordance with method 236, of FIG. 7. That is, various fields have already been completed by user 16ₙ, etc., for the purpose of making a new claim/application against the selected contract 12ₙ (as will be described in further detail below).

In FIG. 8, it can be seen that preferred make claim screen 34ₙ, preferably includes a number of panels, fields, features, buttons or regions, for displaying information/documents associated with the selected contract 12ₙ and for making a claim or payment application in accordance with that contract 12ₙ. For example, and as shown in FIG. 8, make claim screen 34ₙ preferably includes, but it not limited to: a panel or region 120 for displaying consolidated project-to-date claim summary information, which panel 120 also preferably includes various fields, buttons or regions for performing various make claim/applications functions in accordance with preferred make claim screen 34ₙ; a panel of region 118 (which may simply be the same as that or panel or region 118 shown in FIG. 6) for displaying required supporting documentation (i.e. compliance documents/information) that must be, or has been, submitted or otherwise provided in accordance with contract 12ₙ; a panel or region 122 for displaying consolidated project-to-date contract item 104ₙ claim summary information, and for entering new claim information so as to make a new claim/application in accordance with method 236, of FIG. 7; and/or, a panel or region 124 for displaying consolidated project-to-date contract variation/change order item(s) 124ⁿ claim summary information, and for entering new variation/change order claim information so as to make a new claim/application in accordance with method 236, of FIG. 7.

Although not shown in FIG. 8, one or more of preferred panels or regions 120, 118, 122 and/or 124, of preferred make claim screen 34ₙ, may be selectively collapsed or expanded by system 10, or selectively by a user, e.g. second agent 16ₙ, as desired, as part of the process of viewing make claim screen 34ₙ. For example, each of panels/regions 118, 122 and 124 may preferably be collapsed/expanded by way of the “̂” buttons or regions 118a, 122a, and 124a. Again, although not shown, in their collapsed form, each of regions 118, 122, 124 may display a brief description of the respective panel/region, e.g. “Compliance Documentation”, etc., for panel/region 118; “Contract Works” and possibly a “Display Borders” check-box 122b (which may be selected, hovered over, etc., so as to elect to display the content, e.g. contract work and variation/change order information, shown within panels 122, 124, in a table format—not shown), etc., for panel/region 122; and, “Variations” and possibly a “Add Variation” button or region 124b (which may be selected, hovered over, etc., so as to add a new variation/change order item(s) 124ₙ as part of the claim/application being made—as will be described below) for panel/region 124. As was discussed earlier with reference to FIG. 6, it is also preferred that the concise or collapsed compliance documentation panel or region 118 (not shown) preferably also includes clever, preferably colour coded, visual indicators (e.g. colour coded icons, regions, etc., not shown) so that a user 16ₙ, etc., may readily determine (e.g. by way of, for example, selecting or hovering over, using, e.g. a GUI pointing device, pen, finger, etc., one or more of the colour coded icons, etc.) the status (e.g. submitted, missing, expiring soon, not verified, etc.) of the supporting documents to be submitted or otherwise provided in order to make a claim/payment application in accordance with contract 12ₙ.

In FIG. 8, it can be seen that preferred panel or region 120 preferably displays consolidated project-to-date claim/payment application summary information for the selected contract 12ₙ. The summary information preferably includes, but is not limited to: the claim number 120a for the new claim being made; ‘approved to date’, “amount claimed” and “yet to be claimed” project-to-date consolidated totals for the specific contract 12ₙ; and, the completion status of the contract 12ₙ which is clearly and cleverly displayed by way of, for example, a colour coded progress bar 120b or the like (e.g. a progress wheel (not shown), or some other form of, preferably colour coded, visual indicator, etc.). In the example shown in FIG. 8, a blue or first colour region (from left to right) represents the total claim/application amount approved to date, whilst a green or second colour region represents the total claim/application amount now being claimed, and a grey, blank or final colour region represents the amount yet to be claimed by way of a claim or payment application. Preferred panel or region 120 may also include, but is not limited to: a text box or field/region 120c, e.g. a “claim as at” text box or field 120c, which displays the date (e.g. the date of opening/displaying make claim screen 34ₙ) applicable to the consolidated claim information shown within make claim screen 34ₙ, and which may selectively be changed (e.g. by way of selecting, etc., a drop down menu or pop-up calendar that may appear upon selecting or hovering over, using, e.g. a GUI pointing device, pen or finger, etc., text box or field 120c); a button or region 120d, e.g. an “Attachments” button or region 120d, which may be selected, hovered over, etc., so at to bring up a pop-up window of the like (not shown) for displaying details of any attachments (and for possibly downloading, etc. copies of same) that may have already been associated with contract 12ₙ, or to submit (e.g. upload, etc.) or otherwise any required or desired attachments applicable to contract 12ₙ or the claim/payment application being made; a button or region 120e, e.g. a “Draft Claim PDF” button or region 120e, which may be selected, hovered over, etc., so as to generate and download or view a draft claim/compliance document (in accordance with step 236G, of method 236, of FIG. 7—as will be described below) applicable to the claim/payment application being made; a button or region 120f, e.g. a “Save Draft” button or region 120f, for saving the claim/payment application being made as a draft; and/or, a button or region 120g, e.g. a “Submit Claim” button or region 120g, for selectively submitting the claim/application being made for assessment/approval in accordance with the invention.

As already described above, preferred panel or region 118 for displaying required supporting documentation (i.e. compliance documents/information) that must be, or has been, submitted or otherwise provided in accordance with contract 12ₙ is preferably the same as, or similar to, preferred panel/region 118 shown in FIG. 6. Accordingly, a detailed discussion of the features and/or operation of preferred panel/region 118, of FIG. 8, need not be provided again. Instead, it should be understood that panel 118 of FIG. 8, may perform some or all of the aspects/operations, or variations thereof, of panel 118 as described above with reference to FIG. 6. Having said that, should any required compliance documents have been defined as “required at claim” documents (referring to text boxes 100b, of create contract screen 34ₙ, of FIG. 5, then at the claim/payment application stage, additional required documents, e.g. a “Subcontractor Declaration”, as shown in FIG. 8, may now appears as being a required compliance document within preferred panel or region 118.

In FIG. 8 it can also be seen that preferred panel 122 for displaying consolidated project-to-date contract item 104ₙ claim summary information, and for entering new claim information so as to make a new claim/application in accordance with method 236, of FIG. 7, is configured to enable a user, e.g. a second agent 16ₙ, to readily view summary information concerning previous claims/applications and to input or add one or more new claim amounts (for one or more contract items 104ₙ) as required so as to make a new claim/payment application in connection with the selected contract 12ₙ. In the preferred make claim screen 34ₙ shown in FIG. 8, it can be seen that various contract item 104ₙ (this time arranged in sections, with section headings, and subsection contract items 104ₙ), in addition to including their reference 104a, description 104b, when complete amounts 104c, and when complete automatically calculated total of all contract items 104i, each or which were described earlier with reference to FIG. 5, each contract item 104ₙ also includes a number of regions, fields or text boxes for viewing previous claim/application information and for entering new claim/application information. These additional regions, fields or text boxes, etc., may include, but are not limited to: a previously approved automatically calculated amount 122c, which when there are more than one contract items 104ₙ, may also include a consolidated automatically calculated previously approved total 122d; the completion status of the contract item 104ₙ which is clearly and cleverly displayed by way of, for example, a colour coded progress bar 122e or the like (e.g. a progress wheel (not shown), or some other form of, preferably colour coded, visual indicator, etc.)—in the example shown in FIG. 8 (like in the case of preferred progress bar 120b of preferred panel/region 120) a blue or first colour region (from left to right) represents the total claim/application amount approved to date, whilst a green or second colour region represents that total claim/application amount now being claimed, and a grey, blank or final colour region represents the amount yet to be claimed by way of a claim or payment application; a project-to-date percentage and monetary text box 122f for each contract item 104ₙ, either of which may be selectively altered to input or add new claim/application information so as to make a new claim/application in accordance with method 236, of FIG. 7 (e.g. should the existing claim amount be 25%, or $2,500, a user 16ₙ, etc., may readily input/add a new claim amount by varying either the percentage or monetary amounts pre-populated therein, e.g. by changing 25% to say 75%, or by changing $2,500 to $7,500, etc.); a project-to-date automatically calculated claim total 122g, representing the total monetary amount of all of monetary text boxes 122f; and/or, a current claim/application amount text box 122h for each contract item 104ₙ (which may also be selectively altered to input or add new claim/application information so as to make a new claim/application in accordance with method 236, of FIG. 7), and an associated automatically calculated total 122i for all of current claim/application amount text boxes 122h, representing the total amount now being claimed. Also shown in FIG. 8, are regions of conversation icons 122j for each contract item 104ₙ, which when selected, hovered over, etc., may bring up a pop-up screen or the like (not shown) for reviewing any comments or documents (e.g. photos, etc.) that may have already been added (uploaded, etc.) in connection with a contract item 104ₙ (e.g. a first user's 14ₙ reasons why a previous contract item 104ₙ associated with a previous claim/application was not approved in full, etc.) and/or for adding, submitting, uploading, etc., any comments or documents (e.g. photos, reports, etc.) in connection with a contract item 104ₙ (e.g. reasons for claim amounts, photos of completed works, etc.).

Finally, and again in FIG. 8, it can be seen that preferred panel 124 (here shown in its “lump sum” format, but which could be shown in a “schedule of rates” format, as previously described with reference to drop-down menu 104j, of create contract screen 34ₙ, of FIG. 5) for displaying consolidated project-to-date contract variation/change order item(s) 124ₙ claim summary information, and for entering new variation/change order claim information (i.e. variation/change order items 124ₙ) so as to make a new claim/application in accordance with method 236, of FIG. 7, is configured to enable a user, e.g. a second agent 16ₙ, to readily view summary information concerning previous variations/claim orders and to input or add one or more new variations/claim order items 124ₙ as required so as to make a new claim/payment application in connection with the selected contract 12ₙ. In the preferred make claim screen 34ₙ shown in FIG. 8, like in the case of contract items 104ₙ, it can be seen that one or more variation/claim order item(s) 124ₙ may each include a reference 104a, description 104b, when complete amount 104c, and when complete automatically calculated total of all variation/change order items 124i, along with a number of regions, fields or text boxes for viewing previous claim/application variation/claim order information and for entering new claim/application variation/claim order information. These regions, fields or text boxes, etc., may include, but are not limited to: a previously approved automatically calculated amount 122c, which when there are more than one variation/change order items 124ₙ, may also include a consolidated automatically calculated previously approved total 124d; the completion status of the variation/claim order item 124ₙ which is clearly and cleverly displayed by way of, for example, a colour coded progress bar 122e or the like (e.g. a progress wheel (not shown), or some other form of, preferably colour coded, visual indicator, etc.)—as hereinbefore described with reference to preferred panel/region 122; a project-to-date percentage and monetary text box 122f for each variation/change order item 124ₙ, either of which may be selectively altered to input or add new claim/application information so as to make a new claim/application in accordance with method 236, of FIG. 7—as hereinbefore described with reference to preferred panel 122; a project-to-date automatically calculated total 124g, representing the total monetary amount of all of variation/change order monetary text boxes 122f; and/or, a current claim/application amount text box 122h for each variation/change order item 124ₙ (which may be selectively altered to input or add new claim/application information—as hereinbefore described with reference to preferred panel 122), and an associated automatically calculated total 124j for all of current variation/change order claim/application amount text boxes 122h, representing the total amount now being claimed. Also shown in FIG. 8, are regions of conversation icons 124k for each variation/change order item 124ₙ, for viewing or adding comments, documents, etc., as hereinbefore described with reference to preferred panel 122.

Referring back to step 236A, of method 236, of FIG. 7, it can be seen that after preferred make claim screen 34ₙ, of FIG. 8, has been presented to the user, e.g. second agent 16ₙ, method 236 may continue at step 236B, whereat user 16ₙ, etc., may input/edit new claim information for one or more contract items 104ₙ, using, e.g. any of text boxes 122f or 122h. At step 236B, and as can be seen in FIG. 7, user 16ₙ, etc., may also selectively add any comments, documents (e.g. photos, etc.), concerning one or more contract items 104ₙ, as required or desired using, e.g. any of regions or conversation icons 122j, etc. After having added/input all required claim/application information concerning contract items 104ₙ, at step 236B, method 236 may continue at step 236C, whereat the user 16ₙ, etc., may selectively choose to edit or input any required variation/change order information, etc. Although variations/change orders would typically be made by a second or first agent 16ₙ, 14ₙ, depending on access permissions, it will be appreciated that third agents 32ₙ may also request variations/change orders in some instances. If at step 236C, user 16ₙ, etc., (chooses to add/edit variation/change order information, then method 236 may continue at step 236D, whereat user 16ₙ, etc., may input/edit new variation/change order information for one or more variation/change order items 124ₙ, using, e.g. any of text boxes 122f or 122h, or may add new variation/change order item(s) 124ₙ, using, e.g. “Add Variation” button or region 124b. At step 236D, and as can be seen in FIG. 7, user 16ₙ, etc., may also selectively add any comments, documents (e.g. photos, etc.), concerning one or more variation/change order items 124ₙ, as required or desired using, e.g. any of regions or conversation icons 124k, etc. Thereafter, method 236 may continue at step 236E, whereat user 16ₙ may selectively (or may be prompted to) manage using, e.g. preferred panel/region 118 of FIG. 8, the required supporting compliance documents that must be submitted in order to make a claim/payment application in accordance with the selected contract 12ₙ. As described earlier with reference to contract screen 34ₙ, of FIG. 6, user 16ₙ, etc., may view and add any necessary supporting compliance documents/information (including any related expiry date information, if required in accordance with the contract 12ₙ—i.e. if set as compulsory by, for example, first agent 14ₙ, when creating the selected new contract 12ₙ, as was described earlier with reference to create contract screen 34ₙ, of FIG. 5) by way of preferred panel/region 118, of FIG. 8. Alternatively, and referring back to step 236C, of method 236, should user 16ₙ, etc., chooses not to add/edit variation/change order information, then method 236 may continue at step 236E, as hereinbefore described (e.g. user 16ₙ, etc., may manage the required supporting compliance documents/information using, e.g. preferred panel/region 118, of FIG. 8).

After reviewing, submitting, etc., any/all required supporting compliance documents at step 236E, method 236 may continue at step 236F, whereat a user 16ₙ, etc., may selectively choose to view (using, e.g. “Draft Claim PDF” button or region 120e, of FIG. 8) a draft claim document(s) (e.g. a claim document(s) that conform with relevant Security of Payments or similar statutory adjudication legislation) that may be automatically generated in accordance with system 10 of the present invention. Should user 16ₙ, etc., choose to view a draft claim document(s), then method 236 may continue at step 236G, whereat the required retention/retainage amounts are determined, and thereafter the draft claim document(s) is generated and made available (e.g. viewable in a pop-up window or the likes (not shown), or made available for download, etc.) to user 16ₙ, etc. Thereafter, method 236 may continue at step 236H, whereat user 16ₙ, etc., may selectively choose whether or not to submit their claim or payment application. Alternatively, and referring back to step 236F, should user 16ₙ, etc., choose not to view a draft claim document(s), then method 236 may continue at step 236H (i.e. user 16ₙ, etc., may selectively choose whether or not to submit their claim or payment application). If, at step 236H, user 16ₙ, etc., chooses not to submit their claim/payment application, then method 236 may return to step 236A (after saving the claim/application as a draft, e.g. using “Save Draft” button or region 120f, of FIG. 8) or may end (not shown) should user 16ₙ, etc., opt to sign or log out of system 10.

If, at step 236H, a user 16ₙ, etc., chooses to submit their claim/payment application using, e.g. “Submit Claim” button or region 120g, then method 236 may continue at step 236J, whereat system 10 may request any missing required supporting compliance documents/information, and/or then determine the required retention/retainage amounts, before generating any/all claim/compliance document(s). As is shown in FIG. 7, should any required supporting compliance documents have not been submitted at the “submit claim” stage (e.g. steps 236H, 236J) it is preferred that method 236 continues at step 236E, whereat the user 16ₙ, etc., must add/submit any missing documents/information before their claim/payment application can be processed by system 10. If, at step 236J, it is determined that all required supporting compliance documents have been submitted, then after generating the claim/compliance document(s) at step 236J, method 236 may continue at step 236K, whereat it may be determined whether or not the user 16ₙ, etc., has integrated, e.g. an external accounting software provider 30ₙ(see, FIG. 1), such as, for example, Xero™, MYOB ™, Quickbooks™, Sage One™, etc.) with system 10, for the purpose of, for example, invoicing and account reconciliations, etc. Also, at step 236J, if it is determined that the total claim/payment application amount meets or exceeds the percentage of total works previously defined in text box 86, of create contract screen 34ₙ, of FIG. 5, then at this stage the user 16ₙ, etc., may choose to claim Practical Completion, and hence, have a percentage (i.e. the percentage that was defined in text box 88 of create contract screen 34ₙ, of FIG. 5) of their retention/retainage released upon approval.

If, at step 236K, it is determined that system 10 is not integrated with any external accounting software provider(s) 30ₙ, associated with user 16ₙ, etc., or if user 16ₙ, selectively chooses to skip the accounting software integration step, then method 236 may continue at step 236L, whereat a summary of the claim/application about to be submitted may first be presented to the user 16ₙ, etc., for their review/approval, and thereafter (assuming the user 16ₙ, etc., does not cancel the submission process) the claim is submitted to system 10, along with any supporting documents and/or required supporting compliance documents. A notification (e.g. in the form of an e-mail, etc.) may then be generated and sent (e.g. by way of third party notification service provider(s) 33ₙ, such as, for example, Mandrill™, etc.) to the respondent, e.g. first agent 14ₙ, along with copies of some or all of the automatically generated claim/compliance document(s), and/or any supporting documents or required supporting compliance documents, etc. It will be appreciated that no attachments need be sent with the notification sent to first agent 14ₙ, etc., as all documents will be readily available to first agent 14ₙ, etc., upon logging into system 10. Similarly, instead of sending any attachments with the notification to first agent 14ₙ, etc., links, etc., to the necessary documents, etc., could be supplied as part of the notification. Thereafter, method 236 may end, as shown.

Alternatively, if, at step 236K, it is determined that system 10 is integrated with an external accounting software provider(s) 30ₙ, associated with user 16ₙ, etc., or if user 16ₙ, selectively chooses to integrate system 10 with an external accounting software provider 30ₙ, then method 236 may continue at step 236M, whereat depending on whether or not the user 16ₙ, etc., has chosen (or now selects) to generate an accounting software invoice at the claim/payment application stage (the selection of which may be set when, for example, setting up or enabling integration of external accounting software provider 30ₙ with system 10), method 236 may either continue at step 236L (whereat, if accounting invoices are not to be generated at the claim stage, the claim/payment application is submitted/processed and thereafter a notification is generated and sent to the respondent 14ₙ, etc.) as hereinbefore described, or at step 236N, whereat system 10 may exchange necessary information and instructions with the integrated external accounting software provider 30ₙ so as to automatically generate an accounting invoice for user 16ₙ, etc. At step 236N, user 16ₙ, etc., may choose to view the accounting invoice (not shown) by way of, for example, a button or region (not shown) provided within make claim screen 34ₙ, of FIG. 8, etc. Thereafter, method 236 may continue at step 236L, as before, but may also submit/process the accounting invoice as part of that step (236L). Similarly, upon generating the invoice using external accounting software provider 30ₙ, system 10 may automatically attach a copy of the system 10 generated claim/compliance document to the invoice (or an associated file location) within the external accounting software 30ₙ, etc. Method 236 may then end, as discussed previously.

It will be appreciated that access to, or integration with, an external accounting software provider 30ₙ, etc., may be enabled, facilitated and/or granted, by way of, e.g. the “Add-On” facility or page(s) (not shown) previously described with reference to dashboard screen 34ₙ, of FIG. 3. Although not shown in the drawings, it will be appreciated that the process of integrating system 10 with an external accounting software or other software provider 30ₙ, would include a user, e.g. 16ₙ, granting access rights to system 10 (and/or, external software provider(s) 30ₙ) so as to enable data to be shared between system 10 and external software provider(s) 30ₙ. Further, as part of setting up or enabling integration with an external accounting software provider 30ₙ, user 16ₙ, etc., may be required to nominate, e.g. a specific company, accounting codes, payment terms, etc. (e.g. one or more accounting sales or other revenue codes, retention/retainage code(s), etc.), that are to be used when an invoice is automatically generated by way of integration with system 10. Similarly, as part of setting up or enabling integration with an external accounting software provider 30, or later by way of, e.g. “Add-On” facility or page (not shown) accessibly to user 16ₙ, etc., by way of one or more preferred GUI screens 34, the user 16ₙ, etc., may be required to nominate whether or not they wish to have invoices generated at the claim or approval stage. By enabling a user, e.g. second agent 16ₙ, to share data and/or instructions with their external accounting software provider 30ₙ, as part of (for example) step 236N, of method 236, accounting tasks and/or reconciliations for that user 16ₙ, etc., will be significantly streamlined/improved.

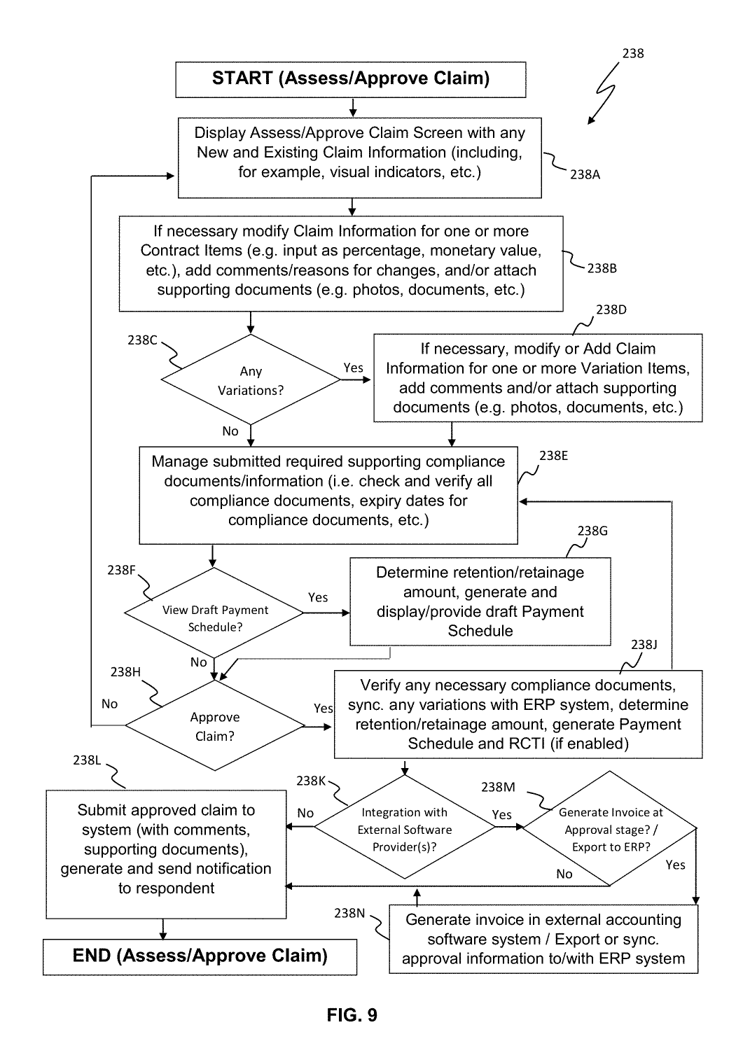

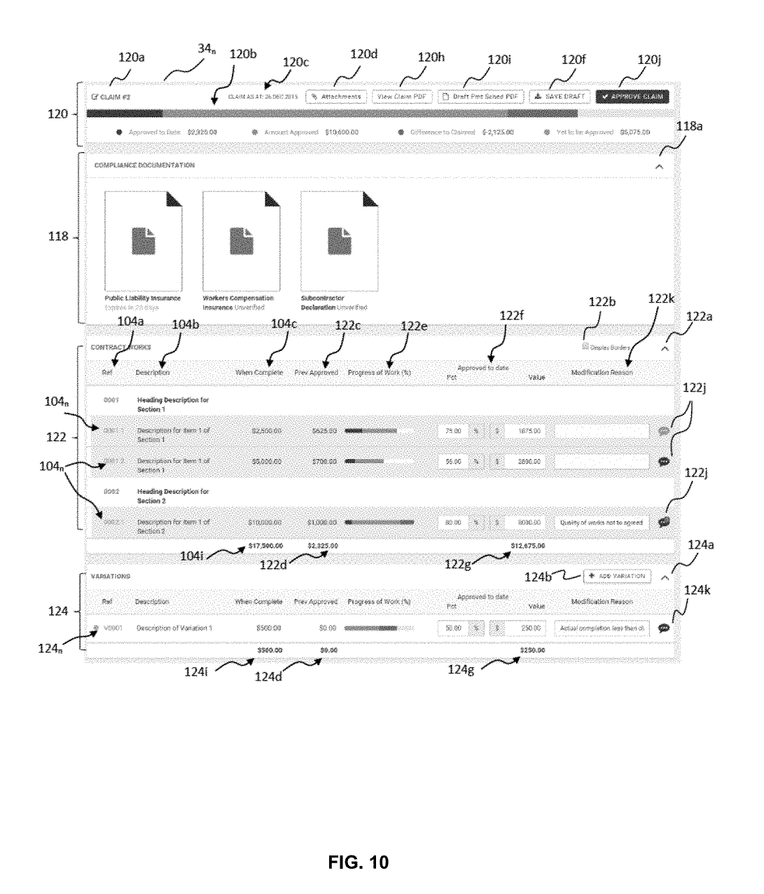

In FIG. 9, there is shown a flow diagram which illustrates a preferred method 238 for assessing and/or approving claims or payment applications in accordance with step 238, of method 200, of FIG. 2. As can be seen in FIG. 9, the preferred process of assessing and/or approving claims or payment application in accordance with method 238 preferably commences at step 238A, whereat the user, e.g. a first, second or third 14ₙ, 16ₙ, 32ₙ (e.g. a first agent 14ₙ in his/her capacity as a respondent, a second agent 16ₙ if using system 10 in its self-assess or stand-alone mode, and/or a third agent 32ₙ if granted access rights to assess (and possibly approve) claims or payment applications in accordance with system 10) is presented with, or arrives at, a GUI “assess or approve claim or payment application” page(s) or screen(s) 34ₙ (hereinafter simply referred to as “assess claim screen 34ₙ,”), by way of their user terminal(s) 28ₙ. An exemplary GUI screen-shot 34ₙ of a preferred assess claim screen 34ₙ is shown in FIG. 10 (which may display a new assess claim screen 34ₙ created from scratch, or may show a previously saved draft assess claim screen 34ₙ—which will be described in detail below). As is indicated by step 238A, shown in FIG. 9, if any existing claim(s)/application(s) have been made against the selected contract 12ₙ, then details pertaining to the existing claim(s)/application(s) are retrieved by system 10, and used to generate the display of information shown within assess claim screen 34ₙ. The existing claim(s)/application(s) details preferably include, but are not limited to: the last claim/application number made against the contract 12ₙ; previously approved claim amounts (which preferably includes the monetary and percentage, etc., amounts); previously added variation items and amounts; any comments or supporting documents (e.g. photos, documents, etc.) that may have been associated with one or more contract items 104ₙ and/or variation/retainage items 124ₙ; and/or, any supporting compliance documents that may have already been submitted by a user, 14ₙ, 16ₙ, etc., in connection with the specific contract 12ₙ. This existing claim(s)/application(s) data, if any, is preferably retrieved and/or used by financial data display engine 24ₙ (and/or any other associated modules or engines 24ₙ, not shown) of network server 20ₙ (or a third party service provider 33ₙ, if desired), of system 10, to calculate, analyse and/or manipulate any necessary data (e.g. financial data) so as to then populate the relevant fields or regions (including the various progress bars 120b, 122e, or other similar visual indicator not shown) of assess claim screen 34ₙ shown in FIG. 10. The data necessary for display within assess claim screen 34ₙ, may have been prepared in advance by financial data display engine 24ₙ, i.e. upon a last transaction (e.g. a project 38ₙ or contract 12ₙ being created, a claim/payment application being made or approved, etc.) being completed, or may be prepared in (substantially) real-time upon, for example, a request being received by system 10 to assess/approve a claim (at step 238), and to display assess claim screen 34ₙ.

Referring to FIG. 10 (which again only shows the preferred screen content so as to simplify the drawing), it can be seen that if an existing claim or payment application has been made (and/or approved) against the selected contract 12ₙ, then a number of the preferred fields or features presented within the various preferred panels or regions 120, 118, 122, 124, of assess claim screen 34ₙ may have been pre-populated by system 10 (as will be described below). Preferred assess claim screen 34ₙ, of FIG. 10, which in this example is that of a first agent 14ₙ, is shown in a state part through the preferred process of assessing and approving a claim or payment application in accordance with method 238, of FIG. 9. That is, various fields have already been completed by user 14ₙ for the purpose of assessing and approving a claim/application against the selected contract 12ₙ(as will be described in further detail below).

In FIG. 10, it can be seen that preferred assess claim screen 34ₙ, preferably includes a number of panels, fields, features, buttons or regions, for displaying information/documents associated with the selected contract 12ₙ and for assessing/approving a claim or payment application in accordance with that contract 12ₙ. For example, and as shown in FIG. 10, assess claim screen 34ₙ preferably includes, but it not limited to: a panel or region 120 for displaying consolidated project-to-date claim summary information, which panel 120 also preferably includes various fields, buttons or regions for performing various make claim/applications functions in accordance with preferred assess claim screen 34ₙ; a panel of region 118 (which may simply be the same as that or panel or region 118 shown in FIGS. 6 & 8) for displaying required supporting documentation (i.e. compliance documents/information) that must be, or has been, submitted or otherwise provided in accordance with contract 12ₙ; a panel or region 122 for displaying consolidated project-to-date contract item 104ₙ claim summary information, and for editing any necessary claim or payment application information so as to assess and approve a claim in accordance with method 238, of FIG. 9; and/or, a panel or region 124 for displaying consolidated project-to-date contract variation/change order item(s) 124ₙ claim summary information, and for editing any necessary variation/change order claim information so as to assess and approve a claim/application in accordance with method 238, of FIG. 9.

Although not shown in FIG. 10, and as has been hereinbefore described with reference to FIGS. 6 & 8, one or more of preferred panels or regions 120, 118, 122 and/or 124, of preferred assess claim screen 34ₙ, may be selectively collapsed or expanded by system 10, or selectively by a user (e.g. by way of the ^{“̂”} buttons or regions 118a, 122a, 124a, etc.), e.g. first agent 16ₙ, as desired, as part of the process of assessing and/or approving claims or payment applications by way of assess claim screen 34ₙ. Again, although not shown, in their collapsed form, each of panels/regions 118, 122, 124 may display a brief description of the respective panel/region, e.g. “Compliance Documentation”, etc., for panel/region 118; “Contract Works” and “Display Borders” check-box 122b, etc., for panel/region 122; and, “Variations” and possibly an “Add Variation” button or region 124b (which may be selected, hovered over, etc., so as to add a new variation/change order item 124ₙ as part of the claim/application being made—as will be described below) for panel/region 124. As was discussed earlier with reference to FIGS. 6 & 8, it is also preferred that the concise or collapsed compliance documentation panel or region 118 (not shown) preferably also includes clever, preferably colour coded, visual indicators (e.g. colour coded icons, regions, etc., not shown) so that a user 14ₙ, etc., may readily determine (e.g. by way of, for example, selecting or hovering over, using, e.g. a GUI pointing device, pen, finger, etc., one or more of the colour coded icons, etc.) the status (e.g. submitted, missing, expiring soon, not verified, etc.) of the supporting documents to that have been submitted or otherwise provided with the claim or payment application being assess/approved in accordance with assess claim screen 34ₙ.

In FIG. 10, it can be seen that preferred panel or region 120 preferably displays consolidated project-to-date claim/payment application summary information for the selected contract 12ₙ. The summary information preferably includes, but is not limited to: the claim number 120a for the claim being assessed/approved; ‘approved to date’, “amount approved”, “difference to claimed” (i.e. approved more or less than was claimed), and “yet to be approved” project-to-date consolidated totals for the specific contract 12ₙ; and, the completion status of the contract 12ₙ which may clearly and cleverly be displayed by way of, for example, a colour coded progress bar 120b or the like (e.g. a progress wheel (not shown), or some other form of, preferably colour coded, visual indicator, etc.), as hereinbefore described. In the example shown in FIG. 10, a blue or first colour region (from left to right) represents the total claim/application amount approved to date, a green or second colour region represents the total claim/application amount now being assessed, a red or third colour region represents the amount disapproved by the user 14ₙ, etc. (and hence, the difference to what was claimed by the claimant, e.g. second agent 16ₙ, as part of a subsequent claim or payment application), and a grey, blank or final colour region represents the amount yet to be approved by the user 14ₙ (i.e. the respondent). Preferred panel or region 120 may also include, but is not limited to: a field/region 120c, e.g. a “claim as at” field/region 120c, which displays the date applicable to the claim or payment application being assessed/approved within assess claim screen 34ₙ; a button or region 120d, e.g. an “Attachments” button or region 120d, which may be selected, hovered over, etc., so at to bring up a pop-up window of the like (not shown) for displaying details of any attachments (and for possibly downloading, etc. copies of same) that may have already been associated with contract 12ₙ, or to submit (e.g. upload, etc.) or otherwise any required or desired attachments applicable to contract 12ₙ or the claim/payment application being assessed/approved; a button or region 120h, e.g. a “View Claim PDF” button or region 120h, that may be selected, hovered over, etc., so as to download and/or view the system 10 generated claim/compliance document for the claim or payment application being assessed/approved; a button or region 120i, e.g. a “Draft Payment Schedule PDF” button or region 120i, which may be selected, hovered over, etc., so as to generate and download or view a draft payment schedule/compliance document (in accordance with step 238G, of method 238, of FIG. 9) applicable to the claim/payment application being assessed/approved; a button or region 120f, e.g. a “Save Draft” button or region 120f, for saving the claim/payment application being assessed/approved as a draft; and/or, a button or region 120j, e.g. an “Approve Claim” button or region 120j, for selectively approving the claim or payment application being assessed in accordance with the invention.

As already described above, preferred panel or region 118 for displaying required supporting documentation (i.e. compliance documents/information) that must be, or has been, submitted or otherwise provided in accordance with contract 12ₙ is preferably the same as, or similar to, preferred panels/regions 118 shown in FIGS. 6 & 8. Accordingly, a detailed discussion of the features and/or operation of preferred panel/region 118, of FIG. 10, need not be provided again. Having said that, in this instance, i.e. for assessing and/or approving claims or payment applications using preferred assess claim screen 34ₙ, of FIG. 10, the user 14ₙ, etc., is preferably not required to submit any supporting compliance documents, but instead is required to review and verify each document and associated information, e.g. document expiry dates, etc., so as to ensure compliance with relevant Security of Payments or similar statutory adjudication legislation. That is, although not shown in FIG. 10, user 14ₙ, etc., is preferably required to open, download, etc., each document submitted (by, e.g. user 16ₙ) by way of preferred panel/region 118, and then review each document and associated details (e.g. expiry date information, etc.) to check whether the documents/information provided is accurate and/or complies with the contract 12ₙ and/or relevant Security of Payments or similar statutory adjudication legislation. Upon reviewing each document, user 14ₙ, etc., may be presented with a pop-up screen or the like (not shown), which may include a check-box, or other such facility, for confirming that the document/information has been verified.

In FIG. 10, it can also be seen that preferred panel 122 for displaying consolidated project-to-date contract item claim summary information, and for editing any necessary claim or payment application information so as to assess and approve a claim in accordance with method 238, of FIG. 9, is configured to enable a user, e.g. a first agent 14ₙ, to readily view summary information concerning previous claims/applications and the current claim/application information, and to edit one or more claim amounts (for one or more contract items 104ₙ) as required so as to assess or approve the claim/payment application in connection with the selected contract _{12,1.} In the preferred assess claim screen 34ₙ shown in FIG. 10, it can be seen that the various contract items 104ₙ (again, arranged in sections in this example, with section headings, and subsection contract items 104ₙ), in addition to including: their reference 104a, description 104b; when complete amounts 104c; when complete automatically calculated total of all contract items 104i; previously approved automatically calculated amounts 122c; previously approved automatically calculated total of all previously approved amounts 122d; the completion status of the contract item 104ₙ—which may be clearly and cleverly displayed by way of, for example, colour coded progress bar(s) 122e or the like (e.g. a progress wheel (not shown), or some other form of, preferably colour coded, visual indicator(s), etc.)—in the example shown in FIG. 10 (like in the case of preferred progress bar 120b of preferred panel/region 120) a blue or first colour region (from left to right) represents the total claim/application amount approved to date, a green or second colour region represents that total claim/application amount now being assessed/approved, a red or third colour region represents the amount disapproved by the user 14ₙ, etc. (and hence, the difference to be claimed by the claimant, e.g. second agent 16ₙ, as part of a subsequent claim or payment application), a grey, blank or final colour region represents the amount yet to be approved by the user 14ₙ (i.e. the respondent); project-to-date percentage and monetary text boxes 122f for each contract item 104ₙ (either of which may be selectively altered as part of the process of assessing/approving a claim/application in accordance with method 238, of FIG. 9); project-to-date automatically calculated total 122g, representing the total monetary amount of all of monetary text boxes 122f; and/or, regions or conversation icons 122j for each contract item 104ₙ, which when selected, hovered over, etc., may bring up a pop-up screen or the like (not shown) for reviewing any comments or documents (e.g. photos, etc.) that may have already been added (uploaded, etc.) in connection with a contract item 104ₙ and/or for adding, submitting, uploading, etc., any comments or documents (e.g. photos, reports, etc.) in connection with a contract item 104ₙ (e.g. reasons for disapproving or reducing claim amounts, photos of defects, etc.); each or which were described earlier with reference to FIG. 8, each also include an additional field or text box 122k, e.g. a “Modification Reason” field or text box 122k, which when selected, hovered over, etc. (e.g. by way of a GUI pointing device, pen or finger, etc.), preferably brings a pop-up menu or screen (now shown), which preferably includes a drop-down menu or the like (not shown) for selecting a reason for, e.g. disapproving or altering a claim or payment application (e.g. actual completion less than claimed, quality of works not to agreed standard, other, etc.), and a text box or field for entering any associated description/comments. Such reasons/comments, etc., submitted by way of, e.g. “Modification Reasons” fields or text boxes 122k, preferably being compulsory in instances where a user 14ₙ, etc., disapproves or alters a claim or payment application amount, so as to comply with relevant Security of Payments or similar statutory adjudication legislation.

Finally, and again in FIG. 10, it can be seen that preferred panel 124 for displaying consolidated project-to-date contract variation/change order item(s) 124ₙ (again, here shown in its “lump sum” format, but which could be shown in a “schedule of rates” format, as previously described with reference to drop-down menu 104j, of create contract screen 34ₙ, of FIG. 5) claim summary information, and for editing any necessary variation/change order claim information so as to assess and approve a claim/application in accordance with method 238, of FIG. 9, is configured to enable a user, e.g. a first agent 14ₙ, to readily view summary information concerning previous variations/claim orders and to edit one or more variations/claim orders as required so as to assess and/or approve a claim/payment application in connection with the selected contract 12ₙ. In the preferred assess claim screen 34ₙ shown in FIG. 10, like in the case of each contract items 104ₙ described above in connection with preferred panel/region 122, of FIG. 10, in addition to including each of a: reference 104a; description 104b; when complete amount 104c; when complete automatically calculated total of all variation items 124i; previously approved automatically calculated amount 122c; previously approved consolidated automatically calculated previously approved total 124d; completion status of the variation/claim order item 124ₙ which is clearly and cleverly displayed by way of, for example, a colour coded progress bar 122e or the like (e.g. a progress wheel (not shown), or some other form of, preferably colour coded, visual indicator, etc.)—as hereinbefore described with reference to preferred panel/region 122; project-to-date percentage and monetary text box 122f (either of which may be selectively altered as part of the process of assessing/approving a claim/application in accordance with method 238, of FIG. 9); project-to-date automatically calculated total 124g, representing the total monetary amount of all of variation/change order monetary text boxes 122f; and/or, regions or conversation icons 124k for each variation/change order item 124ₙ, which when selected, hovered over, etc., may bring up a pop-up screen or the like (not shown) for reviewing any comments or documents (e.g. photos, etc.) that may have already been added (uploaded, etc.) in connection with a variation/change order item 124ₙ and/or for adding, submitting, uploading, etc., any comments or documents (e.g. photos, reports, etc.) in connection with a variation/change order item 124ₙ (e.g. reasons for disapproving or reducing claim amounts, photos of defects, etc.); each or which were described earlier, each variation/change order item 124ₙ also includes an additional field or text box 122k, e.g. a “Modification Reason” field or text box 122k, which when selected, hovered over, etc. (e.g. by way of a GUI pointing device, pen or finger, etc.), preferably brings a pop-up menu or screen (now shown), which preferably includes a drop-down menu or the like (not shown) for selecting a reason, e.g. for disapproving or altering a claim or payment application (e.g. actual completion less than claimed, variation not approved, quality of works not to agreed standard, other, etc.), and a text box or field for entering any associated description/comments. Such reasons/comments, etc., submitted by way of, e.g. “Modification Reasons” fields or text boxes 122k, preferably being compulsory in instances where a user 14ₙ, etc., disapproves or alters a claim or payment application amount, so as to comply with relevant Security of Payments or similar statutory adjudication legislation.

Referring back to step 238A, of method 238, of FIG. 9, it can be seen that after preferred assess claim screen 34ₙ, of FIG. 10, has been presented to the user, e.g. first agent 14ₙ, method 238 may continue at step 238B, whereat user 14ₙ, etc., may review and then edit or modify (if necessary) the current claim information (submitted by second agent 16ₙ, etc.) for one or more contract items 104ₙ, using, e.g. either of text boxes 122f. Should the first agent 14ₙ, etc., approve of the claim information provided in connection with a specific contract item 104ₙ, then he/she may approve the full amount as claimed for that contract item 104ₙ by simply leaving the pre-populated amount shown in text boxes 122f as they are. Alternatively, user 14ₙ, etc., may not approve the entire amount claimed, or may not approve payment for any amount at all as claimed by the second agent 16ₙ, etc. In either of these scenarios, the first agent 14ₙ, may simply alter either the percentage or monetary amounts, etc., pre-populated and provided within text boxes 122f. For example, and as shown in FIG. 10, user 14ₙ, etc., did not approve of the claimed amount submitted in connection with the contract item 104ₙ bearing reference number 0002.1, so he/she has changed the full amount (100% or $10,000) claimed by the second agent 16ₙ, etc., to 90% or $9,000, by way of either of text boxes 122f.

As is shown in FIG. 9, at step 238B, user 14ₙ, etc., may also selectively add any reasons, comments, documents (e.g. photos, etc.), concerning one or more contract items 104ₙ, as required or desired using, e.g. any of regions or conversation icons 122j, etc. (as was described above with reference to panels/regions 122 & 124, of FIGS. 8 & 10). As discussed above, it is preferred that upon a first agent 14ₙ making a change to a claim or payment application submitted by a second agent 16ₙ, etc., that the first agent 14ₙ must at least provide a reason for the change (i.e. a reason for not approving the claimed amount in part, or in full). Hence, in the example shown in FIG. 10, it can be seen that the region or conversation icon 122j associated with the contract item 104ₙ, bearing reference number 0002.1, is displayed as a dark (or otherwise highlighted) icon 122j, and includes a red or other coloured circle (preferably with a number displayed therein, representing, e.g. the number of attachments submitted in connection therewith), which indicates that reasons/comments for modifying the claimed amount have been added for that contract item 104ₙ, and at least one attachment (e.g. a photo of a defect, etc.) has been submitted as evidence, etc., so as to show or explain why the claimed amount was modified, etc.

After having modified any/all necessary or desired claim/application information, and after having submitting any required/desired reasons/comments and/or attachments, etc., concerning contract items 104ₙ, at step 238B, method 238 may continue at step 238C, whereat the user 14ₙ, etc., may selectively choose to view and/or modify required variation/change order information, etc., if any exists, and/or may selectively choose to add one or more required variations/change order items 124ₙ. If it is determined at step 238C, that variations/change orders are part of the claim or payment application being assessed/approved, and/or if user 14ₙ, etc., wishes to add a variation/change order, then method 238 may continue at step 238D, whereat user 14ₙ, etc., may review and then edit or modify (if necessary) the current variation/change order claim information (submitted by second agent 16ₙ, etc.) for one or more variation/change order items 124ₙ, using, e.g. either of text boxes 122f, and/or may add variation/change order items 124ₙ to the payment/claim application, and may then submit or otherwise (using, e.g. region(s) or conversation icon(s) 124j, etc.) provide any reasons, comments and/or supporting documents (e.g. photos, etc.) as required/desired, as described above with reference to contract items 104ₙ, of preferred panel/region 122, of FIG. 10. In the example shown in FIG. 10, it can again be seen that user 14ₙ, etc., did not approve of the (in this example, single) variation/change order item 124ₙ amount submitted by second agent 16ₙ, etc., and hence has changed the claimed amount, and also added a reason/comments (as, for example, is indicated by way of the single (in this example) progress bar 122e, and the dark region or conversation icon 124k).

After having reviewed and modified any variation/change order items 124ₙ (including submitting any reasons, comments, documents, etc.), and/or after having added any required variation/change order items 124ₙ, at step 238D, method 238 may continue at step 238E, whereat user 14ₙ may selectively (or may be prompted to) manage using, e.g. preferred panel/region 118 of FIG. 10, the required supporting compliance documents that have been submitted by user 16ₙ, etc., as part of their claim or payment application lodged in connection with the selected contract 12ₙ. As described earlier with reference to preferred panel/region 118, of assess claim screen 34ₙ, of FIG. 10, at step 238E of method 238, of FIG. 9, user 14ₙ may review each document and associated details (e.g. expiry date information, etc.) to check whether the documents/information provided are accurate and/or comply with the contract 12ₙ and/or relevant Security of Payments or similar statutory adjudication legislation. Upon reviewing each document, user 14ₙ, etc., may then (using, e.g. a pop-up screen or the like (not shown), which may include a check-box, or other such facility) confirm that the documents/information has/have been verified.

Alternatively, and referring back to step 238C, of method 238, should no variation/change order item(s) 124ₙ exist in connection with the claim/application being assessed/approved, or should user 14ₙ, chooses not to add or modify any variation/change order information, then method 238 may continue at step 238E, as hereinbefore described (e.g. user 14ₙ, etc., may manage the required supporting compliance documents/information using, e.g. preferred panel/region 118, of FIG. 8).

After reviewing and verifying, etc., any/all required supporting compliance documents at step 238E, method 238 may continue at step 238F, whereat a user 14ₙ, etc., may selectively choose to view (using, e.g. “Draft Payment Schedule PDF” button or region 120i, of FIG. 10) a draft Payment Schedule document(s) (e.g. a payment schedule document that conforms with relevant Security of Payments or similar statutory adjudication legislation) that may be automatically generated in accordance with system 10 of the present invention. Should user 14ₙ, etc., choose to view a draft payment schedule document(s), then method 238 may continue at step 238G, whereat the required retention/retainage amounts are determined, and thereafter the draft payment schedule document(s) is generated and made available (e.g. viewable in a pop-up window or the likes (not shown), or made available for download, etc.) to user 14ₙ, etc. Thereafter, method 238 may continue at step 238H, whereat user 14ₙ, etc., may selectively choose whether or not to approve the claim or payment application (as modified, or as submitted by second agent 16ₙ, e.g. should first agent 14ₙ approve of all claimed amounts as submitted by second user 16ₙ). Alternatively, and referring back to step 238F, should user 14ₙ, etc., choose not to view a draft payment schedule document(s), then method 238 may continue at step 238H (i.e. user 14ₙ, etc., may selectively choose whether or not to approve the claim or payment application). If, at step 238H, user 14ₙ, etc., chooses not to approve the claim/payment application, then method 238 may return to step 238A (after saving the assessed claim/application as a draft, e.g. using “Save Draft” button or region 120f, of FIG. 10) or may end (not shown) should user 14ₙ, etc., opt to sign or log out of system 10.

If, at step 238H, a user 14ₙ, etc., chooses to approve the claim/payment application using, e.g. “Approve Claim” button or region 120j (of FIG. 10), then method 238 may continue at step 238J, whereat system 10 may request that user 14ₙ review and verify any previously unverified supporting compliance documents/information, and/or then determine the required retention/retainage amounts, before generating any/all payment schedule (compliance document(s)) and a Recipient Created Tax Invoice (RCTI) should the creation of RCTI's have been enabled by user 14ₙ, etc., by way of, for example, check-box 98 of preferred create contract screen 34ₙ, of FIG. 5. Further, and as is illustrated by way of method 238, of FIG. 9, as part of step 238J, system 10 may check to see whether any/all variations/change order item(s) 124ₙ information included within the claim/payment application to be approved, is/are linked or reconciled to/with, for example, an external ERP software provider 30ₙ(such as, for example, Viewpoint™, Jobpac™, Sage 300 Construction and Real Estate™, and, COINS ™, etc.). That is, when a claim/payment application is submitted for approval, using, e.g. “Approve Claim” button or region 120j of assess claim screen 34ₙ, of FIG. 10, a check may be made to see if, for example, the variation/change order item(s) 124ₙ, reference numbers 104a, etc., exist within ERP software system 30ₙ, etc. If it is determined that the variation/change order reference numbers 104a, etc., do not exist within ERP system 30ₙ, etc., and integration with ERP software system 30ₙ is crucial or important, then it is preferred that the approved claim/payment application may not be submitted/processed by system 10 until such time that the variation/change order item(s) 124ₙ reference numbers, etc., are reconciled or synchronised with ERP software system 30ₙ, etc. This preferred reconciliation/synchronisation step may be facilitated by way of a “Sync Variations” button or region (not shown) provided within, for example, assess claim screen 34ₙ, of FIG. 10, such that upon selecting, hovering over, etc., that “Sync Variations” button or region, system 10 may exchange data with external ERP software provider (i.e. may readily retrieve existing ERP variation/change order information) so as to display (in the form of a pop-up window, or the like (not shown)), the ERP variation/change order information simultaneously with system 10 variation/change order information, with any unsyncronised variation/change order information highlighted, so that a user 14ₙ, etc., may then, for example, synchronise the system 10 variation/change order information with the necessary ERP software system 30ₙvariation/change order information (this process may also include importing new variation/change order items 124ₙ into contract 12ₙ, for future use, as required/desired). As already discussed above, access to, or integration with, the ERP software provider 30ₙ, etc., may be enabled, facilitated and/or granted, by way of, e.g. the “Add-On” facility or page(s) (not shown) previously described with reference to dashboard screen 34ₙ, of FIG. 3. By enabling a user, e.g. first agent 14ₙ, to synchronise existing ERP, etc., variation/change order data with system 10 variation/change order data, as part of step 238J, of method 238, consistency with existing ERP information is likely to be assured.

As is shown in FIG. 9, should any required supporting compliance documents have not been verified by user 14ₙ, etc., at the “approve claim” stage (e.g. steps 238H, 238J) it is preferred that method 238 continues at step 238E, whereat the user 14ₙ, etc., must review and verify any documents/information that have not been previously verified, before the claim/payment application can be approved and processed by system 10. If, at step 238J, it is determined that all required supporting compliance documents have been verified, then after generating the Payment Schedule (compliance document(s)), RCTI (if enabled), and synchronising any required variation/change order information with, e.g. external ERP software provider 30ₙ, at step 238J, method 238 may continue at step 238K, whereat it may be determined whether or not the user 14ₙ, 16ₙ, etc., has integrated system 10 with any external software provider(s) 30ₙ, such as, for example, an external accounting software provider 30ₙ, e.g. Xero™, MYOB ™, Quickbooks™, Sage One™, etc., or an external ERP software provider 30ₙ, e.g. Viewpoint™, Jobpac™, Sage 300 Construction and Real Estate™, and, COINS™, etc., for the purpose of, for example, invoicing, account reconciliations, exporting approval data to an ERP system, etc. Also, at step 238J, if it is determined that the claimant, e.g. second agent 16ₙ, has claimed for Practical or Final Completion, and hence, has requested that his/her/their retention/retainage funds be released, then at this stage the respondent, e.g. first agent 14ₙ, may preferably be prompted to authorise or otherwise the release of those retention/retainage funds. If at this point the respondent, e.g. first agent 14ₙ, declines to release the retention/retainage funds, then it is also preferred that the first agent 14n must provide a reason as to why the funds are not being released. Retention/retainage funds will be released (or not) accordingly.

If, at step 238K, it is determined that system 10 is not integrated with any external software provider(s) 30ₙ, associated with user 14ₙ, 16ₙ, etc., or if user 14ₙ, 16ₙ, selectively chooses to skip the external software integration step, then method 238 may continue at step 238L, whereat a summary of the claim/application about to be submitted for approval may first be presented to the user 14ₙ, 16ₙ, etc., for their review/approval, and thereafter (assuming the user 14ₙ, 16ₙ, etc., does not cancel the submission process) the claim is submitted and approved by system 10 (which process includes submitting or generating any supporting documents and/or required supporting compliance documents). A notification (e.g. in the form of an e-mail, etc.) may then be generated and sent (e.g. by way of third party notification service provider(s) 33ₙ, such as, for example, Mandrill™, etc.) to the claimant, e.g. second agent 16ₙ, along with copies of some or all of the automatically generated Payment Schedule/compliance document(s)/RCTI, etc., and/or any supporting documents or required supporting compliance documents, etc. A notification (e.g. in the form of an e-mail, etc.), may also be sent to other agents, e.g. a third agent 32ₙ, at step 238L, should that agent(s) 32ₙ have authorisation to receive/review such information. It will be appreciated that no attachments need be sent with the notification sent to second or third agents 16ₙ, 32ₙ, etc., as all documents will be readily available to second and third agents 16ₙ, 32ₙ, etc., upon logging into system 10. Similarly, instead of sending any attachments with the notification to second and agents 16ₙ, 32ₙ, etc., links, etc., to the necessary documents, etc., could be supplied as part of the notification. Thereafter, method 238 may end, as shown.

Alternatively, if, at step 238K, it is determined that system 10 is integrated with an external software provider(s) 30ₙ, associated with user 14ₙ, 16ₙ, etc., or if user 14ₙ, 16ₙ, etc., selectively chooses to integrate system 10 with an external software provider 30ₙ, then method 238 may continue at step 238M, whereat one or more preferred integration processes may occur as will now be described.

Firstly, should system 10 be integrated with a user's 14ₙ, 16ₙ, etc., external accounting service provider 30ₙ, such as, for example, Xero™, MYOB™, Quickbooks™, and, Sage One™, then at step 238M, of method 238, of FIG. 9, depending on whether or not the user 14ₙ, 16ₙ, etc., has chosen (or now selects) to generate an accounting software invoice at the approval stage (the selection of which may be set when, for example, setting up or enabling integration of external accounting software provider 30ₙ with system 10), method 238 may either continue at step 238L (whereat, if accounting invoices are not to be generated at the approval stage, the claim/payment application is submitted/processed for approval, and thereafter a notification is generated and sent to the claimant 16ₙ, etc.) as hereinbefore described, or at step 238N, whereat system 10 may exchange necessary information and instructions with the integrated external accounting software provider Aₗso as to automatically generate an accounting invoice for user 16ₙ, etc. At step 238N (or after receiving a notification of approval of their claim/payment application), user 14ₙ, 16ₙ, etc., may choose to view the accounting invoice (not shown) by way of, for example, the notification informing them of the approval of their claim/application, and/or a button or region (not shown) provided within assess claim screen 34ₙ, of FIG. 10, etc. Thereafter, method 238 may continue at step 238L, as before, but may also submit/process the accounting invoice as part of that step (238L). Similarly, upon generating the invoice using external accounting software provider 30ₙ, system 10 may automatically attach a copy of the system 10 generated Payment Schedule (e.g. the payment schedule compliance document) to the invoice (or an associated file location) within the external accounting software 30ₙ, etc. Method 238 may then end, as discussed previously.

Alternatively, or in conjunction with the preferred integration with external accounting software provider 30ₙ, at steps 238M & 238N, should system 10 be integrated with a user's 14ₙ, etc., external ERP service provider 30ₙ, such as, for example, Viewpoint™, Jobpac™, Sage 300 Construction and Real Estate™, and, COINS ™, etc., then at step 238M, of method 238 (and preferably in addition to the preferred ERP synchronisation processes previously described with reference to step 238J), depending on whether or not the user 14ₙ, etc., is required or desires to export claim/payment application approval information, e.g. approval values, claim number and retention/retainage values, to the/their ERP software provider 30ₙ, method 238 may either continue at step 238L, whereat, if it is not required or desired to export claim/payment application approval data to ERP software provider 30ₙ, no such data is sent to ERP software provider 30ₙ, and instead the claim/payment application is submitted/processed for approval, and thereafter a notification is generated and sent to the claimant 16ₙ, etc., as hereinbefore described, or at step 238N, whereat system 10 may exchange/export/sync the necessary information/data with ERP software provider 30ₙ so as to ensure that ERP software provider 30ₙ is aware of, or receives, the new claim/payment application approval information. Thereafter, method 238 may continue at step 238L, as hereinbefore described. Method 238 may then end, as discussed previously.

As was described earlier with reference to make claim screen 34ₙ, of FIG. 8, it will be appreciated that access to, or integration with, an external accounting software provider 30ₙ, etc., may be enabled, facilitated and/or granted, by way of, e.g. the “Add-On” facility or page(s) (not shown) previously described with reference to dashboard screen 34ₙ, of FIG. 3. Although not shown in the drawings, it will be appreciated that the process of integrating system 10 with an external accounting software or other software provider 30ₙ, would include a user, e.g. 14ₙ or 16ₙ, granting access rights to system 10 (and/or, external software provider(s) 30ₙ) so as to enable data to be shared between system 10 and external software provider(s) 30ₙ. Further, as part of setting up or enabling integration with an external accounting software provider 30ₙ, user 16ₙ, etc., may be required to nominate, e.g. a specific company, accounting codes, payment terms, etc. (e.g. one or more accounting sales or other revenue codes, retention/retainage code(s), etc.), that are to be used when an invoice is automatically generated by way of integration with system 10. Similarly, as part of setting up or enabling integration with an external accounting software provider 30ₙ, or later by way of, e.g. “Add-On” facility or page (not shown) accessible to user 16ₙ, etc., by way of one or more preferred GUI screens 34ₙ, the user 16ₙ, etc., may be required to nominate whether or not they wish to have invoices generated at the claim or approval stage. By enabling a user, e.g. second agent 16ₙ, to share data and/or instructions with their external accounting software provider 30ₙ, as part of (for example) step 238N, of method 238, accounting tasks and/or reconciliations for that user 16ₙ, etc., will be significantly streamlined/improved. Finally, it will be appreciated that in instances where it is likely that a claim or payment application, for any given contract 12ₙ, is not likely to be approved in full, user's 16ₙ, etc., would be best to select “generate invoices at approval” as opposed to “generate invoices at the claim stage”, as if the latter option (i.e. at claim stage) is selected, a credit note may need to be generated and provided to, e.g. first agent 14ₙ, so as to bring the original invoice amount down to the approved amount, etc. Although it is preferred that system 10 may also be able to automatically generate such credit note(s), from an accounting system 30ₙ, etc., point of view it may be desirable to eliminate the need to generate such credit notes.

Although not shown in the drawings, if, for example, a first user 14ₙ, etc., has a number of contracts 12ₙ with pending claims/payment applications associated with a specific project 38ₙ, each of which may be viewable by way of, e.g. project screen 34ₙ of FIG. 4, such as, for example, by selecting the “Pending Claims” button or region 64, system 10 may enable the user 14ₙ, etc., to bulk approve two or more of those pending claims/payment applications with or without having to individually assess/view each claim/payment application. That is, after having selected, hovered over, etc., the “Pending Claims” button or region 64 provided with project screen 34ₙ, of FIG. 4, the user 14ₙ, etc., may be presented with a further project GUI screen or page (not shown), which only shows the concise details of contracts 12ₙ having pending claims/applications, and which may include check-boxes or the like (not shown), for selecting two or more contracts 12ₙ with pending claims, and an approve button or region (not shown) for bulking approving the selected claims/applications. Although it is preferred that such a bulk approval process need not involve individually reviewing each pending claim/application, it will be appreciated that before bulk approving a number of pending claims/applications, a user 14ₙ, etc., may have already assessed, but not approved, each of those claims/applications by way of only steps 238A to 238H of method 238, of FIG. 9 (i.e. up to the point of selecting whether or not to approve a claim/application. Similarly, although it may not be necessary to individually assess each pending claim/application as part of this preferred bulk approval process, it is preferred that pending claims/applications which do not have all required supporting compliance documents attached thereto, or which have supporting compliance documents that have not been verified, may not be approved as part of the preferred bulk approval process.

Although not shown in the drawings, it will be appreciated that system 10 may provide one or more varying GUI page(s) or screen(s) (not shown) for access by third agents 32ₙ. As already described above, third agents 32ₙmay be, for example, owner-agents, or some other person with an interest or authority over a particular project 38ₙ or contract 12ₙ. Depending on permissions granted to a third agent 32ₙ, such GUI page(s) or screen(s), may only display and/or otherwise provide a limited amount of information to third agents 32ₙ, and/or may display and/or otherwise provide the same information as that presented to one or more of a first or second agent 14ₙ, 16ₙ. Similarly, although not shown in the drawings, approval of claims/payment applications made in accordance with system 10 of the present invention may require assessment/approval by multiple agents, e.g. a first agent 14ₙ and one or more third agents 32ₙ, etc. Such a “multi-stage approval” requirement may be defined or set as part of the process of creating a new project 38ₙ, by way of, for example, a create new project GUI screen(s) (not shown). If multi-stage approval is set as a requirement for a project 38ₙ, then all contracts 12ₙ created under that project 38ₙ, will require assessment and approval by those agents 14ₙ, 32ₙ, etc., that are defined as having to be part of the multistage approval process. Referring back to the preferred flow diagram of FIG. 9, should a multistage approval process apply to a claim/payment application being assess/approved, then the generation of the payment schedule and RCTI at step 238J, and the external software provider 30ₙ integration (e.g. ERP and/or accounting software provider 30ₙ integration) at steps 238K, 238M & 238N, of method 238, would only apply be triggered, or apply, to the final approver 14ₙ, 32ₙ, etc.

The present invention therefore provides novel and useful systems and/or methods for managing contracts associated with construction projects. Many advantages of the present invention will be apparent from the detailed description of the preferred embodiments provided hereinbefore. Examples of those advantages include, but are not limited to: the ability to manage contracts both collaboratively or in a self-assess/stand-alone mode; the ability to integrate with external software systems or providers so as to streamline processes, assure compliance, etc.; the ability to share documents/information between parties involved in a project in real time so that all parties have a single view of the status of a project or contract, meaning there are no surprises, which will likely lead to fewer disputes, etc.; the ability to enable supporting documentation/information (including, e.g. insurance documentation and associated expiry dates, etc.) to be submitted and distributed between contracted parties; compliance with relevant Security of Payments or similar statutory adjudication legislation; the ability to use a single account (and to assign multiple users to that account) to manage or view multiple construction projects and contracts; automatic and instant generation of conforming documentation that may be delivered by, e.g. e-mail, to contracted parties; automatic calculation of retention/retainage amounts for each contract payment claim/application and approval; the ability to send important notifications or reminders for the various phases of a contract; and/or, the ability to cleverly display project-to-date reconciliations for any given project, or for all claims or payment applications and approvals made under a contract for a specific project to any point in time.

While this invention has been described in connection with specific embodiments thereof, it will be understood that it is capable of further modification(s). The present invention is intended to cover any variations, uses or adaptations of the invention following in general, the principles of the invention and including such departures from the present disclosure as come within known or customary practice within the art to which the invention pertains and as may be applied to the essential features hereinbefore set forth.

As the present invention may be embodied in several forms without departing from the spirit of the essential characteristics of the invention, it should be understood that the above described embodiments are not to limit the present invention unless otherwise specified, but rather should be construed broadly within the spirit and scope of the invention as defined in the attached claims. Various modifications and equivalent arrangements are intended to be included within the spirit and scope of the invention. Therefore, the specific embodiments are to be understood to be illustrative of the many ways in which the principles of the present invention may be practiced.

Where the terms “comprise”, “comprises”, “comprised” or “comprising” are used in this specification, they are to be interpreted as specifying the presence of the stated features, integers, steps or components referred to, but not to preclude the presence or addition of one or more other features, integers, steps, components to be grouped therewith.

What is claimed is:

1. A system for managing contract payments between a first agent and at least one second agent for a project, said system being operable over a communications network, said system including:
at least one network server connected to said communications network, said at least one network server acting as a central repository for storing and sharing contract information associated with said project; and
at least one user operable terminal associated with each of said first and second agents, said user operable terminals being configured to be selectively connected to said communications network for creating, editing, viewing and/or approving said contract information associated with said project stored at said at least one network server;
wherein said contract information includes at least one contract which includes at least one contract item entity associated with said project and said second agent, said contract item entity representing a contract item being for a good and/or service provided by said second agent to said first agent in accordance with said contract, each contract item entity including:
at least one item identifier for identifying said contract item;
an item value representing a first monetary value of said contract item as agreed between said first agent and said second agent;
a completion amount for said contract item which said second agent claims to have completed;
a claim amount representing a second monetary value which said second agent claims for payment, said claim amount depending on said item value and said completion amount; and
an approval amount representing a third monetary value which is a portion between 0% and 100% of said claim amount approved by said first agent for payment to said second agent; and
wherein said at least one network server generates and provides at least one visual indicator for display on said user operable terminals, said at least one visual indicator being configured to graphically represent consolidated project-to-date contract information and/or contract item entity information.

2. The system of claim 1, wherein: said second agent populates said completion amount, and said first agent populates said approval amount based on assessment and/or agreement of said completion amount; or, one of said first or second agents populates said completion amount, and also populates said approval amount based on self-assessment and/or agreement of said completion amount.

3. The system of claim 1, wherein said at least one visual indicator is/are a progress wheel and/or a progress bar.

4. The system of claim 3, wherein said progress wheel and/or said progress bar utilise multiple colours or varying shades of a single colour to graphically represent consolidated project-to-date or current claim/approval contract information and/or contract item entity information.

5. The system of claim 1, further including at least one external software provider or server connected to said communications network, said at least one external software provider or server being selectively integrable with said at least one network server so as to enable data sharing between said at least one network server and said at least one external software provider or server, and/or to enable various external software functions to be automated and/or controlled by way of said at least one network server.

6. The system of claim 5, wherein said at least one external software provider or server is selected from the group consisting of: an ERP software provider; a project collaboration software provider; a procurement software provider; a cost planning or budgeting software provider; an accounting software provider; and/or, any other suitable software or data provider that may provide associated or desired software or data that may be accessed or otherwise used by said at least one network server.

7. The system of claim 1, wherein at least one of said at least one user operable terminals is associated with at least one third agent who may also selectively connect to said communications network to at least edit and/or view said contract information associated with said project stored at said at least one network server.

8. The system of claim 7, wherein said at least one network server or at least third party notification service provider sends multiple notifications to first, second and/or third agents during the various phases or said project, these notifications may be selected from the following group: invitations to first, second and/or third agents to collaborate on said project; reminders to populate said completion amount so as to submit a claim for payment; notifications of submittal of said claims for payment; reminders to populate said approval amount based on assessment and/or agreement of said completion amount so as to approve a claim; reminders of approval deadlines in accordance with legislation governing said contract; notifications of approval of claims; and/or, reminders to claim for final completion and associated retention/retainage release.

9. The system of claim 1, wherein said contract information further includes at least one variation/change order item entity associated with said project and said second agent, said variation/change order item entity representing a variation/change order item being for a good and/or service associated with said contract, each variation/change order item entity including: at least one item identifier for identifying said variation/change order item; an item value representing a first monetary value of said variation/change order item; a completion amount for said variation/change order item nominated by said first or second agent; and, an approval amount representing a third monetary value approved by said first agent for payment to or by said second agent, wherein said at least one network server generates and provides at least one visual indicator for display on said user operable terminals, said at least one visual indicator being configured to graphically represent consolidated project-to-date variation/change order item entity information.

10. The system of claim 9, wherein: said first or second agent populates said completion amount of said at least one variation/change order item entity, and said first agent populates said approval amount of said at least one variation/change order item entity, based on assessment and/or agreement of said completion amount; or, one of said first or second agents populates said completion amount of said at least one variation/change order item entity, and also populates said approval amount of said at least one variation/change order item entity, based on self-assessment and/or agreement of said completion amount.

11. The system of claim 1, wherein any required supporting compliance documents must be submitted and/or verified before a claim for payment or approval of a claim can be made or processed.

12. The system of claim 1, wherein said at least one network server generates claim and payment schedule documents as part of the process of submitting a claim for payment or for approving a claim, the claim and payment schedule documents complying with relevant statutory adjudication legislation.

13. A method for managing contract payments, via a communications network, between a first agent and at least one second agent for a project, said method including the steps of:
providing a central repository for storing and sharing contract information associated with said project; and
providing said first and said at least one second agents with controlled access to said central repository and said contract information stored therein so that they may selectively create, edit, view and/or approve said contract information associated with said project;
wherein said contract information includes: at least one contract which includes at least one contract item entity associated with said project and said second agent, said contract item entity representing a contract item being for a good and/or service provided by said second agent to said first agent in accordance with said contract, each contract item entity including:
at least one item identifier for identifying said contract item;
an item value representing a first monetary value of said contract item as agreed between said first agent and said second agent;
a completion amount for said contract item which said second agent claims to have completed;
a claim amount representing a second monetary value which said second agent claims for payment, said claim amount depending on said item value and said completion amount; and
an approval amount representing a third monetary value which is a portion between 0% and 100% of said claim amount approved by said first agent for payment to said second agent; and
wherein said method further includes the step of: generating and providing at least one visual indicator for display to said first and second agents, said at least one visual indicator being configured to graphically represent consolidated project-to-date contract information and/or contract item entity information.

14. The method of claim 13, wherein: said second agent populates said completion amount, and said first agent populates said approval amount based on assessment and/or agreement of said completion amount; or, one of said first or second agents populates said completion amount, and also populates said approval amount based on self-assessment and/or agreement of said completion amount.

15. The method of claim 13, wherein said at least one visual indicator is/are a progress wheel and/or a progress bar.

16. The method of claim 15, wherein said progress wheel and/or said progress bar utilise multiple colours or varying shades of a single colour to graphically represent consolidated project-to-date or current claim/approval contract information and/or contract item entity information.

17. The method of claim 13, wherein said central repository is at least one network server and said method further includes the step of: enabling at least one external software provider or server to be selectively integrated with said at least one network server so as to enable data sharing between said at least one network server and said at least one external software provider or server, and/or to enable various external software functions to be automated and/or controlled by way of said at least one network server.

18. The method of claim 17, wherein said at least one external software provider or server is selected from the group consisting of: an ERP software provider; a project collaboration software provider; a procurement software provider; a cost planning or budgeting software provider; an accounting software provider; and/or, any other suitable software or data provider that may provide associated or desired software or data that may be accessed or otherwise used by said at least one network server.

19. The method of claim 13, further including the step of: providing at least one third agent with controlled access to said central repository and said contract information stored therein, so that said at least one third agent may at least selectively edit and/or view said contract information associated with said project.

20. The method of claim 19, further including the step of: generating and sending multiple notifications to first, second and/or third agents during the various phases of said project; these notifications may be selected from the following group: invitations to first, second and/or third agents to collaborate on said project; reminders to populate said completion amount so as to submit a claim for payment; notifications of submittal of said claims for payment; reminders to populate said approval amount based on assessment and/or agreement of said completion amount so as to approve a claim; reminders of approval deadlines in accordance with legislation governing said contract; notifications of approval of claims; and/or, reminders to claim for final completion and associated retention/retainage release.

21. The method of claim 13, wherein said contract information further includes at least one variation/change order item entity associated with said project and said second agent, said variation/change order item entity representing a variation/change order item being for a good and/or service associated with said contract, each variation/change order item entity including: at least one item identifier for identifying said variation/change order item; an item value representing a first monetary value of said variation/change order item; a completion amount for said variation/change order item nominated by said first or second agent; and, an approval amount representing a third monetary value approved by said first agent for payment to or by said second agent, wherein said at least one network server generates and provides at least one visual indicator for display on said user operable terminals, said at least one visual indicator being configured to graphically represent consolidated project-to-date variation/change order item entity information.

22. The method of claim 21, wherein: said first or second agent populates said completion amount of said at least one variation/change order item entity, and said first agent populates said approval amount of said at least one variation/change order item entity, based on assessment and/or agreement of said completion amount; or, one of said first or second agents populates said completion amount of said at least one variation/change order item entity, and also populates said approval amount, of said at least one variation/change order item entity, based on self-assessment and/or agreement of said completion amount.

23. The method of claim 13, wherein any required supporting compliance documents must be submitted and/or verified before a claim for payment or approval of a claim can be made or processed.

24. The method of claim 23, further including the step of: generating claim and payment schedule documents as part of the process of submitting a claim for payment or for approving a claim, the claim and payment schedule documents complying with relevant statutory adjudication legislation.

25. A non-transitory computer readable medium storing a set of instructions that, when executed by a machine, cause the machine to execute a method for managing contract payments, via a communications network, between a first agent and at least one second agent for a project, said method including the steps of:
providing a central repository for storing and sharing contract information associated with said project; and
providing said first and said at least one second agents with controlled access to said central repository and said contract information stored therein so that they may selectively create, edit, view and/or approve said contract information associated with said project;
wherein said contract information includes: at least one contract which includes at least one contract item entity associated with said project and said second agent, said contract item entity representing a contract item being for a good and/or service provided by said second agent to said first agent in accordance with said contract, each contract item entity including:
at least one item identifier for identifying said contract item;
an item value representing a first monetary value of said contract item as agreed between said first agent and said second agent;
a completion amount for said contract item which said second agent claims to have completed;
a claim amount representing a second monetary value which said second agent claims for payment, said claim amount depending on said item value and said completion amount; and
an approval amount representing a third monetary value which is a portion between 0% and 100% of said claim amount approved by said first agent for payment to said second agent; and
wherein said method further includes the step of: generating and providing at least one visual indicator for display to said first and second agents, said at least one visual indicator being configured to graphically represent consolidated project-to-date contract information and/or contract item entity information.
